(19) United States
(12) Patent Application Publication
(10) Pub. No.: US 2026/0078205 A1
(43) Pub. Date: Mar. 19, 2026

(54) SILYL-BRIDGED BIS(INDENYL) METALLOCENES WITH AN OMEGA-ALKENYL GROUP ON SILICON

(71) Applicant: Chevron Phillips Chemical Company LP, The Woodlands, TX (US)

(72) Inventors: Zhou CHEN, Bartlesville, OK (US); Qing YANG, Bartlesville, OK (US); Richard M. BUCK, Bartlesville, OK (US); Jim B. ASKEW, Bartlesville, OK (US); Graham R. LIEF, Bartlesville, OK (US)

(73) Assignee: Chevron Phillips Chemical Company LP, The Woodlands, TX (US)

(21) Appl. No.: 18/886,358

(22) Filed: Sep. 16, 2024

(51) Int. Cl. C08F 10/02

(52) U.S. Cl. CPC C08F 10/02; C08F 2420/10

(57) ABSTRACT

Disclosed are single-metallocene catalyst systems and processes for polymerizing olefins using new metallocenes and solid super acids (SSA) activator-support combinations which produce polyethylenes having a higher PDI (polydispersity index, Mw/Mn) and a lower LCB (long chain branching) as compared to polyethylenes produced with a benchmark metallocene. A series of silyl-bridged bis(indenyl) metallocenes having an omega-(ω-)alkenyl moiety on the silyl bridge were prepared and found to exhibit excellent polymerization activities and produced polyethylenes with broad molecular weight distributions, relatively high melt indices, and low levels of long chain branching (LCB) as compared with the silyl-bridged metallocenes absent an ω-alkenyl moiety on the silyl bridge.

### CROSS REFERENCE TO RELATED APPLICATIONS

None.

### TECHNICAL FIELD OF THE DISCLOSURE

This disclosure relates to catalyst compositions for producing ethylene homopolymers and co-polymers, and polymerization processes for preparing the same.

### BACKGROUND OF THE DISCLOSURE

The development of new olefin polymerization catalysts is of great interest in the polyolefin industry because of their potential to tailor resin architectures and provide customized polymer properties. This interest is particularly intense in the search for new metallocene-based catalysts. In comparison with chromium and Ziegler-Natta multiple site catalysts, metallocene-based catalysts often provide “single-site” behavior, providing opportunities to specifically tailor certain resin properties. Moreover, bridged metallocenes often exhibit an enhanced ability to incorporate linear alpha-olefins into a growing polyethylene chain and thereby produce linear low-density polyethylene (LLDPE) under substantially reduced monomer concentrations.

One persistent issue with advancing catalyst design is the need to control the formation of long chain branching (LCB) in polymers, as the extent of long-chain branching in a polyethylene can greatly affect processing parameters and the final resin properties. For example, if LCB formation is too high in the polymer, certain applications such as film formation may be negatively impacted. This goal has been particularly challenging using metallocene catalysts. While a number of metallocene-based catalysts can control long chain branch formation, the resulting polyethylenes often have a very narrow molecular weight distributions (low Mw/Mn or polydispersity index), which present their own challenges to resin processability and end use.

Therefore, there remains a need for new catalysts, catalyst compositions, and catalytic processes for preparing polyolefins with controlled or reduced levels of long chain branching, and which provide molecular weight distributions which are not as narrow as polyethylenes produced using conventional metallocene catalysts.

### SUMMARY OF THE DISCLOSURE

This disclosure provides new metallocene compounds and catalyst compositions, processes for polymerizing olefins, methods for making catalyst compositions, olefin polymers and copolymers. In an aspect, the disclosed olefin polymers are characterized by low levels of long chain branching (LCB) and broader molecular weight distributions than produced using conventional single-site metallocene catalysts. Therefore, these catalysts can be useful for preparing film resins that are readily processed and other applications that require low levels of LCB. While not intending to be bound by theory, it is possible that the pendent olefin may protect the active catalytic site by coordinating the metallocene and in doing so, inhibit the insertion of an in-situ generated macromonomer or olefin oligomer into a growing polymer chain, which would otherwise lead to long chain branch formation.

Accordingly, this disclosure provides a series of silyl-bridged bis-indenyl metallocenes possessing an omega-(ω-)alkenyl group on the bridging silicon atom, and catalyst compositions comprising the metallocenes, FIG. 1. While any metallocene activator can be used, these catalysts showed excellent activity and resin properties when activated using a solid oxide treated with an electron-withdrawing anion, also termed a solid super acid of “SSA”, in combination with a co-catalyst such as an organoaluminum compound. The resulting catalyst compositions exhibited very high activities, excellent melt index (MI) response to added hydrogen and/or 1-hexene, and an activity which greatly increased by the addition of 1-hexene. Polymer molecular weight could be readily tuned using either H₂ or 1-hexene.

These metallocene-based catalysts can produce polymers with a broad molecular weight distribution (MWD or Mw/Mn) of from about 4 to about 7, in contrast the typical metallocene catalysts which produce polyethylenes having a MWD of from about 2 to about 3. Notably, these resins having the broader MWD can be produced even in the absence of H₂ conditions as demonstrated in the Examples. One benchmark metallocene was the commercial catalyst dimethylsilyl bis(indenyl) zirconium dichloride, designated herein as DSI or MET-5, which is absent a pendent alkenyl group. In comparison to the MET-5 catalyst, the silyl-bridged metallocene having various tethered olefins produced polymers with low LCB content as manifested in the higher Carreau-Yasuda (CY) breadth parameter, α (CY-a parameter). It was observed that the alkenyl tether length does not have a substantial impact on the LCB control. For example, the MET-1 catalyst with a short length allyl group (CH₂CH═CH₂) bonded to the bridging silicon produced a polymer with similar LCB contents as the polymer producing using the MET-3 catalyst having a tethered ω-pentenyl group (see FIG. 1).

Accordingly, in one aspect of this disclosure, there is provided a catalyst composition for polymerizing olefins, the catalyst composition comprising or comprising the contact product of:
(a) a metallocene compound having the formula:

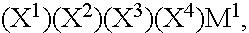

wherein
M¹ is titanium, zirconium, or hafnium;
X¹ and X² are independently a substituted or an unsubstituted indenyl ligand, wherein a substituent, when present, is selected independently from a halogen or a C₁-C₂₀ hydrocarbyl group;
X¹ and X² are bridged by a linking group having the formula >Si[(CH₂)ₙCH═CH₂]R¹, wherein n is 1, 2, 3, 4, 5, or 6, and R¹ is H or a C₁ to C₂₀ hydrocarbyl group; and
X³ and X⁴ are independently a halide, hydride, a C₁-C₂₀ hydrocarbyl group, a C₁-C₂₀ heterohydrocarbyl group, tetrahydroborate, or OBR^{A}₂ or OSO₂R^{A}, wherein R^{A} is independently a C₁-C₁₂ hydrocarbyl group;
(b) an activator-support comprising a solid oxide treated with an electron-withdrawing anion (“solid super acid” or “SSA”); and
(c) a co-catalyst such as an organoaluminum co-catalyst.
   Examples of the solid super acid include but are not limited to those in which: (a) the solid oxide comprises, consists essentially of, or is selected from silica, alumina, silica-alumina, silica-coated alumina, mullite, or any combination thereof; and (b) the electron-withdrawing anion comprises, consists essentially of, or is selected from sulfate, bisulfate, fluorosulfate, phosphate, fluorophosphates, fluoride, or chloride.

Further aspects of this disclosure include: (a) a process for polymerizing olefins comprising contacting at least one olefin monomer and a catalyst composition under polymerization conditions to form a polyolefin, wherein the catalyst composition comprises, or comprises the contact product of, the components disclosed above, and optionally other components described herein; and (b) a method of making a catalyst composition, the method comprising contacting in any order the catalyst composition components disclosed above, and optionally other components described herein.

This disclosure further describes the olefin polymers made by the disclosed process, and also describes fabricating an article of manufacture comprising the olefin polymers produced according to the disclosure, by any technique. The fabricated article can be, for example but is not limited to, an agricultural film, an automobile part, a bottle, a drum, a fiber or fabric, a food packaging film or container, a container preform, a food service article, a fuel tank, a geomembrane, a household container, a liner, a molded product, a medical device or material, a pipe, a sheet or tape, or a toy.

These and other embodiments and aspects of the processes, methods, and compositions including catalyst compositions are described more fully in the Detailed Description and claims and further disclosure such as the Examples provided herein.

### BRIEF DESCRIPTION OF THE FIGURES

FIG. 1 illustrates the structures of exemplary and comparative metallocene compounds that are used in catalyst compositions and processes according to this disclosure.

FIG. 2A provides metallocene activity data in grams polyethylene per gram of metallocene per hour (g/(g·h)) and activator-support (SSA) activity data in grams polyethylene per gram of activator-support per hour (g/(g·h)) as a function of temperature using metallocene MET-2 and fluorided silica-coated alumina (“m-SSA”) as activator.

FIG. 2B illustrates the relationship of metallocene activity in grams polyethylene per gram of metallocene per hour (g/(g·h)) as a function of the activator-support (SSA)-to-metallocene ratio, for both fluorided silica-coated alumina (“m-SSA”) and sulfated alumina (or “s-SSA”) with metallocene MET-2, demonstrating the significantly higher metallocene activity obtainable using m-SSA. The metallocene activity with m-SSA unexpectedly could be further increased with higher ratios of m-SSA, which was not observed with sulfated alumina.

FIG. 3A illustrates the effect of increasing the hydrogen concentration in the ethylene feed on MET-2 metallocene activity in grams polyethylene per gram of metallocene per hour (g/(g·h)) in the absence of a comonomer, demonstrating that high concentration of hydrogen had a negative effect on metallocene activity.

FIG. 3B illustrates the effect of increasing the 1-hexene co-monomer concentration on MET-2 metallocene ethylene-1-hexene polymerization activity in grams polyethylene per gram of metallocene per hour (g/(g·h)) in the absence of hydrogen, demonstrating that higher concentrations of 1-hexene co-monomer had a positive response on metallocene activity.

FIG. 4A illustrates an HLMI response profile for MET-2 versus hydrogen feed concentration in the absence of co-monomer, showing a plot of the logarithm of high load melt index versus the logarithm of the H₂/ethylene feed ratio and demonstrating the excellent melt index response over a wide range of hydrogen feed concentrations in the absence 1-hexene.

FIG. 4B illustrates an HLMI response profile for MET-2 versus 1-hexene co-monomer concentration in the absence of hydrogen, showing a plot of the high load melt index versus the grams of 1-hexene in the polymerization reaction, and showing the melt index potential of the polymer is greatly increased by adding moderate amounts of 1-hexene to the polymerization in the absence of hydrogen.

FIG. 5A provides gel permeation chromatography (GPC) data for polymers producing using metallocene MET-2 and fluorided silica-coated alumina (m-SSA) in the presence of different concentrations of hydrogen in the ethylene feed and in the absence of 1-hexene co-monomer, demonstrated that the molecular weight distribution of polymers produced with increasing amounts of hydrogen show a significant increase in a low molecular weight tail.

FIG. 5B provides gel permeation chromatography (GPC) data for polymers producing using metallocene MET-2 and fluorided silica-coated alumina (m-SSA) in the presence of different concentrations of 1-hexene in the polymerization reaction and in the absence of hydrogen, demonstrating that the molecular weight distribution of polymers produced with increasing amounts of 1-hexene becomes increasingly narrow.

FIG. 5C provides gel permeation chromatography (GPC) data for ethylene-1-hexene co-polymers produced using metallocenes MET-1 through MET-3, and comparative metallocene MET-5 under the polymerization conditions in the Examples. These data show that the allyl-tethered metallocene MET-1 produced an ethylene-1-hexene co-polymer with increased high molecular weight components, while the metallocene with the longer butenyl and pentenyl tethers produce lower amounts of high molecular weight polymer. The molecular weight distribution of the ethylene-1-hexene co-polymer produced using metallocenes MET-5 (DSI) showed a much larger high molecular weight content.

FIG. 6A illustrates the long chain branching (LCB) content of ethylene homopolymers produced using the different metallocene-based catalysts, specifically showing a Janzen-Colby plot of the logarithm of the zero-shear viscosity (Pa·s) versus the logarithm of weight-average molecular weight (Mw) by size exclusion chromatography (SEC) for the designated Examples. Data for homopolymers of ethylene produced using metallocenes MET-1 (Example 19), MET-2 (Example 23), MET-3 (Example 27), and MET-5 (DSI) (Example 35) activated by fluorided silica-coated alumina support-activator (m-SSA) and TIBAL co-catalyst are shown.

FIG. 6B illustrates the long chain branching (LCB) content of ethylene-1-hexene co-polymers produced using different metallocene-based catalysts, specifically showing a Janzen-Colby plot of the logarithm of the zero-shear viscosity (Pa·s) versus the logarithm of weight-average molecular weight (Mw) by size exclusion chromatography (SEC) for the designated Examples. Data for ethylene-1-hexene co-polymers produced using metallocenes MET-1 (Example 2), MET-2 (Example 10), MET-3 (Example 14), and MET-5 (DSI) (Example 18), activated by fluorided silica-coated alumina (m-SSA) support-activator and TIBAL co-catalyst are shown. The copolymers were produced using 30 g of 1-hexene under the polymerization conditions described in the specified examples.

### DETAILED DESCRIPTION OF THE DISCLOSURE

### General Description

This disclosure provides generally for metallocene compounds, catalyst compositions comprising a metallocene compound, processes for polymerizing olefins, methods for making catalyst compositions, olefin polymers and copolymers and articles made from the olefin polymers and copolymers. In an aspect, this disclosure provides generally for catalytic processes for polymerizing olefins to form a polyethylene having limited α-olefin comonomer incorporation, and also provides for metallocene compounds, catalyst compositions comprising metallocene compounds, and methods for making the catalyst compositions. The disclosure also describes the polymers prepared as using the catalytic processes and articles made from the polymers.

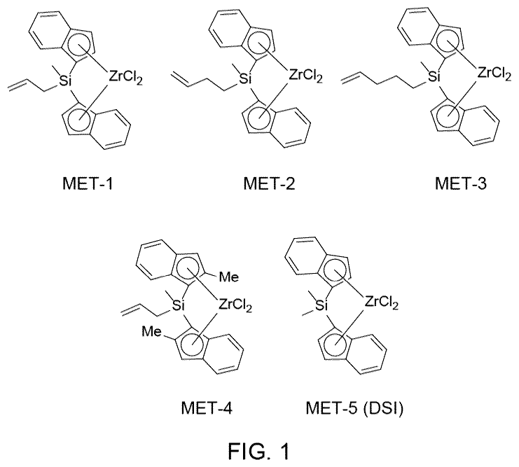

Accordingly, a series of silyl-bridged bis-indenyl metallocenes possessing an omega-alkenyl group on the bridging silicon atom have been synthesized as shown in FIG. 1, and catalyst compositions comprising these metallocenes prepared and used in ethylene polymerizations. These metallocenes were unexpectedly shown to exhibit excellent activities and resin properties when activated using a solid oxide treated with an electron-withdrawing anion (solid super acid or “SSA”) in combination with a co-catalyst such as an organoaluminum compound. Significantly, the resins produced using these metallocene catalyst compositions showed reduced levels of long chain branching while also having a desirable broad molecular weight distribution (MWD or Mw/Mn) of from about 4 to about 7. Therefore, these catalyst compositions fulfil a need for new catalysts with the ability to tune the resulting polyethylene resin properties within certain ranges over a number of parameters such as molecular weights, polydispersity indices, long chain branching, melt indices, and the like, all of which can be tuned to provide the desired resin properties.

The catalyst composition and processes disclosed herein can also include a metallocene activator. The activator can be a compound or material that is capable of converting a transition metal component such as a metallocene compound into an active catalyst that can polymerize olefins. In an aspect, and while not intending to be bound by theory, an activator can function as a Lewis acid and interact with the transition metal or metallocene catalyst to form a cationic complex or incipient cationic complex, which is an active site for olefin polymerization. The metallocene activators disclosed herein can include, but are not limited to, a solid oxide treated with an electron-withdrawing anion (also termed an “activator-support”) in combination with an organoaluminum compound such as trialkylaluminum compounds. In the examples provided with this disclosure, the metallocene compounds were activated for olefin polymerization by contacting the metallocene with a co-catalyst such as triisobutylaluminum and an activator comprising a solid oxide treated with an electron withdrawing anion.

The solid oxide treated with an electron-withdrawing anion is fully described herein, and may also be referred to throughout this disclosure using terms such as a solid oxide that has been chemically-treated with an electron withdrawing anion, a chemically treated solid oxide (CTSO), a solid super acid (SSA), or an activator-support, and these terms are used interchangeably. Examples of the solid oxide that can be used to prepare the solid super acid (SSA) include, but are not limited to, silica, alumina, silica-alumina, silica-coated alumina, aluminum phosphate, mullite, boehmite, heteropolytungstates, titania, zirconia, magnesia, boria, zinc oxide, silica-zirconia, silica-titania, or any combination thereof. Examples of the electron withdrawing anion and the source for the electron withdrawing anion may that can be used to prepare the solid super acid (SSA) include, but are not limited to, fluoride, chloride, bromide, iodide, sulfate, bisulfate, fluorosulfate, fluoroborate, phosphate, fluorophosphate, trifluoroacetate, triflate, mesylate, thiosulfate, fluorozirconate, fluorotitanate, trifluoroacetate, and the like.

Each of the catalyst composition components and processes for making and using the catalyst composition for polymerizing olefins is fully described herein. Definitions of terms that are used in this disclosure are set out.

### Definitions

To define more clearly the terms used herein, the following definitions are provided, and unless otherwise indicated or the context requires otherwise, these definitions are applicable throughout this disclosure. If a term is used in this disclosure but is not specifically defined herein, the definition from the IUPAC Compendium of Chemical Terminology, 2^{nd} Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Regarding claim transitional terms or phrases, the transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Unless specified to the contrary, describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of, apply only to feature class to which it is utilized, and it is possible to have different transitional terms or phrases utilized with different features within a claim. For example, a method can comprise several recited steps (and other non-recited steps) but utilize a catalyst composition preparation consisting of specific steps but utilize a catalyst composition comprising recited components and other non-recited components. While compositions and methods are described in terms of “comprising” various components or steps, the compositions and methods can also “consist essentially of” or “consist of” the various components or steps.

The terms “a,” “an,” and “the” are intended, unless specifically indicated otherwise, to include plural alternatives, e.g., at least one. For instance, the disclosure of “an organoaluminum compound” is meant to encompass one organoaluminum compound, or mixtures or combinations of more than one organoaluminum compound unless otherwise specified.

The terms “configured for use” or “adapted for use” and similar language is used herein to reflect that the particular recited structure or procedure is used in an olefin polymerization system or process. For example, unless otherwise specified, a particular structure “configured for use” means it is “configured for use in an olefin polymerization reactor system” and therefore is designed, shaped, arranged, constructed, and/or tailored to effect an olefin polymerization, as would have been understood by the skilled person.

Groups of elements of the periodic table are indicated using the numbering scheme indicated in the version of the periodic table of elements published in Chemical and Engineering News, 63(5), 27, 1985. In some instances, a group of elements may be indicated using a common name assigned to the group; for example, alkali metals for Group 1 elements, alkaline earth metals for Group 2 elements, transition metals for Group 3-12 elements, and halogens or halides for Group 17 elements.

For any particular compound disclosed herein, a general structure or name presented is also intended to encompass all structural isomers, conformational isomers, and stereoisomers that can arise from a particular set of substituents, unless indicated otherwise. Thus, a general reference to a compound includes all structural isomers unless explicitly indicated otherwise; e.g., a general reference to pentane includes n-pentane, 2-methyl-butane, and 2,2-dimethylpropane, while a general reference to a butyl group includes an n-butyl group, a sec-butyl group, an iso-butyl group, and a tert-butyl group. Additionally, the reference to a general structure or name encompasses all enantiomers, diastereomers, and other optical isomers whether in enantiomeric or racemic forms, as well as mixtures of stereoisomers, as the context permits or requires. For any particular formula or name that is presented, any general formula or name presented also encompasses all conformational isomers, regioisomers, and stereoisomers that can arise from a particular set of substituents.

Groups may be specified according to the atom that is bonded to the metal or bonded to another chemical moiety as a substituent, such as an “oxygen-bonded group,” which is also called an “oxygen group.” For example, an oxygen-bonded group includes species such as hydrocarbyloxide (—OR where R is a hydrocarbyl group, also termed hydrocarboxy), alkoxide (—OR where R is an alkyl group), aryloxide (—OAr where Ar is an aryl group), or substituted analogs thereof, which function as ligands or substituents in the specified location. Therefore, an alkoxide group and an aryloxide group are each a subgenus of a hydrocarbyloxide (hydrocarbyloxy) group.

Unless otherwise specified, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified or unless the context requires otherwise, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. In an aspect, the context could require other ranges or limitations, for example, when the subject carbon-containing group is an aryl group or an alkenyl group, the lower limit of carbons in these subject groups is six carbon atoms and two carbon atoms, respectively. Moreover, other identifiers or qualifying terms may be utilized to indicate the presence or absence of a particular substituent, a particular regiochemistry and/or stereochemistry, or the presence of absence of a branched underlying structure or backbone, and the like.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, by disclosing a temperature of from 70° C. to 80° C., Applicant's intent is to recite individually 70° C., 71° C., 72° C., 73° C., 74° C., 75° C., 76° C., 77° C., 78° C., 79° C., and 80° C., including any sub-ranges and combinations of sub-ranges encompassed therein, and these methods of describing such ranges are interchangeable. Moreover, all numerical end points of ranges disclosed herein are approximate, unless excluded by proviso. As a representative example, if Applicant states that one or more steps in the processes disclosed herein can be conducted at a temperature in a range from 10° C. to 75° C., this range should be interpreted as encompassing temperatures in a range from “about” 10° C. to “about” 75° C.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±15% of the stated value, ±10% of the stated value, ±5% of the stated value, or ±3% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any individual substituents, analogs, compounds, ligands, structures, or groups thereof, or any members of a claimed group, if for any reason Applicant chooses to claim less than the full measure of the disclosure, for example, to account for a reference or prior disclosure that Applicants may be unaware of at the time of the filing of the application.

The term “substituted” when used to describe a group, for example, when referring to a substituted analog of a particular group, is intended to describe any non-hydrogen moiety that formally replaces a hydrogen in that group and is intended to be non-limiting. A group or groups can also be referred to herein as “unsubstituted” or by equivalent terms such as “non-substituted,” which refers to the original group in which a non-hydrogen moiety does not replace a hydrogen within that group. Unless otherwise specified, “substituted” is intended to be non-limiting and include inorganic substituents or organic substituents as understood by one of ordinary skill in the art.

A chemical “group” may be described according to how that group is formally derived from a reference or “parent” compound, for example, by the number of hydrogen atoms formally removed from the parent compound to generate the group, even if that group is not literally synthesized in this manner. These groups can be utilized as substituents or coordinated or bonded to metal atoms. For example, an “alkyl group” formally can be derived by removing one hydrogen atom from an alkane, while an “alkanediyl group” (also referred to as a “alkylene group”) formally can be derived by removing two hydrogen atoms from an alkane. Moreover, a more general term can be used to encompass a variety of groups that formally are derived by removing any number (“one or more”) of hydrogen atoms from a parent compound, which in this example can be described as an “alkane group,” which encompasses an “alkyl group,” an “alkanediyl group,” and materials have three or more hydrogen atoms, as necessary for the situation, removed from the alkane. The disclosure that a substituent, ligand, or other chemical moiety can constitute a particular “group” implies that the known rules of chemical structure and bonding are followed when that group is employed as described. When describing a group as being “derived by,” “derived from,” “formed by,” or “formed from,” such terms are used in a formal sense and are not intended to reflect any specific synthetic method or procedure, unless specified otherwise or the context requires otherwise.

The term “hydrocarbon” whenever used in this specification and claims refers to a compound containing only carbon and hydrogen. Other identifiers can be utilized to indicate the presence of particular groups in the hydrocarbon (e.g., halogenated hydrocarbon indicates that the presence of one or more halogen atoms replacing an equivalent number of hydrogen atoms in the hydrocarbon).

The term “hydrocarbyl” group is used herein in accordance with the definition specified by IUPAC as follows: a univalent group formed by removing a hydrogen atom from a hydrocarbon (that is, a group containing only carbon and hydrogen). Non-limiting examples of hydrocarbyl groups include ethyl, phenyl, tolyl, propenyl, cyclopentyl, and the like. The term “hydrocarbylene” group is also used herein in accordance with the definition specified by IUPAC as follows: a “hydrocarbylene” group refers to a divalent group formed by removing two hydrogen atoms from a hydrocarbon or a substituted hydrocarbon, the free valencies of which are not engaged in forming a double bond. By way of example and comparison, examples of hydrocarbyl and hydrocarbylene groups include, respectively: aryl and arylene; alkyl and alkanediyl (or “alkylene”); cycloalkyl and cycloalkanediyl (or “cycloalkylene”); aralkyl and aralkanediyl (or “aralkylene”); and so forth. For example, an “arylene” group is used in accordance with IUPAC definition to refer to a bivalent group derived from arenes by removal of a hydrogen atom from two ring carbon atoms, which may also be termed an “arenediyl” group. Examples of hydrocarbylene groups include but are not limited to: 1,2-phenylene; 1,3-phenylene; 1,2-propandiyl; 1,3-propandiyl; 1,2-ethandiyl; 1,4-butandiyl; 2,3-butandiyl; and methylene (—CH₂—).

The term “heterohydrocarbyl” group is used herein to refer to a univalent group, which can be linear, branched, or cyclic, formed by removing a single hydrogen atom from [a] a heteroatom or [b] a carbon atom of a parent “heterohydrocarbon” molecule, the heterohydrocarbon molecule being one in which at least one carbon atom is replaced by a heteroatom. Examples of “heterohydrocarbyl” groups formed by removing a single hydrogen atom from a heteroatom of a heterohydrocarbon molecule include, for example: [1] a hydrocarbyloxide group, for example, an alkoxide (—OR) group such as tert-butoxide or aryloxide (—OAr) group such as a substituted or unsubstituted phenoxide formed by removing the hydrogen atom from the hydroxyl (OH) group of a parent alcohol or a phenol molecule; [2] a hydrocarbylsulfide group, for example, an alkylthiolate (—SR) group or arylthiolate (—SAr) group formed by removing the hydrogen atom from the thiol (—SH) group of an alkylthiol or arylthiol; [3] a hydrocarbylamino group, for example, an alkylamino (—NHR) group or arylamino (—NHAr) group formed by removing a hydrogen atom from the amino (—NH₂) group of an alkylamine or arylamine molecule; and [4] a trihydrocarbylsilyl group such as trialkylsilyl (—SiR₃) or triarylsilyl (—SiAr₃) group. Examples of “heterohydrocarbyl” groups formed by removing a single hydrogen atom from a carbon atom of a heterohydrocarbon molecule include, for example, heteroatom-substituted hydrocarbyl groups such as a heteroatom-substituted alkyl group such as trimethylsilylmethyl (—CH₂SiMe₃) or methoxymethyl (—CH₂OCH₃) or a heteroatom-substituted aryl group such as p-methoxy-substituted phenyl (—C₆H₅-p-OCH₃). An “aliphatic” compound is a class of acyclic or cyclic, saturated, or unsaturated, carbon compounds, excluding aromatic compounds, e.g., an aliphatic compound is a non-aromatic organic compound. An “aliphatic group” is a generalized group formed by removing one or more hydrogen atoms (as necessary for the particular group) from a carbon atom of an aliphatic compound. Aliphatic compounds and therefore aliphatic groups can contain organic functional group(s) and/or atom(s) other than carbon and hydrogen.

The term “alkane” whenever used in this specification and claims refers to a saturated hydrocarbon compound. Other identifiers can be utilized to indicate the presence of particular groups in the alkane (e.g., halogenated alkane indicates that the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic and/or linear or branched unless otherwise specified. Primary, secondary, and tertiary alkyl groups are derived by removal of a hydrogen atom from a primary, secondary, and tertiary carbon atom, respectively, of an alkane. The n-alkyl group can be derived by removal of a hydrogen atom from a terminal carbon atom of a linear alkane. The groups of the form RCH₂ (R≠H), R₂CH (R≠H), and R₃C (R≠H) are primary, secondary, and tertiary alkyl groups, respectively, wherein R is itself alkyl group.

The term “carbocyclic” group is used herein to refer to a group in which a carbocyclic compound is the parent compound, that is, a cyclic compound in which all the ring members are carbon atoms. The carbocyclic group is formed by removing one or more hydrogen atoms from the carbocyclic compound. For example, a carbocyclic group can be a univalent group formed by removing a hydrogen atom from a carbocyclic compound. Non-limiting examples of carbocyclic groups include, for example, cyclopentyl, cyclohexyl, phenyl, tolyl, naphthyl and the like.

A “cycloalkane” is a saturated cyclic hydrocarbon, with or without side chains, for example, cyclobutane. Other identifiers can be utilized to indicate the presence of particular groups in the cycloalkane (e.g., halogenated cycloalkane indicates that the presence of one or more halogen atoms replacing an equivalent number of hydrogen atoms in the cycloalkane). Unsaturated cyclic hydrocarbons having one endocyclic double or one triple bond are called cycloalkenes and cycloalkynes, respectively. Those having more than one such multiple bond are cycloalkadienes, cycloalkatrienes, and so forth. Other identifiers can be utilized to indicate the presence of particular groups in the cycloalkenes, cycloalkadienes, cycloalkatrienes, and so forth.

A “cycloalkyl” group is a univalent group derived by removing a hydrogen atom from a ring carbon atom from a cycloalkane. Examples of cycloalkyl groups include cyclobutyl, cyclopentyl, cyclohexyl, and cycloheptyl groups. For clarity, other examples of cycloalkyl groups include a 1-methylcyclopropyl group and a 2-methylcyclopropyl group are illustrated as follows.

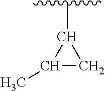 [SMILES: *C1CC1C]

A “cycloalkane group” refers to a generalized group formed by removing one or more hydrogen atoms (as necessary for the particular group and at least one of which is a ring carbon) from a cycloalkane.

The term “alkene” whenever used in this specification and claims refers to an olefin that has at least one carbon-carbon double bond. The term “alkene” includes aliphatic or aromatic, cyclic or acyclic, and/or linear and branched alkene unless expressly stated otherwise. The term “alkene,” by itself, does not indicate the presence or absence of heteroatoms and/or the presence or absence of other carbon-carbon double bonds unless explicitly indicated. Other identifiers may be utilized to indicate the presence or absence of particular groups within an alkene. Alkenes may also be further identified by the position of the carbon-carbon double bond. Alkenes, having more than one such multiple bond are alkadienes, alkatrienes, and so forth, and may be further identified by the position of the carbon-carbon double bond.

An “alkenyl group” is a univalent group derived from an alkene by removal of a hydrogen atom from any carbon atom of the alkene. Thus, “alkenyl group” includes groups in which the hydrogen atom is formally removed from a sp² hybridized (olefinic) carbon atom and groups in which the hydrogen atom is formally removed from any other carbon atom. For example and unless otherwise specified, 1-propenyl (—CH═CHCH₃), 2-propenyl [(CH₃)C═CH₂], and 3-propenyl (—CH₂CH═CH₂) groups are all encompassed with the term “alkenyl group.” Other identifiers may be utilized to indicate the presence or absence of particular groups within an alkene group. Alkene groups may also be further identified by the position of the carbon-carbon double bond. Similarly, a “cycloalkenyl” group is a univalent group derived from a cycloalkene by removal of a hydrogen atom from any carbon atom of the cycloalkene, whether that carbon atom is sp² hybridized (olefinic) or sp³ hybridized carbon atom.

The term “olefin” is used herein in accordance with the definition specified by IUPAC: acyclic and cyclic hydrocarbons having one or more carbon-carbon double bonds apart from the formal ones in aromatic compounds. The class “olefins” subsumes alkenes and cycloalkenes and the corresponding polyenes. Ethylene, propylene, 1-butene, 2-butene, 1-hexene and the like are non-limiting examples of olefins. The term “alpha olefin” as used in this specification and claims refers to an olefin that has a double bond between the first and second carbon atom of the longest contiguous chain of carbon atoms. The term “alpha olefin” includes linear and branched alpha olefins unless expressly stated otherwise.

An “aromatic group” refers to a generalized group formed by removing one or more hydrogen atoms (as necessary for the particular group and at least one of which is an aromatic ring carbon atom) from an aromatic compound. Thus, an “aromatic group” as used herein refers to a group derived by removing one or more hydrogen atoms from an aromatic compound, that is, a compound containing a cyclically conjugated hydrocarbon that follows the Hickel (4n+2) rule and containing (4n+2) pi-electrons, where n is an integer from 1 to about 5. Aromatic compounds and hence “aromatic groups” may be monocyclic or polycyclic unless otherwise specified. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms by trivalent or divalent heteroatoms, in such a way as to maintain the continuous pi-electron system characteristic of aromatic systems and a number of out-of-plane pi-electrons corresponding to the Hückel rule (4n+2)). While arene compounds and heteroarene compounds are mutually exclusive members of the group of aromatic compounds, a compound that has both an arene group and a heteroarene group that compound generally is considered a heteroarene compound. Aromatic compounds, arenes, and heteroarenes may be mono- or polycyclic unless otherwise specified. Examples of arenes include, but are not limited to, benzene, naphthalene, and toluene, among others. Examples of heteroarenes include, but are not limited to furan, pyridine, and methylpyridine, among others. As disclosed herein, the term “substituted” may be used to describe an aromatic group wherein any non-hydrogen moiety formally replaces a hydrogen in that group, and is intended to be non-limiting.

An arene is an aromatic hydrocarbon, with or without side chains (e.g., benzene, toluene, or xylene, among others). An “aryl group” is a group derived from the formal removal of a hydrogen atom from an aromatic hydrocarbon ring carbon atom from an arene compound. One example of an “aryl group” is ortho-tolyl (o-tolyl), the structure of which is shown here.

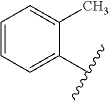 [SMILES: *c1ccccc1C]

The arene can contain a single aromatic hydrocarbon ring (e.g., benzene or toluene), contain fused aromatic rings (e.g., naphthalene or anthracene), and contain one or more isolated aromatic rings covalently linked via a bond (e.g., biphenyl) or non-aromatic hydrocarbon group(s) (e.g., diphenylmethane).

A “heterocyclic compound” is a cyclic compound having at least two different elements as ring member atoms. For example, heterocyclic compounds may comprise rings containing carbon and nitrogen (for example, tetrahydropyrrole), carbon and oxygen (for example, tetrahydrofuran), or carbon and sulfur (for example, tetrahydrothiophene), among others. Heterocyclic compounds and heterocyclic groups may be either aliphatic or aromatic.

An “aralkyl group” is an aryl-substituted alkyl group having a free valance at a non-aromatic carbon atom, for example, a benzyl group and a 2-phenylethyl group are examples of an “aralkyl” group.

A “halide”, also referred to as a “halo” group or a halogen substituent or group has its usual meaning. Examples of halides include fluoride, chloride, bromide, and iodide.

The term “polymer” is used herein generically to include olefin homopolymers, copolymers, terpolymers, and so forth. A copolymer is derived from an olefin monomer and one olefin comonomer, while a terpolymer is derived from an olefin monomer and two olefin comonomers. Accordingly, “polymer” encompasses copolymers, terpolymers, etc., derived from any olefin monomer and comonomer(s) disclosed herein. Similarly, an ethylene polymer would include ethylene homopolymers, ethylene copolymers, ethylene terpolymers, and the like. As an example, an olefin copolymer, such as an ethylene copolymer, can be derived from ethylene and a comonomer, such as 1-butene, 1-hexene, or 1-octene. If the monomer and comonomer were ethylene and 1-hexene, respectively, the resulting polymer could be categorized an as ethylene/1-hexene copolymer.

In like manner, the scope of the term “polymerization” includes homopolymerization, copolymerization, terpolymerization, etc. Therefore, a copolymerization process could involve contacting one olefin monomer (e.g., ethylene) and one olefin comonomer (e.g., 1-hexene) to produce a copolymer.

The term “co-catalyst” is used generally herein to refer to compounds such as organoaluminum compounds, organoboron compounds, organozinc compounds, organomagnesium compounds, organolithium compounds, and the like, that can constitute one component of a catalyst composition, when used, for example, in addition to an activator-support. The term “co-catalyst” is used regardless of the actual function of the compound or any chemical mechanism by which the compound may operate. In one aspect, a co-catalyst can function as an alkylating agent for a metallocene, or a co-catalyst can function to transfer a hydride ligand to the metallocene. Therefore, in an aspect, a co-catalyst can function to provide an activatable ligand (for example, an alkyl or a hydride) to the metallocene, which can engage in olefin polymerization when activated. In this aspect, and while not intending to be bound by theory, it is thought that when the metallocene itself comprises an activatable hydrocarbyl or hydride ligand without being contacting with a co-catalyst, an active catalyst can form without the use of a co-catalyst.

The term “activator”, as used herein, refers generally to a substance that is capable of converting a transition metal component such as a metallocene compound into an active catalyst that can polymerize olefins. In an aspect, the transition metal or metallocene compound can have an activatable ligand which can function as a site for olefin polymerization upon activation. The term “activator” is used regardless of the actual activating mechanism. Illustrative activators include activator-supports, aluminoxanes, organoborate compounds, ionizing ionic compounds, and the like, including combinations thereof.

The terms “solid super acid” or “SSA”, “solid oxide treated with an electron withdrawing anion”, “chemically-treated solid oxide”, “treated solid oxide”, “treated solid oxide compound,” and the like, are used herein to indicate a solid, inorganic oxide of relatively high porosity, which can exhibit Lewis acidic or Brønsted acidic behavior, and which has been treated with an electron-withdrawing component such as an anion or anion source, and which is calcined. The catalyst composition component referred to as the “activator-support” comprises, consists of, consists essentially or, or is selected from a solid oxide treated with an electron-withdrawing anion. The electron-withdrawing component is typically an electron-withdrawing anion source compound. Thus, the solid super acid can comprise a calcined contact product of at least one solid oxide with at least one electron-withdrawing anion source compound. Typically, the solid super acid comprises at least one acidic solid oxide compound. The terms “support” and “activator-support” are not used to imply that these components are inert, and such components should not be construed as an inert component of the catalyst composition.

An “organoaluminum compound,” is used to describe any compound that contains an aluminum-carbon bond. Thus, organoaluminum compounds include, but are not limited to, hydrocarbyl aluminum compounds such as trihydrocarbyl-, dihydrocarbyl-, or monohydrocarbylaluminum compounds; hydrocarbylaluminum halide compounds; hydrocarbylalumoxane compounds; and aluminate compounds which contain an aluminum-organyl bond such as tetrakis(p-tolyl)aluminate salts. An “organoboron” compound, an “organozinc compound,” an “organomagnesium compound,” and an “organolithium compound” are used in an analogous fashion to describe any compound that contains a direct metal-carbon bond between an organic group and the recited metal.

The terms “catalyst composition,” “catalyst mixture,” “catalyst system,” and the like, do not depend upon the actual product or composition resulting from the contact or reaction of the initial components of the claimed catalyst composition/mixture/system, the nature of the active catalytic site, or the fate of the co-catalyst, the metallocene compound(s), any olefin monomer used to prepare a precontacted mixture, or the activator (e.g., activator-support), after combining these components. Therefore, the terms “catalyst composition,” “catalyst mixture.” “catalyst system,” and the like, encompass the initial starting components of the composition, as well as whatever product(s) may result from contacting these initial starting components, and this is inclusive of both heterogeneous and homogenous catalyst systems or compositions. The terms “catalyst composition,” “catalyst mixture,” “catalyst system,” and the like, are used interchangeably throughout this disclosure.

The term “contact product” is used herein to describe compositions wherein the components are contacted together in any order, in any manner, and for any length of time. For example, the components can be contacted by blending or mixing. Further, contacting of any component can occur in the presence or absence of any other component of the compositions described herein. Combining additional materials or components can be done by any suitable method. Further, the term “contact product” includes mixtures, blends, solutions, slurries, reaction products, and the like, or combinations thereof. Although “contact product” can include reaction products, it is not required for the respective components to react with one another. Similarly, the term “contacting” is used herein to refer to materials which can be blended, mixed, slurried, dissolved, reacted, allowed to react, treated, or otherwise contacted in some other manner.

Similarly, the term “precontacted” mixture is used herein to describe a first mixture of catalyst components that are contacted for a first period of time prior to the first mixture being used to form a “postcontacted” or second mixture of catalyst components that are contacted for a second period of time.

Although any methods, devices, and materials similar or equivalent to those described herein can be used in the practice or testing of the invention, the typical methods, devices, and materials are herein described.

All publications and patents mentioned herein are incorporated herein by reference for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

### Metallocene Compounds and Metallocene-Based Catalyst Compositions

The present invention is directed generally to new metallocene compounds, new catalyst systems and catalyst compositions comprising the metallocene compounds, methods for preparing the catalyst compositions, methods for using the catalyst compositions to polymerize olefins, the polymer resins produced using such catalyst compositions, and articles produced using these polymer resins.

Accordingly, in an aspect this disclosure provides a metallocene compound, having the formula (X¹)(X²)(X³)(X⁴)M¹, wherein: M¹ is titanium, zirconium, or hafnium; X¹ and X² are independently a substituted or an unsubstituted indenyl ligand, wherein a substituent, when present, is selected independently from a halogen or a C₁-C₂₀ hydrocarbyl group; X¹ and X² are bridged by a linking group having the formula >Si[(CH₂)ₙCH═CH₂]R¹, wherein n is 1, 2, 3, 4, 5, or 6, and R¹ is H or a C₁ to C₂₀ hydrocarbyl group; and X³ and X⁴ are independently a halide, hydride, a C₁-C₂₀ hydrocarbyl group, a C₁-C₂₀ heterohydrocarbyl group, tetrahydroborate, or OBR^{A}₂ or OSO₂R^{A}, wherein R^{A} is independently a C₁-C₁₂ hydrocarbyl group.

A further aspect of this disclosure provides a catalyst composition for polymerizing olefins, the catalyst composition comprising or comprising the contact product of:
(a) a metallocene compound having the formula:

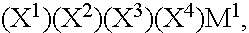

wherein
M¹ is titanium, zirconium, or hafnium;
X¹ and X² are independently a substituted or an unsubstituted indenyl ligand, wherein a substituent, when present, is selected independently from a halogen or a C₁-C₂₀ hydrocarbyl group;
X¹ and X² are bridged by a linking group having the formula >Si[(CH₂)ₙCH═CH₂]R¹, wherein n is 1, 2, 3, 4, 5, or 6, and R¹ is H or a C₁ to C₂₀ hydrocarbyl group; and
X³ and X⁴ are independently a halide, hydride, a C₁-C₂₀ hydrocarbyl group, a C₁-C₂₀ heterohydrocarbyl group, tetrahydroborate, or OBR^{A}₂ or OSO₂R^{A}, wherein R^{A} is independently a C₁-C₁₂ hydrocarbyl group;
(b) an activator-support comprising a solid oxide treated with an electron-withdrawing anion (“solid super acid”); and
(c) a co-catalyst such as an organoaluminum co-catalyst.
   The activator-support and the components thereof and the organoaluminum compound are described in detail hereinbelow. Using the catalyst composition disclosed above, this disclosure provides a process for polymerizing olefins comprising contacting at least one olefin monomer and a catalyst composition under polymerization conditions to form a polyolefin, wherein the catalyst composition is disclosed above, and optionally other components described herein. A method of making a catalyst composition, the method comprising contacting in any order the catalyst composition components disclosed above, and optionally other components is described herein.

In further aspects of the catalyst composition, the process for polymerizing olefins, and the method of making a catalyst composition described here, the metallocene compound can have the formula (X¹)(X²)(X³)(X⁴)M¹, wherein M¹ can be zirconium or hafnium; X¹ and X² independently can be a substituted or an unsubstituted indenyl ligand, wherein a substituent, when present, is selected independently from a C₁-C₁₅ hydrocarbyl group; X¹ and X² can be bridged by a linking group having the formula >Si[(CH₂)ₙCH═CH₂]R¹, wherein n is 1, 2, 3, 4, 5, or 6, and R¹ is H or a C₁-C₁₅ hydrocarbyl; and X³ and X⁴ can be independently selected from F, Cl, Br, a hydride, a C₁-C₁₂ hydrocarbyl group, a C₁-C₁₂ hydrocarbyloxide group, or an SiR²₃-substituted C₁ to C₁₅ hydrocarbyl group wherein R² is independently a C₁ to C₆ hydrocarbyl group.

In still a further aspects of the catalyst composition, the process for polymerizing olefins, and the method of making a catalyst composition described here, the metallocene compound can have the formula (X¹)(X²)(X³)(X⁴)M¹, wherein M¹ can be Ti; alternatively, M¹ can be Zr; alternatively, M¹ can be Hf; or alternatively, M¹ can be Zr or Hf. In this metallocene formula, X³ and X⁴ can be independently selected from F, Cl, Br, a hydride, a C₁-C₁₂ hydrocarbyl group, a C₁-C₁₂ hydrocarbyloxide group, or an SiR²₃-substituted C₁ to C₁₂ hydrocarbyl group wherein R² is independently a C₁ to C₆ hydrocarbyl group. For example, X³ and X⁴ can be independently selected from Cl or Br.

In an aspect of the metallocene formula (X¹)(X²)(X³)(X⁴)M¹, wherein X¹ and X² are bridged by a linking group having the formula >Si[(CH₂)ₙCH═CH₂]R¹, wherein n can be 1, 2, 3, 4, 5, or 6, or even greater than 6, and wherein R¹ can be H or a C₁ to C₁₂ hydrocarbyl group. In this linking group, n can be 1; alternatively, n can be 2; alternatively, n can be 3; alternatively, n can be 4; alternatively, n can be 5; alternatively, n can be 6; alternatively, n can be 7; or alternatively, n can be 8. In an aspect of this linking group >Si[(CH₂)ₙCH═CH₂]R, R¹ can be a C₁ to C₁₀ hydrocarbyl group; alternatively a C₁ to C₈ hydrocarbyl group; or alternatively a C₁ to C₆ hydrocarbyl group. For example, R¹ can be a C₁ to C₁₀ saturated hydrocarbyl group; alternatively a C₁ to C₈ saturated hydrocarbyl group; or alternatively a C₁ to C₆ saturated hydrocarbyl group. Examples of R¹ include, but are not limited to methyl, ethyl, propyl, butyl, pentyl, hexyl, cyclopentyl, cyclohexyl, phenyl, tolyl, or benzyl. In addition, R¹ can also be (CH₂)ₙCH═CH₂, such that X¹ and X² are bridged by a linking group having the formula >Si[(CH₂)ₙCH═CH₂]₂.

In another aspect of the metallocene formula (X¹)(X²)(X³)(X⁴)M¹, wherein X¹ and X² are bridged by a linking group >Si[(CH₂)ₙCH═CH₂]R¹, the linking group formula can be, but is not limited to, >Si[CH₂CH═CH₂]Me, >Si[(CH₂)₂CH═CH₂]Me, >Si[(CH₂)₃CH═CH₂]Me, >Si[(CH₂)4CH═CH₂]Me, >Si[CH₂CH═CH₂]Ph, >Si[(CH₂)₂CH═CH₂]Ph, >Si[(CH₂)₃CH═CH₂]Ph, >Si[(CH₂)₄CH═CH₂]Ph, >Si[CH₂CH═CH₂]₂, >Si[(CH₂)₂CH═CH₂]₂, >Si[(CH₂)₃CH═CH₂]₂, or >Si[(CH₂)₄CH═CH₂]₂.

According to another aspect of the metallocene compound (X¹)(X²)(X³)(X⁴)M¹ which is used in the catalyst compositions and olefin polymerization process, X¹ and X² are independently a substituted or an unsubstituted indenyl ligand, wherein a substituent, when present, can be a C₁-C₂₀ hydrocarbyl group. Thus, X¹ can be an unsubstituted indenyl ligand, and X² can be a substituted indenyl ligand comprising one or more independently selected substituents; or both X¹ and X² are unsubstituted indenyl ligands. In another aspect, both X¹ and X² can be substituted indenyl ligands comprising one or more independently selected substituents.

The C₁-C₂₀ hydrocarbyl group, when present as a substituent on X¹ or X², can be independently selected from a C₁-C₁₂ hydrocarbyl group, a C₁-C₁₀ hydrocarbyl group, a C₁-C₈ hydrocarbyl group, a C₁-C₆ hydrocarbyl group, or a C₁-C₄ hydrocarbyl group. For example, the C₁-C₂₀ hydrocarbyl group when present as a substituent on X¹ or X², can be independently selected from a C₁-C₂₀ aliphatic group, a C₆-C₂₀ aromatic group, a C₁-C₁₂ aliphatic group, a C₆-C₁₂ aromatic group, a C₁-C₁₀ aliphatic group, or a C₆-C₁₀ aromatic group, wherein the carbon count includes any hydrocarbyl substituent on the aliphatic group or the aromatic group. Thus, the any substituent on X¹ and X², when present, can be independently selected from a C₁-C₁₂ alkyl, a C₂-C₁₂ alkenyl, a C₃-C₇ cycloalkyl, a C₆-C₁₀ aryl, or a C₇-C₁₂ aralkyl. For example, the C₁-C₂₀ hydrocarbyl group substituent, when present as a substituent on X¹ or X², can be independently selected from methyl, ethyl, propyl, butyl, pentyl, hexyl, cyclopentyl, cyclohexyl, phenyl, tolyl, benzyl, naphthyl, or biphenyl.

In the catalyst composition, the process for polymerizing olefins, or a method of making a catalyst composition, in an aspect, the metallocene compound also can have the formula:

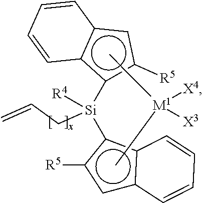

wherein
M¹ is zirconium or hafnium;
x is 1, 2, 3, 4, 5, or 6;
R⁴ is selected from H or a C₁-C₁₂ hydrocarbyl;
R⁵ in each occurrence is selected independently from H or a C₁-C₂₀ hydrocarbyl; and
X³ and X⁴ are independently selected from F, Cl, Br, a hydride, a C₁-C₁₂ hydrocarbyl group, or a C₁-C₁₂ hydrocarbyloxide group.
   In this aspect, R⁴ of this metallocene compound can be selected from H or a C₁-C₁₀ hydrocarbyl; and R⁵ in each occurrence can be selected independently from H or a C₁-C₁₅ hydrocarbyl. For example, the R⁴ substituent can be selected from methyl, ethyl, propyl, butyl, pentyl, hexyl, cyclopentyl, cyclohexyl, phenyl, tolyl, benzyl, and the like.

According to a further aspect, in the catalyst composition, the process for polymerizing olefins, or a method of making a catalyst composition, in an aspect, the metallocene compound also can have the formula:

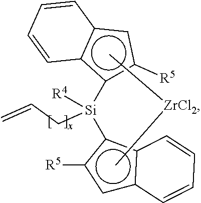

wherein
x is 1, 2, 3, 4, 5, or 6;
R⁴ is methyl or phenyl; and
R⁵ in each occurrence is selected independently from H, methyl, or phenyl.
   Examples of metallocenes include, but are not limited to, a metallocene compound having the formula:

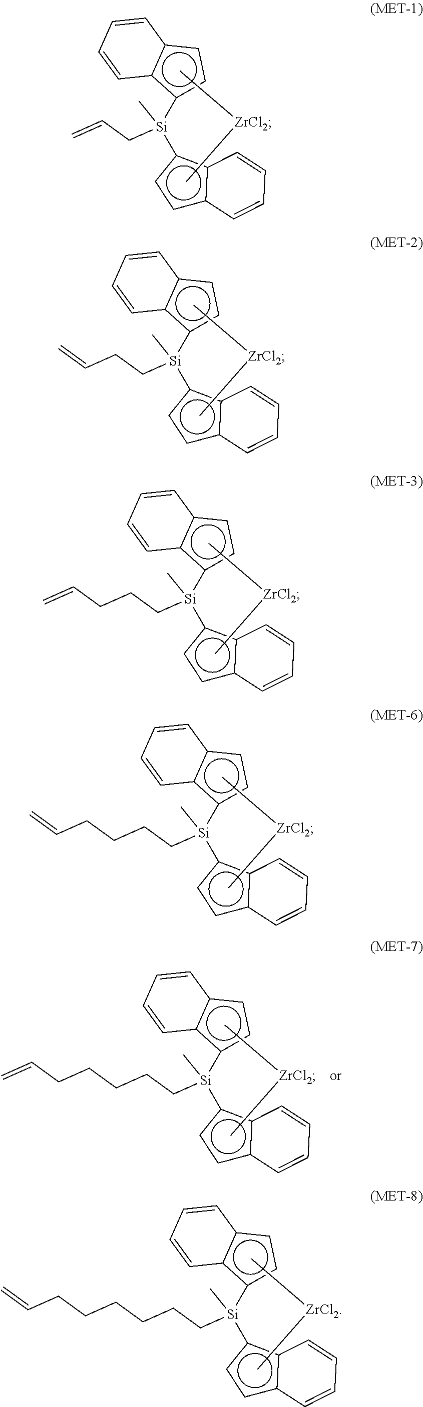

While the catalyst composition, the process for polymerizing olefins, and the method of making a catalyst composition described herein are described in terms of the single metallocene having the X¹ and X² ligands bridged by the linking group >Si[(CH₂)ₙCH═CH₂]R¹, the catalyst composition can include another metallocene compound, such as a second metallocene used in a single polymerization reactor or in tandem reactors, or the catalyst composition can be absent any other metallocene compound. such as a second metallocene used in a single polymerization reactor or in tandem reactors. Accordingly, the contacting step to make the catalyst composition can include contacting other catalyst composition components with another (e.g. second) metallocene or the contacting step can be absent contacting other catalyst composition components with other (e.g. second) metallocene compound.

### Metallocene Syntheses

The general procedure for metallocene synthesis is illustrated in Scheme 1, and the detailed procedure is set out in the Examples. The structures of metallocenes prepared and analyzed are shown in FIG. 1.

The silyl-bridged bis(indenyl) metallocenes having an omega-(ω-)alkenyl moiety on the silyl bridge were prepared as shown in Scheme 1. The general metallocene preparation is described in the Examples for the allylmethylsilyl-bridged metallocene. The (ω-butenyl)methylsilyl bis-indene and the (ω-pentenyl)methylsilyl bis-indene ligands were prepared, and the allylmethylsilyl bis-indene ligand was produced from the commercially available allyl (dichloro)methylsilane and indene which was deprotonated using n-butyl lithium. The allylmethylsilyl bis-indene ligand was subsequently lithiated and metallated through a salt metathesis reaction to provide a rac/meso mixture of the metallocene shown in Scheme 1. Pure rac allylmethylsilyl bis(indenyl) metallocene (MET-1) could be isolated by fractional recrystallization from toluene and heptane.

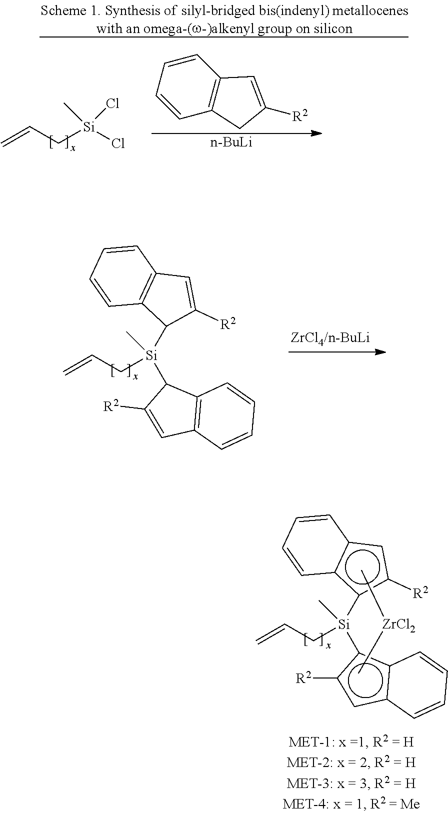

To systematically investigate the effect of the tethered olefin length on LCB formation, longer alkenyl chain substituted analogs, for example, butenyl (MET-2) and pentenyl (MET-3) analogs, were successfully obtained using the similar procedure, starting from butenyl and pentenyl dichloromethylsilanes, respectively. The synthesis for these two dichlorosilanes was developed by Chevron Phillips Chemical Company. A metallocene (MET-4) with 2-methyl substituent on the indenyl rings was also prepared by an analogous route and examined. The structures of the metallocenes are shown in FIG. 1. Other metallocenes which can be prepared and used as described herein include, but are not limited to, metallocenes having the following structures:

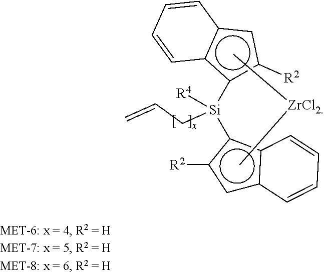

The comparative metallocene used as a benchmark in these polymerization studies was the commercial catalyst dimethylsilyl bis(indenyl) zirconium dichloride (MET-5), which has the following structure with a dimethylsilyl linking group, absent any alkenyl moiety.

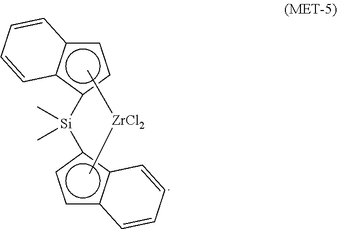

### Metallocene Activators

Each of the catalyst composition, the process for polymerizing olefins, and the method of making a catalyst composition according to this disclosure utilize a metallocene compound and a metallocene activator. In this aspect, metallocene activators can comprise, consist of, consist essentially of, or be selected independently from any composition that is capable of activating the metallocene compound towards olefin polymerization. Examples of metallocene activators include but are not limited to a solid oxide treated with an electron-withdrawing anion, an organoboron compound, a borate or an organoborate compound, an ionizing ionic compound, an aluminoxane compound, or any combinations thereof. Examples of these are described hereinbelow.

### Activator-Support (Solid Super Acid or “SSA”)

The activator-support that is used in the processes and the catalyst composition can comprise, consist essentially of, or can be selected from a solid oxide chemically-treated with an electron withdrawing anion, also termed a “solid super acid” or “SSA”. That is, any solid oxide or combinations of solid oxides disclosed herein that have been contacted and/or chemically-treated with any electron-withdrawing anion or combinations of electron-withdrawing anions disclosed herein can be used. Each of these components is set out in more detail below. Generally, examples of solid oxide that can be used in this disclosure include, but are not limited to, silica, alumina, silica-alumina, silica-coated alumina, aluminum phosphate, mullite, silica-zirconia, silica-titania, bentonite, or any combination thereof, and the like. Generally, examples of the electron withdrawing anions that can be used in accordance with this disclosure include, but are not limited to, fluoride, chloride, phosphate, triflate, sulfate, bisulfate, and the like. Therefore sources of these anions are used in preparing the solid super acid.

According to a further aspect, in the processes or catalyst composition disclosed herein, the solid oxide chemically-treated with an electron withdrawing anion can comprise, consist essentially of, or be selected from at least one solid oxide treated with at least two electron-withdrawing anions, and the at least two electron-withdrawing anions can comprise, consist essentially of, or be selected from fluoride and phosphate, fluoride and sulfate, chloride and phosphate, chloride and sulfate, triflate and sulfate, or triflate and phosphate.

In an aspect, the solid oxide treated with an electron-withdrawing anion can comprise a sulfur oxoacid anion-modified solid oxide, a phosphorus oxoacid anion-modified solid oxide, or a halide ion-modified solid oxide. In another aspect, the solid oxide treated with an electron-withdrawing anion can be generated by treatment of a solid oxide with an acid or a salt of an electron-withdrawing anion. In an aspect, following treatment of the solid oxide with the acid or the salt of an electron-withdrawing anion, the solid oxide treated with an electron-withdrawing anion can be dried and calcined.

While further details of a solid super acid are set out below, generally, a wide range of solid oxides and sources of electron-withdrawing anions can be used to prepare the solid super acid. For example, in various aspects: 1) the solid oxide chemically-treated with an electron withdrawing anion can have a surface area from about 100 m²/g to about 1000 m²/g, a pore volume from about 0.25 mL/g to about 3.0 mL/g, and an average particle size from about 5 microns to about 150 microns; 2) the solid oxide chemically-treated with an electron withdrawing anion can have a pore volume from about 0.5 mL/g to about 2.5 mL/g; and/or the solid oxide chemically-treated with an electron withdrawing anion can have a surface area from about 150 m²/g to about 700 m²/g.

The term “solid super acid” (or “SSA”) is used interchangeably with “activator support” and similar terms such as, “solid oxide treated with an electron-withdrawing anion,” “chemically-treated solid oxide”, or “treated solid oxide.” While not intending to be bound by theory, it is thought that the solid super acid can serve as an acidic activator-support. In an aspect, the solid super acid typically can be used in combination with a co-catalyst such as an organoaluminum compound or similar activating agent or alkylating agent. In another aspect, the metallocene compound can be “pre-activated” by, for example, being alkylated prior to its use in the catalyst composition, prior to contacting the solid super acid.

In one aspect of this disclosure, the catalyst composition can comprise at least one solid super acid comprising at least one solid oxide treated with at least one electron-withdrawing anion, wherein the solid oxide can comprise any oxide that is characterized by a high surface area, and the electron-withdrawing anion can comprise any anion that increases the acidity of the solid oxide as compared to the solid oxide that is not treated with at least one electron-withdrawing anion.

In another aspect of this disclosure, the catalyst composition can comprise a solid super acid or “chemically-treated solid oxide” comprising a solid oxide treated with an electron-withdrawing anion, wherein: the solid oxide comprises, consists of, consists essentially of, or is selected from silica, alumina, titania, zirconia, magnesia, boria, calcia, zinc oxide, silica-alumina, silica-coated alumina, silica-titania, silica-zirconia, silica-magnesia, alumina-titania, alumina-zirconia, zinc-aluminate, alumina-boria, silica-boria, aluminum phosphate, aluminophosphate, aluminophosphate-silica, magnesium aluminate, titania-zirconia, mullite, boehmite, heteropolytungstates, mixed oxides thereof, a pillared clay such as a pillared montmorillonite, or any combination thereof.

According to a further aspect, the catalyst composition can comprise a solid super acid comprising a solid oxide treated with an electron-withdrawing anion, wherein the electron-withdrawing anion comprises or is selected from fluoride, chloride, bromide, iodide, sulfate, bisulfate, fluorosulfate, phosphate, fluorophosphate, triflate, mesylate, tosylate, thiosulfate, C₁-C₁₀ alkyl sulfonate, C₆-C₁₄ aryl sulfonate, trifluoroacetate, fluoroborate, fluorozirconate, fluorotitanate, or any combination thereof.

In this aspect, the activator-support can comprise, consist of, consist essentially of, or be selected from a solid oxide treated with an electron-withdrawing anion, wherein:
a) the solid oxide comprises, consists of, consists essentially of, or is selected from silica, alumina, silica-alumina, silica-coated alumina, mullite, aluminum phosphate, aluminophosphate, heteropolytungstate, titania, zirconia, magnesia, boria, zinc oxide, a mixed oxide thereof, or any mixture thereof; and
b) the electron-withdrawing anion comprises, consists of, consists essentially of, or is selected from sulfate, bisulfate, fluorosulfate, phosphate, fluorophosphates, fluoride, or chloride.

In another aspect, the catalyst composition can comprise a solid super acid comprising a solid oxide treated with an electron-withdrawing anion, wherein: the solid oxide is selected from silica, alumina, silica-alumina, silica-coated alumina, titania, zirconia, mullite, mixed oxides thereof, or mixtures thereof; and the electron-withdrawing anion is selected from fluoride, chloride, bisulfate, sulfate, or any combination thereof.

In a further aspect, the solid oxide treated with an electron withdrawing anion can comprise at least one solid oxide treated with at least two electron-withdrawing anions, and wherein the at least two electron-withdrawing anions comprise fluoride and phosphate, fluoride and sulfate, chloride and phosphate, chloride and sulfate, triflate and sulfate, or triflate and phosphate, or any combination of two electron-withdrawing anions or sources for electron-withdrawing anions disclosed herein.

According to a further aspect, the solid oxide treated with an electron-withdrawing anion can be generated by treatment of a solid oxide with sulfuric acid, sulfate ion, bisulfate ion, fluorosulfuric acid, fluorosulfate ion, phosphoric acid, phosphate ion, fluorophosphoric acid, monofluorophosphate ion, triflic (trifluoromethanesulfonic) acid, triflate trifluoromethanesulfonate) ion, methanesulfonic acid, mesylate (methanesulfonate) ion, toluenesulfonic acid, tosylate (toluenesulfonate) ion, thiosulfate ion, C₁-C₁₀ alkyl sulfonic acid, C₁-C₁₀ alkyl sulfonate ion, C₆-C₁₄ aryl sulfonic acid, C₆-C₁₄ aryl sulfonate ion, fluoride ion, chloride ion, or any combination thereof. In an aspect, the solid oxide treated with an electron withdrawing anion comprises a sulfated solid oxide, bisulfated (hydrogen sulfated) solid oxide, fluorosulfated solid oxide, phosphated solid oxide, fluorophosphated solid oxide, fluoride solid oxide, or chloride solid oxide.

In an aspect, various examples of a solid oxide chemically-treated with an electron withdrawing anion (“solid super acid”) that can be used can comprise, can consist essentially of, or can be selected from fluorided alumina, chlorided alumina, bromided alumina, sulfated alumina, fluorided silica-alumina, chlorided silica-alumina, bromided silica-alumina, sulfated silica-alumina, fluorided silica-coated alumina (m-SSA), chlorided silica-coated alumina, bromided silica-coated alumina, fluorided silica-zirconia, chlorided silica-zirconia, bromided silica-zirconia, sulfated silica-zirconia, fluorided mullite, chlorided mullite, bromided mullite, sulfated mullite, or a pillared clay such as a pillared montmorillonite that is treated with fluoride, chloride, or sulfate, phosphated alumina, or other aluminophosphates treated with sulfate, fluoride, or chloride, or any combination of these activator-supports.

According to an aspect, the electron withdrawing anion can comprise or can be selected from a sulfur oxoacid anion-modified solid oxide generated by sulfuric acid treatment or sulfate ion treatment. In another aspect, the electron withdrawing anion comprises or is selected from a phosphorus oxoacid anion-modified solid oxide generated by phosphoric acid treatment or phosphate ion treatment. The solid oxide treated with an electron withdrawing anion can include any solid oxide or combinations of solid oxides disclosed herein, treated with any electron-withdrawing anion or combinations of electron-withdrawing anions disclosed herein. Further, the solid oxide treated with an electron-withdrawing anion can be produced by a process comprising contacting any suitable solid oxide and any suitable solid oxide with an electron-withdrawing anion to provide a mixture, and concurrently and/or subsequently drying and/or calcining the mixture.

Further, and in yet another aspect, the solid super acid can further comprise a metal or metal ion selected from zinc, nickel, vanadium, titanium, silver, copper, gallium, tin, tungsten, molybdenum, or any combination thereof. Therefore, in another aspect and in any embodiment of this disclosure, for example, the solid super acid can be selected from any solid super acid disclosed herein, which can further comprise a metal or metal ion selected from zinc, nickel, vanadium, silver, copper, gallium, tin, tungsten, molybdenum, or any combination thereof. By example, the activator-support can comprise, consist essentially or, or can be selected from fluorided alumina, chlorided alumina, sulfated alumina, fluorided silica-alumina, chlorided silica-alumina, sulfated silica-alumina, fluorided silica-coated alumina (m-SSA), chlorided silica-coated alumina, bromided silica-coated alumina, fluorided silica-zirconia, sulfated silica-zirconia, or any combination thereof, that further can further comprise a metal or metal ion selected from zinc, nickel, vanadium, tin, or any combination thereof.

In an aspect, the solid super acid s that further comprise a metal or metal ion can comprise, consist essentially of, or be selected from zinc- or titanium-impregnated fluorided alumina, zinc- or titanium-impregnated chlorided alumina, zinc- or titanium-impregnated bromided alumina, zinc- or titanium-impregnated sulfated alumina, zinc- or titanium-impregnated fluorided silica-alumina, zinc- or titanium-impregnated chlorided silica-alumina, zinc- or titanium-impregnated bromided silica-alumina, zinc- or titanium-impregnated sulfated silica-alumina, chlorided zinc aluminate, fluorided zinc aluminate, bromided zinc aluminate, sulfated zinc aluminate, or any combination thereof. In another aspect, the solid super acids that further comprise a metal or metal ion can comprise, consist essentially of, or be selected from zinc- or titanium-impregnated fluorided silica-zirconia, zinc- or titanium-impregnated chlorided silica-zirconia, zinc- or titanium-impregnated bromided silica-zirconia, zinc- or titanium-impregnated sulfated silica-zirconia, zinc- or titanium-impregnated fluorided silica-coated alumina (m-SSA), zinc- or titanium-impregnated chlorided silica-coated alumina, zinc- or titanium-impregnated bromided silica-coated alumina, zinc- or titanium-impregnated sulfated silica-coated alumina, or any combination thereof.

In yet a further aspect and in any embodiment of this disclosure, the solid super acid can comprise the contact product of at least one solid oxide compound and at least one electron-withdrawing anion source. The solid oxide compound and electron-withdrawing anion source are described independently herein and may be utilized in any combination to further describe the solid super acid comprising the contact product of at least one solid oxide compound and at least one electron-withdrawing anion source. That is, the solid super acid is provided upon contacting or treating the solid oxide with the electron-withdrawing anion source. In one aspect, the solid oxide compound can comprise or alternatively be selected from, an inorganic oxide. It is not required that the solid oxide compound be calcined prior to contacting the electron-withdrawing anion source. The contact product may be calcined either during or after the solid oxide compound is contacted with the electron-withdrawing anion source. In this aspect, the solid oxide compound may be calcined or uncalcined. In another aspect, the activator-support may comprise the contact product of at least one calcined solid oxide compound and at least one electron-withdrawing anion source.

While not intending to be bound by theory, the solid super acid, also termed the activator-support, exhibits enhanced acidity as compared to the corresponding untreated solid oxide compound. The solid super acid also functions as a catalyst activator as compared to the corresponding untreated solid oxide. While the solid super acid may activate the metallocene compound in the absence of additional activators, additional activators may be utilized in the catalyst composition. By way of example, it may be useful to include an organoaluminum compound in the catalyst composition along with the metallocene compound(s) and solid super acid. The activation function of the activator-support is evident in the enhanced activity of catalyst composition as a whole, as compared to a catalyst composition containing the corresponding untreated solid oxide.

In one aspect, the solid super acid of this disclosure can comprise a solid inorganic oxide material, a mixed oxide material, or a combination of inorganic oxide materials, that is chemically-treated with an electron-withdrawing component, and optionally treated with a metal. Thus, the solid oxide of this disclosure encompasses oxide materials such as alumina, “mixed oxide” compounds thereof such as silica-alumina, and combinations and mixtures thereof. The mixed oxide compounds such as silica-alumina can be single or multiple chemical phases with more than one metal combined with oxygen to form a solid oxide compound, and are encompassed by this disclosure. The solid inorganic oxide material, mixed oxide material, combination of inorganic oxide materials, electron-withdrawing component, and optional metal are independently described herein and may be utilized in any combination to further described the solid super acid.

In another aspect, the solid super acid of this disclosure can comprise a solid oxide of relatively high porosity, which exhibits Lewis acidic or Brønsted acidic behavior. The solid oxide is chemically-treated with an electron-withdrawing component, typically an electron-withdrawing anion, to form an activator-support. While not intending to be bound by the following statement, it is believed that treatment of the inorganic oxide with an electron-withdrawing component augments or enhances the acidity of the oxide. Thus in one aspect, the activator-support exhibits Lewis or Brønsted acidity which is typically greater than the Lewis or Brønsted acid strength of the untreated solid oxide, or the activator-support has a greater number of acid sites than the untreated solid oxide, or both. One method to quantify the acidity of the chemically-treated and untreated solid oxide materials is by comparing the oligomerization activities of the treated and untreated oxides under acid catalyzed reactions.

In one aspect, the solid super acid can comprise a solid inorganic oxide comprising oxygen and at least one element selected from Group 2, 3, 4, 5, 6, 7, 8, 9, 10, 11, 12, 13, 14, or 15 of the periodic table, or comprising oxygen and at least one element selected from the lanthanide or actinide elements; alternatively, the solid super acid can comprise a solid inorganic oxide comprising oxygen and at least one element selected from Group 4, 5, 6, 12, 13, or 14 of the periodic table, or comprising oxygen and at least one element selected from the lanthanide elements. (See: Hawley's Condensed Chemical Dictionary, 11^{th} Ed., John Wiley & Sons; 1995; Cotton, F. A.; Wilkinson, G.; Murillo; C. A.; and Bochmann; M. Advanced Inorganic Chemistry, 6^{th} Ed., Wiley-Interscience, 1999.) Usually, the inorganic oxide can comprise oxygen and at least one element selected from Al, B, Be, Bi, Cd, Co, Cr, Cu, Fe, Ga, La, Mn, Mo, Ni, Sb, Si, Sn, Sr, Th, Ti, V, W, P, Y, Zn or Zr; alternatively, the inorganic oxide can comprise oxygen and at least one element selected from Al, B, Si, Ti, P, Zn or Zr.

Further suitable examples of solid oxide materials or compounds that can be used in the solid super acid of the present disclosure include, but are not limited to, Al₂O₃, B₂O₃, BeO, Bi₂O₃, CdO, Co₃O₄, Cr₂O₃, CuO, Fe₂O₃, Ga₂O₃, La₂O₃, Mn₂O₃, MoO₃, Na₂O, NiO, P₂O₅, Sb₂O₅, SiO₂, SnO₂, SrO, ThO₂, TiO₂, V₂O₅, WO₃, Y₂O₃, ZnO, ZrO₂, K₂O, CaO, Ce₂O₃, and the like, including mixtures thereof, mixed oxides thereof, and any combinations thereof. Alternatively, suitable examples of solid oxide materials or compounds that can be used in the solid super acid of the present disclosure include, but are not limited to, Al₂O₃, B₂O₃, SiO₂, SnO₂, TiO₂, V₂O₅, WO₃, Y₂O₃, ZnO, ZrO₂, and the like, including mixed oxides thereof, and combinations thereof, for example, silica-alumina. Alternatively, suitable examples of solid oxide materials or compounds that can be used in the solid super acid of the present disclosure include, but are not limited to, Al₂O₃, SiO₂, TiO₂, ZrO₂, and the like, including mixed oxides thereof, and combinations thereof.

Examples of mixed oxides that can be used in the activator-support of the present disclosure include, but are not limited to, silica-alumina, silica-titania, silica-zirconia, zeolites, many clay minerals, alumina-titania, alumina-zirconia, zinc-aluminate and the like; alternatively, examples of mixed oxides that can be used in the activator-support of the present disclosure include, but are not limited to, silica-alumina, silica-titania, silica-zirconia, alumina-titania, alumina-zirconia, zinc-aluminate and the like; alternatively, examples of mixed oxides that can be used in the activator-support of the present disclosure include, but are not limited to, silica-alumina, silica-titania, silica-zirconia, alumina-titania, and the like.

In one aspect of this disclosure, the solid oxide material is chemically-treated by contacting it with at least one electron-withdrawing component, typically an electron-withdrawing anion source. Further, the solid oxide material can be chemically-treated with a metal ion if desired, then calcining to form a metal-containing or metal-impregnated solid super acid. Alternatively, a solid oxide material and an electron-withdrawing anion source are contacted and calcined simultaneously. The method by which the oxide is contacted with an electron-withdrawing component, typically a salt or an acid of an electron-withdrawing anion, includes, but is not limited to, gelling, co-gelling, impregnation of one compound onto another, and the like. Typically, following any contacting method, the contacted mixture of oxide compound, electron-withdrawing anion, and the metal ion if present can be calcined.

The electron-withdrawing component used to treat the oxide is any component that increases the Lewis or Brønsted acidity of the solid oxide upon treatment. In one aspect, the electron-withdrawing component is an electron-withdrawing anion derived from a salt, an acid, or other compound such as a volatile organic compound that may serve as a source or precursor for that anion. Examples of electron-withdrawing anions include, but are not limited to, sulfate, bisulfate, fluoride, chloride, bromide, iodide, fluorosulfate, fluoroborate, phosphate, fluorophosphate, trifluoroacetate, triflate, fluorozirconate, fluorotitanate, trifluoroacetate, triflate, and the like, including mixtures and combinations thereof. Generally, fluoride, sources of fluoride, chloride, bisulfate, sulfate, and the like, including mixtures and combinations thereof, are particularly useful. In addition, other ionic or non-ionic compounds that serve as sources for these electron-withdrawing anions may also be employed in the present disclosure.

When the electron-withdrawing component can comprise a salt of an electron-withdrawing anion, the counterion or cation of that salt may be selected from any cation that allows the salt to revert or decompose back to the acid during calcining. Factors that dictate the suitability of the particular salt to serve as a source for the electron-withdrawing anion include, but are not limited to, the solubility of the salt in the desired solvent, the lack of adverse reactivity of the cation, ion-pairing effects between the cation and anion, hygroscopic properties imparted to the salt by the cation, and the like, and thermal stability of the anion. Examples of suitable cations in the salt of the electron-withdrawing anion include, but are not limited to, ammonium, trialkyl ammonium, tetraalkyl ammonium, tetraalkyl phosphonium, H⁺, [H(OEt₂)₂]⁺, and the like; alternatively, ammonium; alternatively, trialkyl ammonium; alternatively, tetraalkyl ammonium; alternatively, tetraalkyl phosphonium; or alternatively, H⁺, [H(OEt₂)₂]⁺.

Further, combinations of one or more different electron withdrawing anions, in varying proportions, can be used to tailor the specific acidity of the activator-support to the desired level. Combinations of electron withdrawing components may be contacted with the oxide material simultaneously or individually, and any order that affords the desired solid super acid acidity. For example, one aspect of this disclosure is employing two or more electron-withdrawing anion source compounds in two or more separate contacting steps. Thus, one example of such a process by which an solid super acid is prepared is as follows: a selected solid oxide compound, or combination of oxide compounds, is contacted with a first electron-withdrawing anion source compound to form a first mixture, this first mixture is then calcined, the calcined first mixture is then contacted with a second electron-withdrawing anion source compound to form a second mixture, followed by calcining said second mixture to form a treated solid oxide compound. In such a process, the first and second electron-withdrawing anion source compounds are typically different compounds, although they may be the same compound.

In one aspect of the disclosure, the solid oxide activator-support (solid super acid) may be produced by a process comprising:
(1) contacting a solid oxide compound with at least one electron-withdrawing anion source compound to form a first mixture; and
(2) calcining the first mixture to form the solid oxide activator-support.
   In another aspect of this disclosure, the solid oxide activator-support (solid super acid) is produced by a process comprising:
(1) contacting at least one solid oxide compound with a first electron-withdrawing anion source compound to form a first mixture; and
(2) calcining the first mixture to produce a calcined first mixture;
(3) contacting the calcined first mixture with a second electron-withdrawing anion source compound to form a second mixture; and
(4) calcining the second mixture to form the solid oxide activator-support. Thus, the solid oxide activator-support is sometimes referred to simply as a treated solid oxide compound.

Another aspect of this disclosure is producing or forming the solid super acid by contacting at least one solid oxide with at least one electron-withdrawing anion source compound, wherein the at least one solid oxide compound is calcined before, during or after contacting the electron-withdrawing anion source, and wherein there is a substantial absence of aluminoxanes and organoborates.

In one aspect of this disclosure, once the solid oxide has been treated and dried, it may be subsequently calcined. Calcining of the treated solid oxide is generally conducted in an ambient atmosphere; alternatively, in a dry ambient atmosphere. The solid oxide may be calcined at a temperature from about 200° C. to about 900° C.; alternatively, from about 300° C. to about 800° C.; alternatively, from about 400° C. to about 700° C.; or alternatively, from about 350° C. to about 550° C. The period of time at which the solid oxide is maintained at the calcining temperature may be about 1 minute to about 100 hours; alternatively, from about 1 hour to about 50 hours; alternatively, from about 3 hours to about 20 hours; or alternatively from about 1 to about 10 hours.

Further, any type of suitable ambient atmosphere can be used during calcining. Generally, calcining is conducted in an oxidizing atmosphere, such as air. Alternatively, an inert atmosphere, such as nitrogen or argon, or a reducing atmosphere such as hydrogen or carbon monoxide, may be used.

In another aspect of the disclosure, the solid oxide component used to prepare the solid super acid can have a pore volume from about 0.1 mL/g to about 3.0 mL/g, from about 0.25 mL/g to about 2.5 mL/g; or from about 0.4 mL/g to about 2.0 mL/g, or from about 0.5 mL/g to about 1.7 mL/g, greater than about 0.1 mL/g, greater than about 0.5 mL/g, or greater than about 1.0 mL/g. According to another aspect, the solid super acid itself (solid oxide treated with an electron withdrawing anion) can have a pore volume from about 0.1 mL/g to about 3.0 mL/g, from about 0.25 mL/g to about 2.5 mL/g; from about 0.5 mL/g to about 2.5 mL/g, from about 0.4 mL/g to about 2.0 mL/g, or from about 0.5 mL/g to about 1.7 mL/g, greater than about 0.1 mL/g, greater than about 0.5 mL/g, or greater than about 1.0 mL/g.

In still another aspect, the solid oxide component used to prepare the solid super acid can have a surface area from about 100 to about 1000 m²/g, from about 200 to about 800 m²/g, or from about 250 to about 600 m²/g. According to another aspect, the solid super acid itself (solid oxide treated with an electron withdrawing anion) can have a surface area from about 100 to about 1000 m²/g, from about 200 to about 800 m²/g, from about 250 to about 600 m²/g, or from about 150 m²/g to about 700 m²/g.

In a further aspect, the solid oxide component used to prepare the solid super acid can have an average particle size (d50) of from about 1 micron to about 250 microns, from about 2 microns to about 200 microns, from about 5 microns to about 150 microns, from about 10 to about 100 microns, or from about 15 to about 100 microns. In another aspect, the solid super acid itself (solid oxide treated with an electron withdrawing anion) can have an average particle size (d50) of from about 1 micron to about 250 microns, from about 2 microns to about 200 microns, from about 5 microns to about 150 microns, or from about 10 to about 100 microns.

According to another aspect, the solid oxide treated with an electron withdrawing anion has any of the following properties: a) a surface area from about 100 m²/g to about 1000 m²/g; b) a pore volume from about 0.25 mL/g to about 3.0 mL/g; c) an average particle size from about 5 microns to about 150 microns; or d) any combination thereof.

Regarding the sources of the electron-withdrawing anions, generally, the solid oxide material can be treated with a source of halide ion or sulfate ion or other electron withdrawing anions, optionally treated with a metal ion if desired, then calcined to provide the solid super acid in the form of a particulate solid. Thus, reference is made herein to the source of the sulfate ion (termed a sulfating agent), the source of chloride ion (termed a chloriding agent), the source of fluoride ion (termed a fluoriding agent) and the like, used to provide the solid super acid.

In one aspect of this disclosure, the solid super acid can comprise a fluorided solid oxide in the form of a particulate solid, thus a source of fluoride ion is added to the oxide by treatment with a fluoriding agent. In still another aspect, fluoride ion may be added to the oxide by forming a slurry of the oxide in a suitable solvent such as alcohol or water, including, but are not limited to, the one to three carbon alcohols because of their volatility and low surface tension. Examples of fluoriding agents that can be used in this disclosure include, but are not limited to, hydrofluoric acid (HF), ammonium fluoride (NH₄F), ammonium bifluoride (NH₄HF₂), ammonium tetrafluoroborate (NH₄BF₄), ammonium silicofluoride (hexafluorosilicate) ((NH₄)₂SiF₆), ammonium hexafluorophosphate (NH₄PF₆), analogs thereof, and combinations thereof; alternatively, hydrofluoric acid (HF), ammonium fluoride (NH₄F), ammonium bifluoride (NH₄HF₂), ammonium tetrafluoroborate (NH₄BF₄), analogs thereof, and combinations thereof. For example, ammonium bifluoride NH₄HF₂ may be used as the fluoriding agent, due to its ease of use and ready availability.

In another aspect of the present disclosure, the solid oxide can be treated with a fluoriding agent during the calcining step. Any fluoriding agent capable of thoroughly contacting the solid oxide during the calcining step can be used. For example, in addition to those fluoriding agents described previously, volatile organic fluoriding agents may be used. Examples of volatile organic fluoriding agents useful in this aspect of the disclosure include, but are not limited to, freons, perfluorohexane, perfluorobenzene, fluoromethane, trifluoroethanol, and combinations thereof. Gaseous hydrogen fluoride or fluorine itself can also be used with the solid oxide is fluorided during calcining. One convenient method of contacting the solid oxide with the fluoriding agent is to vaporize a fluoriding agent into a gas stream used to fluidize the solid oxide during calcination.

Similarly, in another aspect of this disclosure, the solid super acid can comprise a chlorided solid oxide in the form of a particulate solid, thus a source of chloride ion is added to the oxide by treatment with a chloriding agent. The chloride ion may be added to the oxide by forming a slurry of the oxide in a suitable solvent. In another aspect of the present disclosure, the solid oxide can be treated with a chloriding agent during the calcining step. Any chloriding agent capable of serving as a source of chloride and thoroughly contacting the oxide during the calcining step can be used. For example, volatile organic chloriding agents may be used. Examples of volatile organic chloriding agents useful in this aspect of the disclosure include, but are not limited to, certain freons, perchlorobenzene, chloromethane, dichloromethane, chloroform, carbon tetrachloride, trichloroethanol, or any combination thereof. Gaseous hydrogen chloride or chlorine itself can also be used with the solid oxide during calcining. One convenient method of contacting the oxide with the chloriding agent is to vaporize a chloriding agent into a gas stream used to fluidize the solid oxide during calcination.

In one aspect, the amount of fluoride or chloride ion present before calcining the solid oxide is generally from about 2 to about 50% by weight, where the weight percents are based on the weight of the solid oxide, for example silica-alumina or silica-coated alumina before calcining. In another aspect, the amount of fluoride or chloride ion present before calcining the solid oxide is from about 3 to about 25% by weight, and in another aspect, from about 4 to about 20% by weight. Once impregnated with halide, the halided oxide may be dried by any method known in the art including, but not limited to, suction filtration followed by evaporation, drying under vacuum, spray drying, and the like, although it is also possible to initiate the calcining step immediately without drying the impregnated solid oxide.

In an aspect, silica-alumina or silica-coated alumina may be utilized as the solid oxide material. The silica-alumina or silica-coated alumina used to prepare the treated solid oxide can have a pore volume greater than about 0.5 mL/g. In one aspect, the pore volume may be greater than about 0.8 mL/g, and in another aspect, the pore volume may be greater than about 1.0 mL/g. Further, the silica-alumina or silica-coated alumina may have a surface area greater than about 100 m²/g. In one aspect, the surface area is greater than about 250 m²/g, and in another aspect, the surface area may be greater than about 350 m²/g. Generally, the silica-alumina or silica-coated alumina of this disclosure has an alumina content from about 5 to about 95%. In one aspect, the alumina content of the silica-alumina or silica-coated alumina may be from about 5 to about 50%, and in another aspect, the alumina content of the silica-alumina or silica-coated alumina may be from about 8% to about 30% alumina by weight. In yet another aspect, the solid oxide component can comprise alumina without silica and in another aspect, the solid oxide component can comprise silica without alumina.

The sulfated solid oxide can comprise sulfate and a solid oxide component such as alumina, silica-alumina, or silica-coated alumina in the form of a particulate solid. The sulfated oxide can be further treated with a metal ion if desired such that the calcined sulfated oxide can comprise a metal. In one aspect, the sulfated solid oxide can comprise sulfate and alumina. In one aspect of this disclosure, the sulfated alumina is formed by a process wherein the alumina is treated with a sulfate source, for example selected from, but not limited to, sulfuric acid or a sulfate salt such as ammonium sulfate. In one aspect, this process may be performed by forming a slurry of the alumina in a suitable solvent such as alcohol or water, in which the desired concentration of the sulfating agent has been added. Suitable organic solvents include, but are not limited to, the one to three carbon alcohols because of their volatility and low surface tension.

In one aspect of the disclosure, the amount of sulfate ion present before calcining is generally from about 0.5 parts by weight to about 100 parts by weight sulfate ion to about 100 parts by weight solid oxide. In another aspect, the amount of sulfate ion present before calcining is generally from about 1 part by weight to about 50 parts by weight sulfate ion to about 100 parts by weight solid oxide, and in still another aspect, from about 5 parts by weight to about 30 parts by weight sulfate ion to about 100 parts by weight solid oxide. These weight ratios are based on the weight of the solid oxide before calcining. Once impregnated with sulfate, the sulfated oxide may be dried by any method known in the art including, but not limited to, suction filtration followed by evaporation, drying under vacuum, spray drying, and the like, although it is also possible to initiate the calcining step immediately.

Further, any method of impregnating the solid oxide material with a metal may be used. The method by which the oxide is contacted with a metal source, typically a salt or metal-containing compound, includes, but is not limited to, gelling, co-gelling, impregnation of one compound onto another, and the like. Following any contacting method, the contacted mixture of oxide compound, electron-withdrawing anion, and the metal ion is typically calcined. Alternatively, a solid oxide material, an electron-withdrawing anion source, and the metal salt or metal-containing compound are contacted and calcined simultaneously.

In an aspect, the metallocene compound or combination of metallocene compounds may be precontacted with an olefin and/or a co-catalyst such as an organoaluminum compound for a first period of time prior to contacting this mixture with the solid super acid. Once the precontacted mixture of the metallocene compound, olefin, and/or organoaluminum compound is contacted with the solid super acid, the composition further comprising the solid super acid is termed the “postcontacted” mixture. The postcontacted mixture can be allowed to remain in further contact for a second period of time prior to being charged into the reactor in which the polymerization process will be carried out.

Various processes to prepare solid oxide activator-supports that can be employed in this disclosure have been reported. For example, U.S. Pat. Nos. 6,107,230, 6,165,929, 6,294,494, 6,300,271, 6,316,553, 6,355,594, 6,376,415, 6,391,816, 6,395,666, 6,524,987, 6,548,441, 6,750,302, 6,831,141, 6,936,667, 6,992,032, 7,601,665, 7,026,494, 7,148,298, 7,470,758, 7,517,939, 7,576,163, 7,294,599, 7,629,284, 7,501,372, 7,041,617, 7,226,886, 7,199,073, 7,312,283, 7,619,047, and U.S. Patent Appl. Publ. No. 2010/0076167, describe such methods, each of which is incorporated by reference herein, in pertinent part.

### Aluminoxane Compounds

In a further aspect of any embodiment provided here, the catalyst composition can comprise, either in combination with the solid super acid or any other activators(s) or alone, at least one aluminoxane. In a further aspect, the catalyst compositions and polymerization processes disclosed herein may be absent an aluminoxane. Aluminoxanes are also referred to as poly(hydrocarbyl aluminum oxides), organoaluminoxanes, or alumoxanes.

Alumoxane compounds that can be used in the catalyst composition of this disclosure include, but are not limited to, oligomeric compounds. The oligomeric aluminoxane compounds can comprise linear structures, cyclic, or cage structures, or mixtures of all three. Oligomeric aluminoxanes, whether oligomeric or polymeric compounds, have the repeating unit formula:

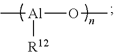

wherein R¹² is a linear or branched alkyl having from 1 to 10 carbon atoms, and n is an integer from 3 to about 10 are encompassed by this disclosure. Linear aluminoxanes having the formula:

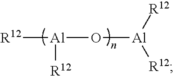

wherein R¹² is a linear or branched alkyl having from 1 to 10 carbon atoms, and n is an integer from 1 to about 50, are also encompassed by this disclosure.

Further, aluminoxanes may also have cage structures of the formula R^{t}_{5m+α}R^{b}_{m-α}Al₄ₘO₃ₘ, wherein m is 3 or 4 and α is =n_{Al(3)}-n_{O(2)}+n_{O(4)}; wherein n_{Al(3)} is the number of three coordinate aluminum atoms, n_{O(2)} is the number of two coordinate oxygen atoms, n_{O(4)} is the number of 4 coordinate oxygen atoms, R^{t} represents a terminal alkyl group, and R^{b} represents a bridging alkyl group; wherein R is a linear or branched alkyl having from 1 to 10 carbon atoms.

Aluminoxanes that can serve as activators in this disclosure are generally represented by formulas such as (R¹²—Al—O)ₙ, R¹²(R¹²—Al—O)ₙAl(R¹²)₂, and the like, wherein the R¹² group is typically a linear or branched C₁-C₆ alkyl such as methyl, ethyl, propyl, butyl, pentyl, or hexyl wherein n typically represents an integer from 1 to about 50. In one embodiment, the aluminoxane compounds of this disclosure include, but are not limited to, methylaluminoxane (MAO), ethylaluminoxane, modified methylaluminoxane (MMAO) such as an isobutyl-modified methyl aluminoxane, n-propylaluminoxane, iso-propylaluminoxane, n-butylaluminoxane, t-butylaluminoxane, sec-butylaluminoxane, iso-butylaluminoxane, t-butyl aluminoxane, 1-pentylaluminoxane, 2-pentylaluminoxane, 3-pentylaluminoxane, iso-pentyl-aluminoxane, neopentylaluminoxane, or combinations thereof.

While organoaluminoxanes with different types of “R” groups such as R¹² are encompassed by the present disclosure, methyl aluminoxane (MAO), ethyl aluminoxane, or isobutyl aluminoxane are typical aluminoxane activators used in the catalyst compositions of this disclosure. These aluminoxanes are prepared from trimethylaluminum, triethylaluminum, or triisobutylaluminum, respectively, and are sometimes referred to as poly(methylaluminum oxide), poly(ethylaluminum oxide), and poly(isobutylaluminum oxide), respectively. It is also within the scope of the disclosure to use an aluminoxane in combination with a trialkylaluminum, such as disclosed in U.S. Pat. No. 4,794,096, which is herein incorporated by reference in its entirety.

The present disclosure contemplates many values of n in the aluminoxane formulas (R¹²—Al—O)ₙ and R¹²(R¹²—Al—O)ₙAl(R¹²)₂, and preferably n is at least about 3. However, depending upon how the organoaluminoxane is prepared, stored, and used, the value of n may be variable within a single sample of aluminoxane, and such a combination of organoaluminoxanes are comprised in the methods and compositions of the present disclosure.

Organoaluminoxanes can be prepared by various procedures which are well known in the art. Examples of organoaluminoxane preparations are disclosed in U.S. Pat. Nos. 3,242,099 and 4,808,561, each of which is incorporated by reference herein, in its entirety. One example of how an aluminoxane may be prepared is as follows. Water which is dissolved in an inert organic solvent may be reacted with an aluminum alkyl compound such as AlR₃ to form the desired organoaluminoxane compound. While not intending to be bound by this statement, it is believed that this synthetic method can afford a mixture of both linear and cyclic (R—Al—O)ₙ aluminoxane species, both of which are encompassed by this disclosure. Alternatively, organoaluminoxanes may be prepared by reacting an aluminum alkyl compound such as AlR₃ with a hydrated salt, such as hydrated copper sulfate, in an inert organic solvent.

The other catalyst components may be contacted with the aluminoxane in a saturated hydrocarbon compound solvent, though any solvent which is substantially inert to the reactants, intermediates, and products of the activation step can be used. The catalyst composition formed in this manner may be collected by methods known to those of skill in the art, including but not limited to filtration, or the catalyst composition may be introduced into the oligomerization reactor without being isolated.

### Organoboron and Organoborate Compounds

In a further aspect of any embodiment provided here, the catalyst composition can comprise, either in combination with the solid super acid or any other activators(s) or alone, at least one organoboron, borate, or organoborate compound as an activator. In a further aspect, the catalyst compositions and polymerization processes disclosed herein may be absent an organoboron, a borate, or an organoborate compound.

Organoboron compounds that can be used in the catalyst composition of this disclosure are varied. In one aspect, the organoboron compound can comprise neutral boron compounds, borate salts, or combinations thereof. For example, the organoboron compounds of this disclosure can comprise a fluoroorgano boron compound, a fluoroorgano borate compound, or a combination thereof. Any fluoroorgano boron or fluoroorgano borate compound known in the art can be utilized. The term fluoroorgano boron compound has its usual meaning to refer to neutral compounds of the form BY₃. The term fluoroorgano borate compound also has its usual meaning to refer to the monoanionic salts of a fluoroorgano boron compound of the form [cation]⁺[BY₄]⁻, where Y represents a fluorinated organic group. For convenience, fluoroorgano boron and fluoroorgano borate compounds are typically referred to collectively by organoboron compounds, or by either name as the context requires.

Examples of fluoroorgano borate compounds that can be used as activators in the present disclosure include, but are not limited to, fluorinated aryl borates such as, N,N-dimethylanilinium tetrakis(pentafluorophenyl)borate, triphenylcarbenium tetrakis(pentafluorophenyl)borate, lithium tetrakis(pentafluorophenyl)borate, N,N-dimethylanilinium tetrakis[3,5-bis(trifluoromethyl)phenyl]borate, triphenylcarbenium tetrakis[3,5-bis(trifluoromethyl)phenyl]borate, and the like, including mixtures thereof; alternatively, N,N-dimethylanilinium tetrakis(pentafluorophenyl)borate; alternatively, triphenylcarbenium tetrakis(pentafluorophenyl)borate; alternatively, lithium tetrakis-(pentafluorophenyl)borate; alternatively, N,N-dimethylanilinium tetrakis[3,5-bis(trifluoro-methyl)phenyl]borate; or alternatively, triphenylcarbenium tetrakis[3,5-bis(trifluoromethyl)-phenyl]borate. Examples of fluoroorgano boron compounds that can be used as activators in the present disclosure include, but are not limited to, tris(pentafluorophenyl)boron, tris[3,5-bis(trifluoromethyl)phenyl]boron, and the like, including mixtures thereof.

Although not intending to be bound by the following theory, these examples of fluoroorgano borate and fluoroorgano boron compounds, and related compounds, are thought to form “weakly-coordinating” anions when combined with organometal compounds, as disclosed in U.S. Pat. No. 5,919,983, which is incorporated herein by reference in its entirety.

Generally, any amount of organoboron compound can be utilized in this disclosure. In one aspect and in any embodiment disclosed herein, the molar ratio of the organoboron compound to the metallocene compound can be from 0.001:1 to 100,000:1. Alternatively and in any embodiment, the molar ratio of the organoboron compound to the metallocene compound can be from 0.01:1 to 10,000:1; alternatively from 0.1:1 to 100:1; alternatively, from 0.5:1 to 10:1; or alternatively, from 0.2:1 to 5:1. When referring to molar ratios of the organoboron compound or any other co-catalyst or activator to the metallocene compound, the molar ratios are intended to reflect the total moles of any metallocene or combinations of metallocene when more than one metallocene is present. Typically, the amount of the fluoroorgano boron or fluoroorgano borate compound used as an activator for the metallocene compounds can be in a range of from about 0.5 mole to about 10 moles of boron compound per total mole of metallocene compound employed. In one aspect, the amount of fluoroorgano boron or fluoroorgano borate compound used as an activator for the metallocene compound(s) is in a range of about 0.8 moles to 5 moles of boron compound per total moles of metallocene compound(s).

### Ionizing Ionic Compounds

In a further aspect of any embodiment provided here, the catalyst composition can comprise, either in combination with the solid super acid or any other activators(s) or alone, at least one ionizing ionic compound. In a further aspect, the catalyst compositions and polymerization processes disclosed herein may be absent an ionizing ionic compound. Examples of ionizing ionic compound are disclosed in U.S. Pat. Nos. 5,576,259 and 5,807,938, each of which is incorporated herein by reference, in its entirety.

An ionizing ionic compound is an ionic compound which can function to enhance the activity of the catalyst composition. While not bound by theory, it is believed that the ionizing ionic compound may be capable of reacting with the metallocene compound and converting it into a cationic metallocene compound or a metallocene compound that is an incipient cation. Again, while not intending to be bound by theory, it is believed that the ionizing ionic compound may function as an ionizing compound by at least partially extracting an anionic ligand such as a chloride or alkoxide from the metallocene compound(s). However, the ionizing ionic compound is an activator regardless of whether it is ionizes the metallocene compound(s), abstracts an anionic ligand in a fashion as to form an ion pair, weakens the metal-anionic ligand bond in the metallocene compound, simply coordinates to anionic ligand, or any other mechanism by which activation may occur.

Further, it is not necessary that the ionizing ionic compound activate the metallocene compounds only. The activation function of the ionizing ionic compound is evident in the enhanced activity of catalyst composition as a whole, as compared to a catalyst composition that does not comprise any ionizing ionic compound. It is also not necessary that the ionizing ionic compound activate different metallocene compounds to the same extent.

In one aspect and in any embodiment disclosed herein, the ionizing ionic compound can have the formula:

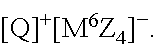

In an embodiment, Q is selected from [NR^{A}R^{B}R^{C}R^{D}]⁺, [CR^{E}R^{F}R^{G}]⁺, [C₇H₇]⁺, Li⁺, Na⁺, and K⁺; alternatively, [NR^{A}R^{B}R^{C}R^{D}]⁺; alternatively, [CR^{E}R^{F}R^{G}]⁺; alternatively, [C₇H₇]⁺; alternatively, Li⁺; alternatively, Na⁺; alternatively, K⁺. In an embodiment, R^{A}, R^{B}, and R^{C} are each selected independently from hydrogen, and a C₁ to C₂₀ hydrocarbyl; alternatively, hydrogen and a C₁ to C₁₀ hydrocarbyl; alternatively, hydrogen and a C₆ to C₂₀ aryl; alternatively, hydrogen and a C₆ to C₁₀ aryl; alternatively, hydrogen and a C₁ to C₂₀ alkyl; alternatively, hydrogen and a C₁ to C₁₀ alkyl; or alternatively, hydrogen and a C₁ to C₅ alkyl. In an embodiment, R^{D} is selected from hydrogen, a halide, and a C₁ to C₂₀ hydrocarbyl; alternatively, hydrogen, a halide, and a C₁ to C₁₀ hydrocarbyl; alternatively, hydrogen, a halide, and a C₆ to C₂₀ aryl; alternatively, hydrogen, a halide, and a C₆ to C₁₀ aryl; alternatively, hydrogen, a halide, and a C₁ to C₂₀ alkyl; alternatively, hydrogen, a halide, and a C₁ to C₁₀ alkyl; or alternatively, hydrogen, a halide, and a C₁ to C₅ alkyl. In an embodiment, R^{E}, R^{F}, and R^{G} are each selected independently from hydrogen, a halide, and a C₁ to C₂₀ hydrocarbyl; alternatively, hydrogen, a halide, and a C₁ to C₁₀ hydrocarbyl; alternatively, hydrogen, a halide, and a C₆ to C₂₀ aryl; or alternatively, hydrogen, a halide, and a C₆ to C₁₀ aryl. In some embodiments, Q may be a trialkyl ammonium or a dialkylarylamine (e.g. dimethyl anilinium); alternatively, triphenylcarbenium or substituted triphenyl carbenium; alternatively, tropylium or a substituted tropylium; alternatively, a trialkyl ammonium; alternatively, a dialkylarylamine (e.g. dimethyl anilinium) alternatively, a triphenylcarbenium; or alternatively, tropylium. In other embodiments, Q may be tri(n-butyl) ammonium, N,N-dimethylanilinium, triphenylcarbenium, tropylium, lithium, sodium, and potassium; alternatively, tri(n-butyl) ammonium and N,N-dimethylanilinium; alternatively, triphenylcarbenium, tropylium; or alternatively, lithium, sodium, and potassium. In an embodiment, M⁶ is B or Al; alternatively, B; or alternatively, Al. In an embodiment, Z is selected independently from halide and

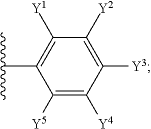

alternatively, halide; or alternatively,

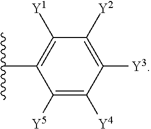

In an embodiment, Y¹, Y², Y³, Y⁴, and Y⁵ are each selected independently from hydrogen, a halide, a C₁ to C₂₀ hydrocarbyl, a C₁ to C₂₀ hydrocarboxy; alternatively, hydrogen, a halide, a C₁ to C₁₀ hydrocarbyl, a C₁ to C₁₀ hydrocarboxide; alternatively, hydrogen, a halide, a C₆ to C₂₀ aryl, a C₁ to C₂₀ alkyl, a C₆ to C₂₀ aryloxide, a C₁ to C₂₀ alkoxide; alternatively, hydrogen, a halide, a C₆ to C₁₀ aryl, a C₁ to C₁₀ alkyl, a C₆ to C₁₀ aryloxide, a C₁ to C₁₀ alkoxide; or alternatively, hydrogen, a halide, a C₁ to C₅ alkyl, a C₁ to C₅ alkoxide. In some embodiments, Y¹, Y², Y³, Y⁴, and Y⁵ may be selected independently from phenyl, p-tolyl, m-tolyl, 2,4-dimethylphenyl, 3,5-dimethylphenyl, pentafluorophenyl, and 3,5-bis(trifluoromethyl)phenyl; alternatively, phenyl; alternatively, p-tolyl; alternatively, m-tolyl; alternatively, 2,4-dimethylphenyl; alternatively, 3,5-dimethylphenyl; alternatively, pentafluorophenyl; or alternatively, 3,5-bis(trifluoromethyl)phenyl. In some embodiments, any hydrocarbyl, aryl, alkyl, hydrocarboxide, aryloxide, or alkoxide can be substituted by one or more halide, C₁ to C₅ alkyl, halide-substituted C₁ to C₅ alkyl, C₁ to C₅ alkoxide, or halide-substituted C₁ to C₅ alkoxide group. Particular halide, hydrocarbyl, aryl, alkyl, hydrocarboxide, and alkoxide are described herein and may be utilized without limitation to provide particular ionizing ionic compound having the formula [Q]⁺[M⁶Z₄]⁻.

Examples of ionizing ionic compounds include, but are not limited to, the following compounds: tri(n-butyl)ammonium tetrakis(p-tolyl)borate, tri(n-butyl)ammonium tetrakis(m-tolyl)borate, tri(n-butyl)ammonium tetrakis(2,4-dimethylphenyl)borate, tri(n-butyl)ammonium tetrakis(3,5-dimethylphenyl)borate, tri(n-butyl)ammonium tetrakis[3,5-bis(trifluoromethyl)phenyl]borate, tri(n-butyl)ammonium tetrakis(pentafluorophenyl)borate, N,N-dimethylanilinium tetrakis(p-tolyl)borate, N,N-dimethylanilinium tetrakis(m-tolyl)borate, N,N-dimethylanilinium tetrakis(2,4-dimethylphenyl)borate, N,N-dimethylanilinium tetrakis(3,5-dimethylphenyl)borate, N,N-dimethylanilinium tetrakis[3,5-bis(trifluoromethyl)phenyl]borate, or N,N-dimethylanilinium tetrakis(pentafluorophenyl)borate; alternatively, triphenylcarbenium tetrakis(p-tolyl)borate, triphenylcarbenium tetrakis(m-tolyl)borate, triphenylcarbenium tetrakis(2,4-dimethylphenyl)borate, triphenylcarbenium tetrakis(3,5-dimethylphenyl)borate, triphenylcarbenium tetrakis[3,5-bis(trifluoromethyl)phenyl]borate, or triphenylcarbenium tetrakis(pentafluorophenyl)borate; alternatively, tropylium tetrakis(p-tolyl)borate, tropylium tetrakis(m-tolyl)borate, tropylium tetrakis(2,4-dimethylphenyl)borate, tropylium tetrakis(3,5-dimethylphenyl)borate, tropylium tetrakis[3,5-bis(trifluoromethyl)phenyl]borate, or tropylium tetrakis(pentafluorophenyl)borate; alternatively, lithium tetrakis(pentafluorophenyl)borate, lithium tetrakis(phenyl)borate, lithium tetrakis(p-tolyl)borate, lithium tetrakis(m-tolyl)borate, lithium tetrakis(2,4-dimethylphenyl)borate, lithium tetrakis(3,5-dimethylphenyl)borate, or lithium tetrafluoroborate; alternatively, sodium tetrakis(pentafluorophenyl)borate, sodium tetrakis(phenyl) borate, sodium tetrakis(p-tolyl)borate, sodium tetrakis(m-tolyl)borate, sodium tetrakis(2,4-dimethylphenyl)borate, sodium tetrakis(3,5-dimethylphenyl)borate, or sodium tetrafluoroborate; alternatively, potassium tetrakis(pentafluorophenyl)borate, potassium tetrakis(phenyl)borate, potassium tetrakis(p-tolyl)borate, potassium tetrakis(m-tolyl)borate, potassium tetrakis(2,4-dimethylphenyl)borate, potassium tetrakis(3,5-dimethylphenyl)borate, or potassium tetrafluoroborate; alternatively, tri(n-butyl)ammonium tetrakis(p-tolyl)aluminate, tri(n-butyl)ammonium tetrakis(m-tolyl)aluminate, tri(n-butyl)ammonium tetrakis(2,4-dimethylphenyl)aluminate, tri(n-butyl)ammonium tetrakis(3,5-dimethylphenyl)aluminate, tri(n-butyl)ammonium tetrakis(pentafluorophenyl)aluminate, N,N-dimethylanilinium tetrakis(p-tolyl)-aluminate, N,N-dimethylanilinium tetrakis(m-tolyl)aluminate, N,N-dimethylanilinium tetrakis(2,4-dimethylphenyl)aluminate, N,N-dimethylanilinium tetrakis(3,5-dimethyl-phenyl)aluminate, or N,N-dimethylanilinium tetrakis(pentafluorophenyl)aluminate; alternatively, triphenylcarbenium tetrakis(p-tolyl)aluminate, triphenylcarbenium tetrakis(m-tolyl)aluminate, triphenylcarbenium tetrakis(2,4-dimethylphenyl)aluminate, triphenylcarbenium tetrakis(3,5-dimethylphenyl)aluminate, or triphenylcarbenium tetrakis-(pentafluorophenyl)aluminate; alternatively, tropylium tetrakis(p-tolyl)aluminate, tropylium tetrakis(m-tolyl)aluminate, tropylium tetrakis(2,4-dimethylphenyl)aluminate, tropylium tetrakis(3,5-dimethylphenyl)aluminate, or tropylium tetrakis(pentafluorophenyl)aluminate; alternatively, lithium tetrakis(pentafluorophenyl)aluminate, lithium tetrakis(phenyl)aluminate, lithium tetrakis(p-tolyl)aluminate, lithium tetrakis(m-tolyl)aluminate, lithium tetrakis(2,4-dimethylphenyl)aluminate, lithium tetrakis(3,5-dimethylphenyl)aluminate, or lithium tetrafluoroaluminate; alternatively, sodium tetrakis(pentafluorophenyl)aluminate, sodium tetrakis(phenyl)aluminate, sodium tetrakis(p-tolyl)aluminate, sodium tetrakis(m-tolyl)aluminate, sodium tetrakis(2,4-dimethylphenyl)aluminate, sodium tetrakis(3,5-dimethylphenyl)aluminate, or sodium tetrafluoroaluminate; or alternatively, potassium tetrakis(pentafluorophenyl)aluminate, potassium tetrakis(phenyl)aluminate, potassium tetrakis(p-tolyl)aluminate, potassium tetrakis(m-tolyl)aluminate, potassium tetrakis(2,4-dimethylphenyl)aluminate, potassium tetrakis(3,5-dimethylphenyl)aluminate, potassium tetrafluoroaluminate. In some embodiments, the ionizing ionic compound may be tri(n-butyl)ammonium tetrakis(3,5-dimethylphenyl)borate, tri(n-butyl)-ammonium tetrakis[3,5-bis(trifluoromethyl)phenyl]borate, tri(n-butyl)ammonium tetrakis(pentafluorophenyl)borate, N,N-dimethylanilinium tetrakis(p-tolyl)borate, N,N-dimethylanilinium tetrakis(m-tolyl)borate, N,N-dimethylanilinium tetrakis[3,5-bis(trifluoro-methyl)phenyl]borate, N,N-dimethylanilinium tetrakis(pentafluorophenyl)borate, triphenyl-carbenium tetrakis(p-tolyl)borate, triphenylcarbenium tetrakis(m-tolyl)borate, triphenylcarbenium tetrakis(2,4-dimethylphenyl)borate, triphenylcarbenium tetrakis(3,5-dimethylphenyl)borate, or triphenylcarbenium tetrakis[3,5-bis(trifluoromethyl)phenyl]borate, lithium tetrakis(p-tolyl)aluminate, lithium tetrakis(m-tolyl)aluminate, lithium tetrakis(2,4-dimethylphenyl)aluminate, or lithium tetrakis(3,5-dimethylphenyl)aluminate.

Alternatively and in some embodiments, the ionizing ionic compound can be tri(n-butyl)ammonium tetrakis[3,5-bis(trifluoromethyl)phenyl]borate, tri(n-butyl)ammonium tetrakis(pentafluorophenyl)borate, N,N-dimethylanilinium tetrakis[3,5-bis(trifluoro-methyl)phenyl]borate, N,N-dimethylanilinium tetrakis(pentafluorophenyl)borate, triphenylcarbenium tetrakis[3,5-bis(trifluoromethyl)phenyl]borate, lithium tetrakis(p-tolyl)aluminate, or lithium tetrakis(m-tolyl)aluminate; alternatively, tri(n-butyl)ammonium tetrakis[3,5-bis(trifluoromethyl)phenyl]borate; alternatively, tri(n-butyl)ammonium tetrakis(pentafluorophenyl)borate; alternatively, N,N-dimethylanilinium tetrakis[3,5-bis(trifluoromethyl)phenyl]borate; alternatively, N,N-dimethylanilinium tetrakis(pentafluorophenyl)borate; alternatively, triphenylcarbenium tetrakis[3,5-bis(trifluoro-methyl)phenyl]borate; alternatively, lithium tetrakis(p-tolyl)aluminate; or alternatively, lithium tetrakis(m-tolyl)aluminate. In other embodiments, the ionizing compound may be a combination of any ionizing compound recited herein. However, the ionizing ionic compound is not limited thereto in the present disclosure.

In one aspect and in any embodiment disclosed herein, the molar ratio of the ionizing ionic compound to the metallocene compound can be from 0.001:1 to 100,000:1. Alternatively and in any embodiment, the molar ratio of the ionizing ionic compound to the metallocene compound can be from 0.01:1 to 10,000:1; alternatively from 0.1:1 to 100:1; alternatively, from 0.5:1 to 10:1; or alternatively, from 0.2:1 to 5:1. When referring to molar ratios of the ionizing ionic compound or any other activator to the metallocene compound, the molar ratios are intended to reflect the total moles of the metallocene compound.

### Co-Catalysts

In another aspect, the catalyst compositions disclosed here can further comprises a co-catalyst, the catalyst compositions can further comprise the contact product of a co-catalyst with the additional catalyst compositions components, or the method of making the catalyst composition can further comprise contacting in any order a co-catalyst and the additional catalyst compositions components.

One aspect of this disclosure provides a catalyst composition and a process for producing an olefin polymer composition, in which the catalyst composition and process can utilize a co-catalyst. In some aspects, the co-catalyst can be optional. While not intending to be bound by theory, some co-catalysts may function as alkylating agents for the metallocene and it is thought that in some embodiments, for example when a metallocene comprises a ligand such as an alkyl ligand, a co-catalyst may not be required. That is, when the contact product of the metallocene and an activator can initiate olefin polymerization without any further alkylation or treatment of the metallocene. However, even in cases in which polymerization activity can be initiated without the addition of a co-catalyst as a component of the catalyst composition, it may be desirable to include a co-catalyst in the catalyst composition.

When parameters such as molar ratios are disclosed, for example when referring to the molar ratio of any co-catalyst or combination of co-catalysts to the metallocene compound, the molar ratios are intended to reflect the total moles of the metallocene compound or metallocene compounds.

One aspect of this disclosure provides for a catalyst composition for polymerizing olefins and a process for polymerizing olefins using a catalyst composition, comprising contacting at least one olefin and a catalyst composition, wherein the catalyst composition can comprise a metallocene compound and optionally a co-catalyst. In any embodiment provided here, the catalyst composition can further comprise an activator, such as a solid oxide treated with an electron-withdrawing anion, an organoboron compound, an organoborate compound, an ionizing ionic compound, an aluminoxane compound, or any combination thereof.

In an aspect, for example, the co-catalyst can comprise, consist of, consist essentially or, or can be selected from an organoaluminum compound, an organoboron compound, an organozinc compound, an organomagnesium compound, an organolithium compound, or any combination thereof. In another aspect, the co-catalyst can comprise or can be selected from an organoaluminum compound, an organozinc compound, an organomagnesium compound, an organolithium compound, or any combination thereof. Examples of co-catalysts include, but are not limited to:
a) M³(X¹⁰)ₙ(X¹¹)₃₋ₙ, wherein M³ is boron or aluminum and n is from 1 to 3 inclusive;
b) M⁴(X¹⁰)ₙ(X¹¹)₂₋ₙ, wherein M⁴ is magnesium or zinc and n is from 1 to 2 inclusive; and/or
c) M⁵X¹⁰, wherein M⁵ is Li; wherein
   i) X¹⁰ is independently hydride or a C₁ to C₂₀ hydrocarbyl; and
   ii) X¹¹ is independently a halide, a hydride, a C₁ to C₂₀ hydrocarbyl, or a C₁ to C₂₀ hydrocarbyloxide.
      For example, the co-catalyst can comprise, consist of, consist essentially of, or be selected from an organoaluminum compound having a formula Al(X¹²)ₛ(X¹³)₃₋ₛ, wherein X¹² is independently a C₁ to C₁₂ hydrocarbyl, X¹¹ is independently a halide, a hydride, or a C₁ to C₁₂ hydrocarboxide, and s is an integer from 1 to 3 (inclusive).

In an aspect, the co-catalyst can comprise or can be selected from an organoaluminum compound, wherein the organoaluminum compound can comprise, can consist essentially of, or can be selected from trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, or any combination thereof. For example, the co-catalyst can comprise, consist of, consist essentially of, or be selected from triethylaluminum, triisobutylaluminum, diethylaluminum ethoxide, diethylaluminum chloride, or any combination thereof.

In a further aspect, the catalyst composition and/or the reaction mixture to prepare and use the catalyst composition can be substantially free of aluminoxane compounds, organoboron or organoborate compounds, ionizing ionic compounds, or combinations thereof. That is, “substantially free” is used to indicated that the recited compound or component is not intentionally added into the catalyst composition or reaction system. For example, “substantially free” can mean that the recited composition or reaction mixture contains a concentration of less than 50 ppmw (parts per million by weight) of the component that the composition or mixture is substantially free of. In another aspect, the catalyst composition and/or the reaction mixture to prepare and use the catalyst composition can be substantially free of aluminoxane compounds, meaning that no aluminoxane or reagents which form aluminoxane in the presence of an aluminum hydrocarbyl compound (such as water) are intentionally added to the catalyst composition.

Compounds which can constitute a co-catalyst are described in more detail below.

### Organoaluminum Compounds

One aspect of this disclosure provides a catalyst composition and a process for producing an olefin polymer composition, in which the catalyst composition and process can utilize a co-catalyst such as an organoaluminum compound. In a further aspect of any embodiment provided here, the catalyst composition can comprise, either in combination with the solid super acid or any other activators or alone, at least one organoaluminum compound.

Organoaluminum compounds that can be used in the catalyst composition of this disclosure include but are not limited to compounds having the formula:

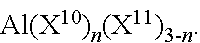

In an embodiment, each X¹⁰ can be independently a C₁ to C₂₀ hydrocarbyl; alternatively, a C₁ to C₁₀ hydrocarbyl; alternately, a C₆ to C₂₀ aryl; alternatively, a C₆ to C₁₀ aryl; alternatively, a C₁ to C₂₀ alkyl; alternatively, a C₁ to C₁₀ alkyl; or alternatively, a C₁ to C₅ alkyl. In an embodiment, each X¹¹ can be independently a halide, a hydride, or a C₁ to C₂₀ hydrocarboxide; alternatively, a halide, a hydride, or a C₁ to C₁₀ hydrocarboxide; alternatively, a halide, a hydride, or a C₆ to C₂₀ aryloxide; alternatively, a halide, a hydride, or a C₆ to C₁₀ aryloxide; alternatively, a halide, a hydride, or a C₁ to C₂₀ alkoxide; alternatively, a halide, a hydride, or a C₁ to C₁₀ alkoxide; alternatively, a halide, a hydride, or, or a C₁ to C₅ alkoxide. In an embodiment, n can be a number (whole or otherwise) from 1 to 3, inclusive. In another aspect and in any embodiment, organoaluminum compounds that can be used in the catalyst composition of this disclosure include but are not limited to compounds having the formula:

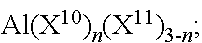

wherein
X¹⁰ can be a hydrocarbyl having from 1 to about 20 carbon atoms;
X¹¹ can be selected from alkoxide or aryloxide, any one of which having from 1 to about 20 carbon atoms, halide, or hydride; and
n can be a number (whole or otherwise) from 1 to 3, inclusive.
   For example, X¹⁰ can be selected independently from a C₁ to C₁₂ hydrocarbyl, X¹¹ can be selected independently from a halide, a hydride, or a C₁ to C₁₂ hydrocarboxide, and s can be an integer from 1 to 3 (inclusive).

In one aspect of the formula Al(X¹⁰)ₙ(X¹¹)₃₋ₙ, X¹⁰ can be an alkyl having from 1 to about 10 carbon atoms. Examples of X¹⁰ alkyl group are described herein and may be utilized to describe the alkyl aluminum compounds without limitation. In an aspect, X¹¹ may be independently selected from fluoro or chloro. In yet another aspect, X¹¹ may be chloro.

In the formula Al(X¹⁰)ₙ(X¹¹)₃₋ₙ, n can be a number (whole or otherwise) from 1 to 3 inclusive, and typically, n is 2 or n is 3. The value of n is not restricted to be an integer, therefore this formula includes sesquihalide compounds or other organoaluminum cluster compounds.

Generally, examples of organoaluminum compounds that can be used in this disclosure include, but are not limited to, trialkylaluminum compounds, dialkylaluminium halide compounds, alkylaluminum dihalide compounds, dialkylaluminum alkoxide compounds, dialkylaluminum hydride compounds, and combinations thereof. Specific examples of organoaluminum compounds that are useful in this disclosure include, but are not limited to: trimethylaluminum (TMA), triethylaluminum (TEA), ethylaluminum dichloride, tripropylaluminum, diethylaluminum ethoxide, tributylaluminum, diisobutylaluminum hydride, triisobutylaluminum, diethylaluminum chloride (DEAC), and combinations thereof.

In one aspect, the present disclosure provides for precontacting the metallocene compound with at least one organoaluminum compound and an olefin monomer to form a precontacted mixture, prior to contact this precontacted mixture with the solid oxide activator-support to form the active catalyst. When the catalyst composition is prepared in this manner, typically, though not necessarily, a portion of the organoaluminum compound can be added to the precontacted mixture and another portion of the organoaluminum compound can be added to the postcontacted mixture prepared when the precontacted mixture can be contacted with the solid oxide activator. However, all the organoaluminum compound may be used to prepare the catalyst in either the precontacting or postcontacting step. Alternatively, all the catalyst components may be contacted in a single step.

Further, more than one organoaluminum compounds may be used, in either the precontacting or the postcontacting step. When an organoaluminum compound is added in multiple steps, the amounts of organoaluminum compound disclosed herein include the total amount of organoaluminum compound used in both the precontacted and postcontacted mixtures, and any additional organoaluminum compound added to the polymerization reactor. Therefore, total amounts of organoaluminum compounds are disclosed, regardless of whether a single organoaluminum compound is used, or more than one organoaluminum compound. In another aspect, triethylaluminum (TEA) or triisobutylaluminum are typical organoaluminum compounds used in this disclosure.

In one aspect and in any embodiment disclosed herein, the molar ratio of the organoaluminum compound to the metallocene compound can be from 0.001:1 to 100,000:1. Alternatively and in any embodiment, the molar ratio of the organoaluminum compound to the metallocene compound can be from 0.01:1 to 10,000:1; alternatively from 0.1:1 to 100:1; alternatively, from 0.5:1 to 10:1; or alternatively, from 0.2:1 to 5:1. When referring to the molar ratio of the organoaluminum compound or any other co-catalyst to the metallocene compound, the molar ratios are intended to reflect the total moles of the metallocene compound or metallocene compounds, when more than one metallocene is present.

### Organozinc and Organomagnesium Compounds

In an aspect, the co-catalyst of this disclosure can comprise, consist of, consist essentially or, or be selected from an organozinc compound, an organomagnesium compound, or a combination thereof. Organozinc compounds and organomagnesium compounds that can be used in the catalyst composition of this disclosure include but are not limited to compounds having the formula:

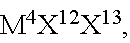

wherein M⁴ is magnesium or zinc. In an embodiment, each X¹² is independently a C₁ to C₂₀ hydrocarbyl; alternatively, a C₁ to C₁₀ hydrocarbyl; alternatively, a C₆ to C₂₀ aryl; alternatively, a C₆ to C₁₀ aryl; alternatively, a C₁ to C₂₀ alkyl; alternatively, a C₁ to C₁₀ alkyl; or alternatively, C₁ to C₅ alkyl. In an embodiment, each X¹³ is independently a halide, a hydride, or a C₁ to C₂₀ hydrocarbyl; alternatively, a halide, a hydride, or a C₁ to C₁₀ hydrocarbyl; alternatively, a halide, a hydride, or a C₆ to C₂₀ aryl; alternatively, a halide, a hydride, or a C₆ to C₁₀ aryl; alternatively, a halide, a hydride, or a C₁ to C₂₀ alkyl; alternatively, a halide, a hydride, or a C₁ to C₁₀ alkyl; alternatively, a halide, a hydride, or a C₁ to C₅ alkyl; alternatively, a halide, a hydride, or a C₁ to C₂₀ hydrocarboxide; alternatively, a halide, a hydride, or a C₁ to C₁₀ hydrocarboxide; alternatively, a halide, a hydride, or a C₆ to C₂₀ aryloxide; alternatively, a halide, a hydride, or a C₆ to C₁₀ aryloxide; alternatively, a halide, a hydride, or a C₁ to C₂₀ alkoxide; alternatively, a halide, a hydride, or a C₁ to C₁₀ alkoxide; or alternatively, a halide, a hydride, or a C₁ to C₅ alkoxide.

In a further aspect and in any disclosed embodiment, the catalyst composition can further comprise an organozinc or organomagnesium co-catalyst, selected from a compound with the following formula:

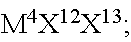

wherein:
M⁴ is Zn or Mg;
X¹² is a hydrocarbyl having from 1 to about 20 carbon atoms; and
X¹³ is selected from a hydrocarbyl, an alkoxide, or an aryloxide having from 1 to about 20 carbon atoms, halide, or hydride.

In another aspect, and in the various embodiments of this disclosure, useful organozinc compounds can be selected from or alternatively can comprise dimethylzinc, diethylzinc, dipropylzinc, dibutylzinc, dineopentylzinc, di(trimethylsilylmethyl)zinc, and the like, including any combinations thereof; alternatively, dimethylzinc; alternatively, diethylzinc; alternatively, dipropylzinc; alternatively, dibutylzinc; alternatively, dineopentylzinc; or alternatively, di(trimethylsilylmethyl)zinc.

In one aspect and in any embodiment disclosed herein, the molar ratio of the organozinc compound to the metallocene compound can be from 0.001:1 to 100,000:1. Alternatively and in any embodiment, the molar ratio of the organozinc compound to the metallocene compound can be from 0.01:1 to 10,000:1; alternatively from 0.1:1 to 100:1; alternatively, from 0.5:1 to 10:1; or alternatively, from 0.2:1 to 5:1. As indicated previously, the molar ratios are intended to reflect the total moles of the metallocene compound or metallocene compounds, when more than one metallocene is present.

### Diluents

In a further aspect, the catalyst compositions disclosed herein may further comprises a diluent, the catalyst compositions can further comprise the contact product of a diluent with the additional catalyst compositions components, or the method of making the catalyst composition can further comprise contacting in any order a diluent and the additional catalyst compositions components. Thus, the polymerization process and the method for making a catalyst composition can be carried out using a diluent or carrier for the components of the catalyst composition.

According to an aspect, the diluent can comprise, consist of, consist essentially of, or can be selected from any suitable non-protic solvent, or any non-protic solvent disclosed herein. For example, in an aspect, the diluent can comprise any suitable non-coordinating solvent such as the hydrocarbon solvents disclosed herein.

For example, the diluent can comprise any suitable aliphatic hydrocarbon solvent, or any aliphatic hydrocarbon solvent disclosed herein. In an aspect, the diluent can comprise, consist of, consist essentially of, or be selected from at least one olefin monomer in the case of bulk polymerizations, propane, butanes (for example, n-butane, iso-butane), pentanes (for example, n-pentane, iso-pentane), hexanes, heptanes, octanes, petroleum ether, light naphtha, heavy naphtha, and the like, or any combination thereof.

In another aspect, the diluent can comprise any suitable aromatic hydrocarbon solvent, or any aromatic hydrocarbon solvent disclosed herein, for example, benzene, xylene, toluene, and the like.

The diluent may also comprise an olefin or a combination of olefins. For example, the diluent can comprise at least one olefin monomer, wherein the olefin monomer comprises, consists essentially of, or is selected from ethylene, propylene, butene (e.g., 1-butene), pentene, hexene (e.g., 1-hexene), heptene, octene (e.g., 1-octene), styrene, and the like.

The term “solvent” as used herein does not imply that all or any of the components of the catalyst composition are soluble, but rather “solvent” is used interchangeably with the term “carrier” or “diluent”. The skilled person will appreciate that not all metallocene compounds, co-catalysts, and activators may be highly stable in all of the diluents described herein, and it is not intended to reflect that this is the case.

### Catalyst Preparation and Polymerization Processes

In another aspect, the catalyst compositions disclosed herein can further comprise at least one olefin (that is, olefin monomer), the catalyst compositions can further comprise the contact product of at least one olefin with the additional catalyst compositions components, or the method of making the catalyst composition can further comprise contacting in any order at least one olefin and the additional catalyst compositions components.

Thus, in an aspect of this disclosure, there is provided a process for polymerizing olefins, in which the process may comprise contacting at least one olefin monomer and a catalyst composition under polymerization conditions to form a polyolefin, wherein the catalyst composition comprises or comprises the contact product of:
(a) a metallocene compound having the formula (X¹)(X²)(X³)(X⁴)M¹, wherein: M¹ is titanium, zirconium, or hafnium; X¹ and X² are independently a substituted or an unsubstituted indenyl ligand, wherein a substituent, when present, is selected independently from a halogen or a C₁-C₂₀ hydrocarbyl group; X¹ and X² are bridged by a linking group having the formula >Si[(CH₂)ₙCH═CH₂]R¹, wherein n is 1, 2, 3, 4, 5, or 6, and R¹ is H or a C₁ to C₁₂ hydrocarbyl group; and X³ and X⁴ are independently a halide, hydride, a C₁-C₂₀ hydrocarbyl group, a C₁-C₂₀ heterohydrocarbyl group, tetrahydroborate, or OBR^{A}₂ or OSO₂R^{A}, wherein R^{A} is independently a C₁-C₁₂ hydrocarbyl group;
(b) an activator-support comprising a solid oxide treated with an electron-withdrawing anion (“solid super acid”); and
(c) an organoaluminum co-catalyst.
   Any of the metallocenes described herein may be used in the process for polymerizing olefins.

In an aspect, this disclosure encompasses a method of making a catalyst composition as well as encompassing a process for polymerizing olefins by contacting at least one olefin monomer and a catalyst composition under polymerization conditions to form an olefin polymer. The catalyst composition can comprise, and the catalyst composition components can comprise, a metallocene compound, an activator-support comprising a solid oxide treated with an electron-withdrawing anion (a “solid super acid”), and an organoaluminum co-catalyst, as disclosed herein. Accordingly, making the catalyst composition involves contacting the components in any order. For example, in one aspect, the contacting steps can comprise contacting the recited components in the following order:
(a) the solid oxide treated with an electron-withdrawing anion, optionally contacted with a diluent, and constituting a first composition, is contacted with:
(b) the organoaluminum co-catalyst, forming a second composition, which is contacted with:
(c) the metallocene compound.
   In a further aspect of making the catalyst composition, the contacting steps can comprise any of the following contacting procedures:
(a) the metallocene compound and the co-catalyst are contacted in a diluent, to provide a first composition, and the first composition is contacted with the activator-support;
(b) the metallocene compound and the activator-support are contacted in the diluent, to provide a second composition, and the second composition is contacted with the co-catalyst;
(c) the co-catalyst and the activator-support are contacted in the diluent, to provide a third composition, and the third composition is contacted with the metallocene compound; or
(d) the metallocene compound, the activator-support, and the co-catalyst are co-fed and contacted in a single step.
   In any of these above contacting steps, the recited components the contacted can occur in the presence of an olefin, or the recited components can be contacted in the absence of an olefin. According to an aspect of making the catalyst composition and the process of polymerizing olefins, the contacting steps and the polymerization process can be conducted in a hydrocarbon slurry.

In the process for polymerizing olefins, at least one olefin monomer can comprise, consist essentially of, or be selected from ethylene, propylene, butene (e.g., 1-butene), pentene, hexene (e.g., 1-hexene), heptene, octene (e.g., 1-octene), styrene, and the like, or any combination thereof. In a particular aspect, the at least one olefin monomer can comprise, consist essentially of, or be selected from ethylene or ethylene in combination with an olefin co-monomer selected from propylene, butene (e.g., 1-butene), pentene, hexene (e.g., 1-hexene), heptene, octene (e.g., 1-octene), styrene, and the like. Moreover, the polymerization process can further comprise a step of monitoring the concentration of at least one reaction mixture component, at least one elimination reaction product, or a combination thereof.

In another aspect, the process for polymerizing olefins described herein can be conducted in the presence of hydrogen. For example, the polymerization process can be conducted in the presence of hydrogen at a concentration of 10 ppmw to 1,000 ppmw in a polymerization reaction composition, where the ppmw concentration is the parts per million by weight of hydrogen relative to the ethylene weight, that is, the weight ratio of H₂ to ethylene. Conducting the polymerization in the presence of hydrogen can assist in molecular weight control of the resulting polymer. In another aspect, the process for polymerizing olefins according to this disclosure can be conducted in the absence of hydrogen.

Examples of the polymerization process include a process by which at least one olefin monomer and the catalyst composition can be contacted under any one or any combination of more than one of the following conditions:
(a) the molar ratio of the co-catalyst to the metallocene compound is from about 0.1:1 to about 1,200:1, or from about 2:1 to about 1,100:1, or from about 5:1 to about 1,000:1, or from about 10:1 to about 750:1;
(b) the weight ratio of the activator-support to the metallocene compound is from about 5:1 to about 1,500:1, or from about 10:1 to about 1,250:1, or form about 20:1 to about 1,000:1;
(c) the weight ratio of the at least one olefin monomer to the metallocene compound is from about 1,000:1 to about 100,000,000:1, or from about 5,000:1 to about 50,000,000:1, or from about 10,000:1 to about 25,000,000:1; or
(d) any combination of conditions (a), (b), and (c).
   These contacting conditions are also useful conditions as a method of making the catalyst composition.

In another aspect, for example, the at least one olefin monomer and the catalyst composition can be contacted under any one or any combination of more than one of the following conditions:
(a) the molar ratio of the co-catalyst to the metallocene compound(s) is from about 10:1 to about 500:1, for example when the co-catalyst comprises an organoaluminum compound such as a trialkylaluminum compound; or
(b) the weight ratio of the activator-support to the metallocene compound(s) is from about 5:1 to about 1,000:1, for example when the activator-support comprises a fluorided silica-alumina, fluorided silica-coated alumina, or a fluorided mullite; or
(c) the weight ratio of the at least one olefin monomer to the metallocene compound(s) is from about 1,000:1 to about 100,000,000:1; or
(d) any combination of (a), (b), and (c).

According to a further aspect, the polymerization conditions can include any one or any combination of more than one of the following conditions:
(a) a polymerization reaction temperature from about 40° C. to about 210° C., from about 50° C. to about 180° C., or from about from about 60° C. to about 160° C.; or
(b) a reaction pressure or a partial pressure of ethylene of from about 25 psig (0.17 MPa) to about 1500 psig (10.3 MPa), from about 50 psig (0.34 MPa) to about 1200 psig (8.3 MPa), from about 85 psig (0.59 MPa) to about 1100 psig (7.6 MPa), or from about 100 psig (0.69 MPa) to about 1000 psig (6.9 MPa);
(c) a time of the contacting step of from about 1 minute to about 3 hours, from about 5 minutes to about 2.5 hours, from about 10 minutes to about 2 hours, or from about 20 minutes to about 1.5 hours; or
(d) any combination of (a), (b), and (c).

The polymerization process is not limited to a specific reactor design or method. For example, the process for polymerizing olefins can be conducted in a polymerization reactor system comprising a batch reactor, a slurry reactor, a loop-slurry reactor, a gas phase reactor, a solution reactor, a high pressure reactor, a tubular reactor, an autoclave reactor, a continuous stirred tank reactor (CSTR), or a combination thereof. A loop-slurry reactor can be particularly useful. Further, the polymerization can be conducted in a polymerization reactor system comprising a single reactor, or can be conducted in a polymerization reactor system comprising two or more reactors. Thus, the polymerization process can be conducted in a tubular reactor, under suitable polymerization conditions. In a further aspect, the polymerization process can be conducted in continuous stirred tank reactor (CSTR), under suitable polymerization conditions. These metallocenes are also useful in single-metallocene or multiple metallocene applications and systems.

For example, in an aspect, the polymerization conditions suitable to form a polyethylene can comprise a polymerization reaction temperature from about 50° C. to about 210° C., from about 60° C. to about 180° C., or from about from about 70° C. to about 160° C.; and a reaction pressure from about 75 psig to about 1200 psig (about 0.52 MPa to about 8.3 MPa), from about 85 psig to about 1100 psig (about 0.59 MPa to about 7.6 MPa), or from about 100 psig to about 1000 psig (about 0.69 MPa to about 6.9 MPa). Alternatively, the polymerization reaction temperature can be from about 60° C. to about 160° C. and a reaction pressure from about 200 psig to about 1000 psig. In another aspect, no hydrogen is added to the polymerization reactor system. In a further aspect, hydrogen is added to the polymerization reactor system when desired.

In an aspect, the polymerization conditions can comprise contacting the catalyst composition with at least one olefin monomer in the presence of a diluent selected from at least one olefin monomer in the case of bulk polymerizations, propane, butanes (for example, n-butane, iso-butane), pentanes (for example, n-pentane, iso-pentane), hexanes, heptanes, octanes, petroleum ether, light naphtha, heavy naphtha, and the like, or any combination thereof. In another aspect, the polymerization conditions can comprise contacting the catalyst composition with at least one olefin monomer in the presence of a diluent selected from any suitable aromatic hydrocarbon solvent, or any aromatic hydrocarbon solvent disclosed herein, for example, benzene, xylene, toluene, and the like.

The polymerization conditions also can comprise a co-polymerization of ethylene with a co-monomer or more than one co-monomer as described herein. For example, the olefin monomer can further comprise at least one C₃ to C₂₀ olefin comonomer. In one aspect, the olefin monomer can further comprise at least one olefin comonomer, the comonomer comprising, consisting essentially of, or being selected from propylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-ethyl-1-hexene, 1-heptene, 2-heptene, 3-heptene, 1-octene, 1-decene, styrene, or a combination thereof.

The disclosure also provides for, in an aspect, a process for polymerizing an olefin wherein the step of providing a catalyst composition further comprises providing the contact product in a solvent. That is, the step of contacting the catalyst composition components can be and typically is carried out in a solvent or a combination of solvents. Moreover, any order of contacting the components can be used. For example, the co-catalyst can be contacted in a solvent prior to contact with the metallocene compound(s). In another aspect, the co-catalyst, the activator such as an activator-support, and the at least one olefin monomer comprising ethylene can be contacted in a solvent prior to contact with the metallocene compound(s). According to other aspects, the co-catalyst and the metallocene compound can be contacted in a solvent in the presence or absence of the at least one olefin monomer comprising ethylene, prior to contacting with the activator-support. A further aspect provides that the activator-support and the metallocene compound can be contacted in a solvent in the presence or absence of the at least one olefin monomer comprising ethylene, prior to contacting with the co-catalyst.

In some aspects, a catalyst composition prepared according to this disclosure can be characterized by an activator-support activity in a range from about 20 g/(g·h) (grams polyethylene per gram of activator-support per hour) to about 12,000 g/(g·h), from about 100 g/(g·h) to about 10,000 g/(g·h), from about 250 g/(g·h) to about 7,500 g/(g·h), or from about 500 g/(g·h) to about 5,000 g/(g·h). When the catalyst composition includes more than one activator-support, these activity values are based upon the total amount of activator-support.

In other aspects, a catalyst composition prepared according to this disclosure can be characterized by a metallocene activity in a range from about 10,000 g/(g·h) (grams polyethylene per gram of metallocene per hour) to about 2,000,000 g/(g·h), from about 30,000 g/(g·h) to about 1,500,000 g/(g·h), from about 40,000 g/(g·h) to about 1,250,000 g/(g·h), from about 50,000 g/(g·h) to about 1,100,000 g/(g·h), from about 60,000 g/(g·h) to about 1,000,000 g/(g·h), or from about 75,000 g/(g·h) to about 900,000 g/(g·h). When the catalyst composition includes more than one metallocene, these activity values are based upon the total amount of metallocene.

### Metallocene Catalyst Comparison

Table 1 provided exemplary data for the catalyst compositions and polymerization conditions for ethylene polymerization runs using the specific metallocenes MET-1 through MET-3 and comparative metallocene MET-5 in the catalyst compositions. The structures for these metallocenes are shown in FIG. 1. Corresponding polyethylene resins properties, produced with the catalysts and polymerization conditions of Table 1, are set out in Tables 2, respectively.

Finally, Table 3 provides representative comparative polymerization results for ethylene polymerizations with catalyst compositions comprising metallocenes MET-1 through MET-5, including MET-4 which includes a 2-methyl substituent on the indenyl rings. Therefore, both MET-4 and MET-1 contain a pendent CH₂=CHCH₂ group, but MET-4 includes 2-methyl indenyl ligands.

These metallocenes were examined for ethylene polymerization using “SSA” activator-supports, particularly fluorided silica-alumina, with triisobutylaluminum (TIBA) as the co-catalyst and alkylating agent. As shown in FIG. 1, metallocenes MET-1 through MET-3 contain pendent allyl, butenyl, and pentenyl moieties, respectively. These metallocene catalyst compositions were examined using various polymerization temperatures, metallocene/activator-support loadings, H₂ concentration and response, and co-monomer concentration and response.

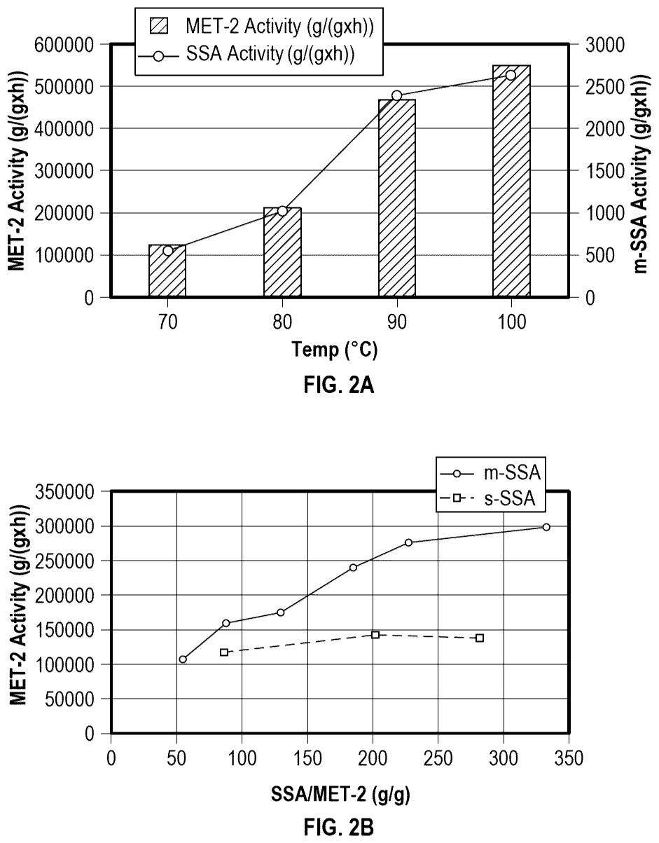

As indicated in Table 3, using the linear low-density polymerization conditions in a bench reactor of 80° C. and 320 psig ethylene, activator-support (SSA) activities were found to be high and generally ranged from 1200 to 4000 g-PE/g-SSA/h (grams polyethylene per gram activator-support (SSA) per hour) under various conditions. FIG. 2A provides metallocene activity data in grams polyethylene per gram of metallocene per hour (g/(g·h)) and activator-support (SSA) activity data in grams polyethylene per gram of activator-support per hour (g/(g·h)) as a function of temperature using metallocene MET-2 and fluorided silica-coated alumina (m-SSA) as activator. As polymerization temperature was increased up to 100° C. at constant ethylene concentration, both metallocene and support activities increased, suggesting that this temperature range works well for these metallocene-based catalysts, FIG. 2A.

FIG. 2B illustrates the relationship of metallocene activity in grams polyethylene per gram of metallocene per hour (g/(g·h)) as a function of the activator-support (SSA)-to-metallocene ratio, for both fluorided silica-coated alumina (m-SSA) and sulfated alumina (or “s-SSA”) with metallocene MET-2, demonstrating the significantly higher metallocene activity obtainable using m-SSA. Thus, substituting m-SSA with sulfated alumina (s-SSA) resulting in a significant decrease in the MET-2 catalyst activity of about two-fold lower activities under the identical polymerization activities, FIG. 2B. The activity of MET-2 could be further improved using a higher activator-support (m-SSA)/MET-2 ratios as shown in FIG. 2B, which was not observed with sulfated alumina.

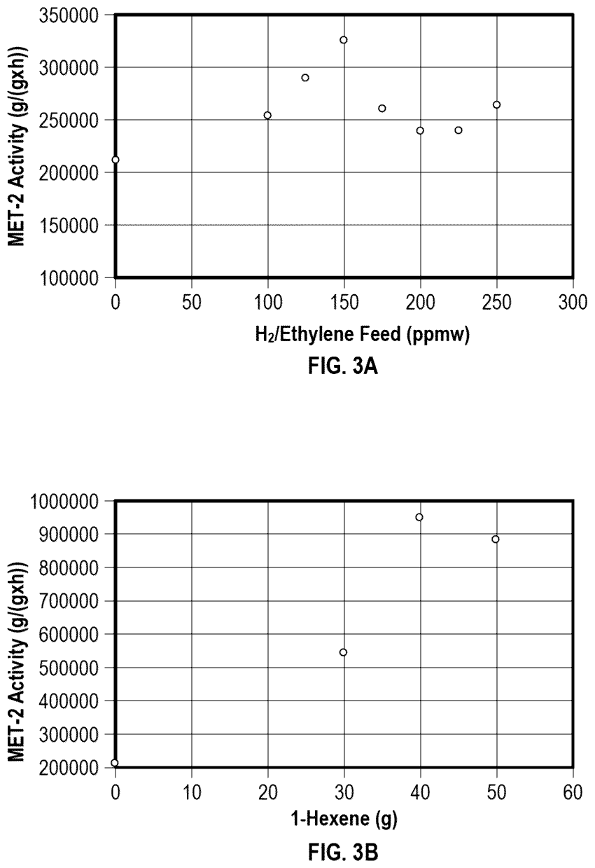

The hydrogen and co-monomer responses were also examined. FIG. 3A illustrates the effect of increasing the hydrogen concentration in the ethylene feed on MET-2 metallocene activity in grams polyethylene per gram of metallocene per hour (g/(g·h)) in the absence of a comonomer, demonstrating that high concentration of hydrogen had a negative effect on metallocene activity. FIG. 3B illustrates the effect of increasing the 1-hexene co-monomer concentration on MET-2 metallocene ethylene-1-hexene polymerization activity in grams polyethylene per gram of metallocene per hour (g/(g·h)) in the absence of hydrogen, demonstrating that higher concentrations of 1-hexene co-monomer had a positive response on metallocene activity.

Under the specific conditions of 0 ppm H₂ concentration and 40 g 1-hexene co-monomer, the activity of MET-2 was observed to reach as high as 948000 g-PE/g MET-2/h with a high support activity (4100 g-PE/g-m-SSA/h). This activity rivals some of the most active metallocene-based catalysts observed. Because H₂ and 1-hexene can be considered chain-termination agents, the addition of H₂ or 1-hexene in the polymerization process can produce a polymer with a higher MI potential or lower Mw than a polymer produced under the same conditions but in the absence of H₂ or 1-hexene.

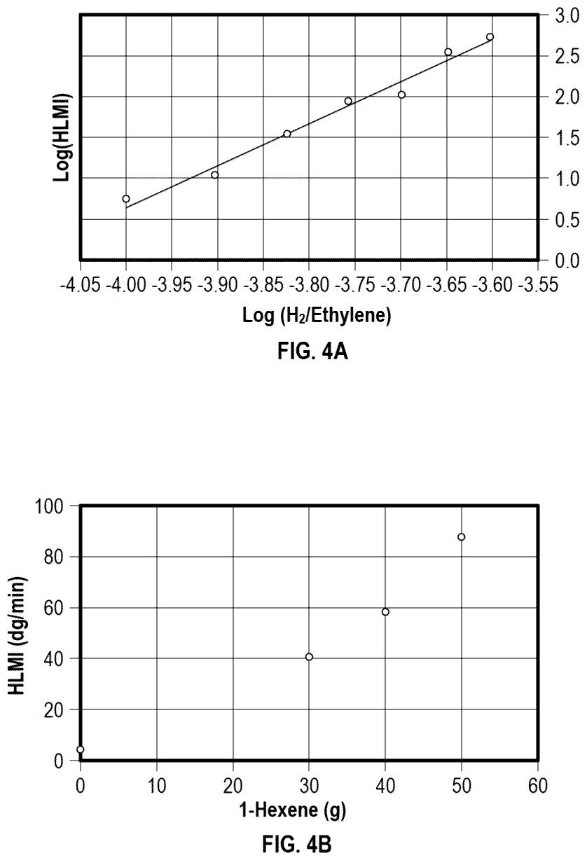

FIG. 4A illustrates an HLMI response profile for MET-2 versus hydrogen feed concentration in the absence of co-monomer, demonstrating that the MET-2 metallocene catalyst composition produced a polyethylene exhibiting an excellent melt index response over a wide range of hydrogen feed concentrations in the absence 1-hexene. Moreover, the melt index potential of polymer produced is greatly increased by adding moderate amounts of 1-hexene to the polymerization, as illustrated in FIG. 4B. Thus, FIG. 4B illustrates an HLMI response profile for MET-2 versus 1-hexene co-monomer concentration in the absence of hydrogen, showing the melt index potential of the polymer is greatly increased by adding moderate amounts of 1-hexene to the polymerization in the absence of hydrogen.

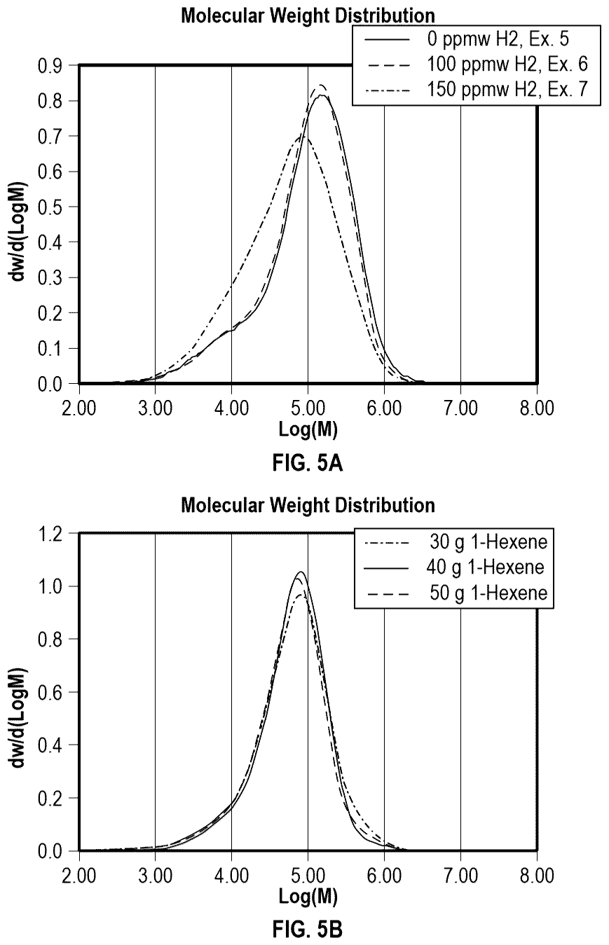

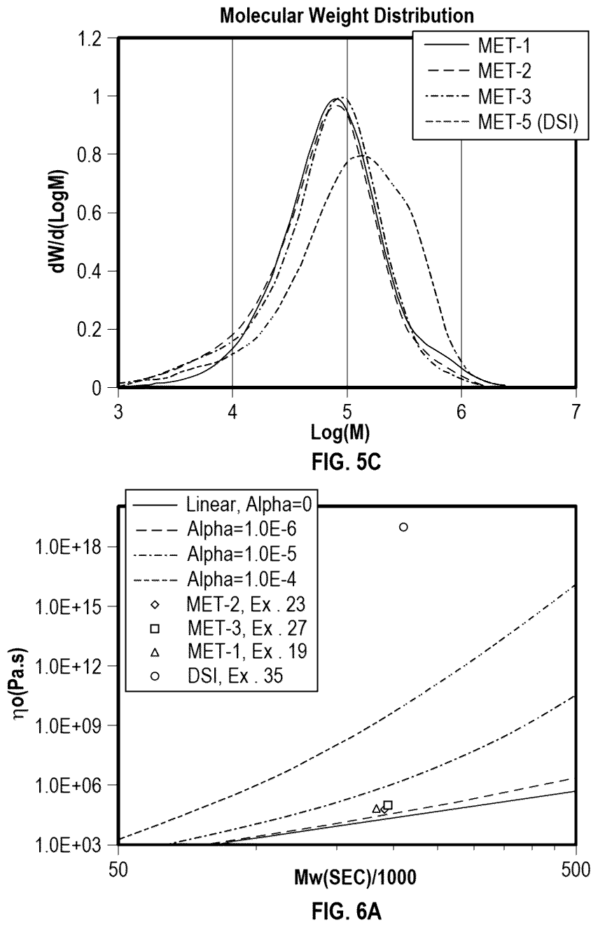

Although both H₂ and 1-hexene can result in chain transfer, the effects on molecular weight distributions of polymers produced are dramatically different when polymerization is conducted in the presence of H₂ versus in the presence of 1-hexene. FIG. 5A provides GPC data for polyethylenes producing using metallocene MET-2 and fluorided silica-coated alumina (m-SSA) in the presence of different concentrations of hydrogen in the ethylene feed and in the absence of 1-hexene co-monomer. These FIG. 5A results demonstrate that the molecular weight distribution of polymers produced with increasing amounts of hydrogen show a significant increase in a low molecular weight tail. FIG. 5B provides GPC data for polyethylenes producing using metallocene MET-2 and fluorided silica-coated alumina (m-SSA) in the presence of different concentrations of 1-hexene in the polymerization reaction and in the absence of hydrogen. These FIG. 5B data demonstrate that the molecular weight distribution of polymers produced with increasing amounts of 1-hexene becomes increasingly narrower. It was also observed that the copolymers produced by MET-2 had much broader molecular weight distributions than those prepared using most metallocenes, in which the Mw/Mn=2-3 is typical.

In addition to the MET-2 catalyst compositions in which the metallocene contains a pendent ω-butenyl group, MET-1 and MET-3 catalyst compositions were examined in which the metallocene contains a shorter allyl pendent group and a longer ω-pentenyl pendent group, respectively. The benchmark dimethyl silyl-bridged bis-indenyl metallocene (MET-5) was also evaluated under similar conditions. Representative polymerization results are summarized in Table 3. Surprisingly, these polymerization results demonstrated that the length of the pendant alkenyl group did not impact the molecular weight (Mw), and even MET-1 with a pendant allyl group showed comparable Mw and metallocene activity as metallocenes with longer alkenyl moieties.

Also surprising was the consistency in metallocene activities for ethylene polymerization as the alkenyl group was varied in length. The variation of tethered alkenyl length was observed to have no substantial effect on the metallocene activities, as all of MET-1 through MET-3 metallocene catalysts were very active and produced relatively low Mw co-polymers with a broad molecular weight distribution (Mw/Mn=ca. 4). This result was surprising as similar behaviors when pendent groups capable of coordinating to the metal are varied by length are not expected. Moreover, in comparison with the benchmark MET-5 metallocene catalysts examined under same polymerization conditions, all three metallocenes MET-1 through MET-3 bearing different length tethered olefins have comparable and even slightly higher metallocene activities than MET-5. The ethylene-1-hexene co-polymers produced using MET-1 through MET-3 have significantly higher HLMI values and lower Mw values than those produced using MET-5.

The molecular weight distributions of the polyethylene samples produced by MET-5 also showed a significant high molecular weight content, FIG. 5C. Moreover, the zero shear rates of the polymer produced by metallocenes with pendant olefins are lower than those of MET-5, as shown in Table 2. The Janzen-Colby data also suggests these polymers contain fewer LCB components than the polymer produced by MET-5.

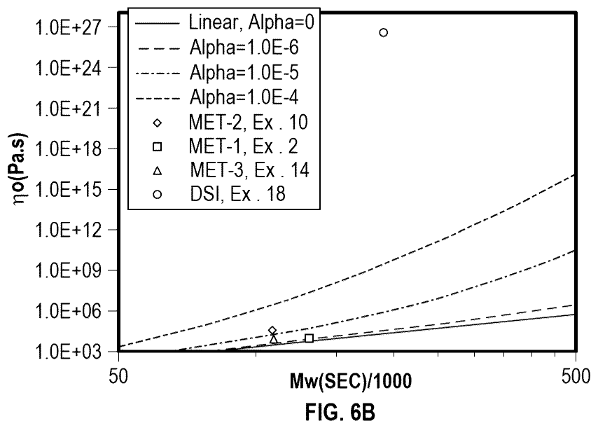

For example, FIG. 6A illustrates the long chain branching (LCB) content of ethylene homopolymers produced using the different metallocene-based catalysts, specifically showing a Janzen-Colby plot of the logarithm of the zero-shear viscosity (Pa·s) versus the logarithm of weight-average molecular weight (Mw) by size exclusion chromatography (SEC) for the designated Examples. Data for homopolymers of ethylene produced using metallocenes MET-1 (Example 19), MET-2 (Example 23), MET-3 (Example 27), and MET-5 (Example 35) are provided in Table 3 and illustrated in FIG. 6A, in which the metallocenes were activated using by fluorided silica-coated alumina (m-SSA) support-activator and TIBAL co-catalyst.

These data further demonstrate the phenomenon that pendant olefins of varying lengths significantly inhibit long chain branch (LCB) formation, and this inhibition of LCB formation was observed even for the short chain allyl substituent of MET-1. Therefore, this elusive combination of low LCB formation and a broad MWD is achievable using even the shorter allyl-substituted silicon-bridged metallocene, MET-1. Also unexpectedly, while not bound by theory, this result was surprising because the allyl substituent of MET-1 was thought to be less able to access the metal center to compete with macromonomer, which is thought to provide the LCB inhibition.

Notably however, the tethered alkenyl length was observed to affect the molecular weight distributions of the resulting co-polymers, as illustrated in the molecular weight distribution data of FIG. 5C. These data show that the allyl-tethered metallocene MET-1 produced an ethylene-1-hexene co-polymer with increased high molecular weight components as seen in the high molecular weight tail, while the longer pentenyl metallocene produces the least amount of high molecular tail, FIG. 5C.

Finally, the allylsilyl-bridged bis(2-methylindenyl)metallocene MET-4 was also synthesized and evaluated. This metallocene was observed to produce polymer with a much higher Mw, a reduced MI potential, and somewhat lower polydispersity indices, and with reduced activity as well.

### Polymer Properties

These metallocene-based catalysts can produce polymers with a broad molecular weight distribution (MWD or Mw/Mn) of from about 4 to about 7, in contrast the typical metallocene catalysts which produce polyethylenes having a MWD of from about 2 to about 3. The silyl-bridged metallocene having various tethered olefins also produced polymers with low LCB content as manifested in the higher Carreau-Yasuda (CY) breadth parameter, a (CY-a parameter) relative to comparative metallocenes which are absent the pendent alkenyl moiety. Examples of comparative metallocenes can include: (a) the dimethylsilyl bis(indenyl) zirconium dichloride; and a metallocene compound identical to those described herein except that X¹ and X² are bridged by a silyl linking group in which the alkenyl moiety (CH₂)ₙCH═CH₂ is replaced by its saturated analog (CH₂)ₙCH₂CH₂.

In the aspect, the polyolefin prepared using the disclosed catalyst compositions can be an ethylene homopolymer or an ethylene-α-olefin copolymer, which can be characterized by the follow properties:
(a) a polydispersity index (molecular weight distribution, Mw/Mn) which is greater than the molecular weight distribution of a comparative polyolefin;
(b) a Carreau-Yasuda CY-a parameter which is greater than the CY-a parameter of the comparative polyolefin;
(c) a long chain branch (LCB) formation which is lower than the LCB formation of the comparative polyolefin; or
(d) any combination of (a), (b), and (c), and wherein:
   (i) the comparative polyolefin is prepared under identical conditions as the ethylene homopolymer or the ethylene-α-olefin copolymer except for using a comparative metallocene compound in place of the metallocene compound in a comparative catalyst composition; and
   (ii) the comparative metallocene compound is: (A) dimethylsilyl bis(indenyl) zirconium dichloride; or (B) identical to the metallocene compound except that X¹ and X² except that X¹ and X² are bridged by a linking group having a formula >Si[(CH₂)ₘCH₂CH₂]R⁶, wherein m has the same value as n, and R⁶ is the same as R¹.

According to an aspect, the polyolefin prepared according to the disclosed process for polymerizing olefins can be an ethylene homopolymer characterized by any of the following properties:
(a) a polydispersity index (molecular weight distribution, Mw/Mn) of from 3.5-7.5, or alternatively from 5.0-7.0; or
(b) a ratio of a high load melt index to a melt index (HLMI/MI) of from 25 to 60, or alternatively from 28-40; or
(c) a Carreau-Yasuda CY-a parameter of from 0.24 to 0.36, or alternatively from 0.25 to 0.34; or
(d) a density in a range from about 0.94 g/cm³ to 0.96; or
(e) any combination of (a), (b), (c), and (d).

In a further aspect, the polyolefin prepared according to the disclosed process for polymerizing olefins can be an ethylene-α-olefin co-polymer characterized by any of the following properties:
(a) a polydispersity index (molecular weight distribution, Mw/Mn) of from 3.0-4.5, or alternatively from 3.1-4.3; or
(b) a ratio of a high load melt index to a melt index (HLMI/MI) of from 15 to 27, or alternatively from 20-25; or
(c) a Carreau-Yasuda CY-a parameter of from 0.10 to 0.24, or alternatively from 0.16 to 0.232; or
(d) a density in a range from about 0.90 g/cm³ to 0.96; or
(e) any combination of (a), (b), (c), and (d).

In an aspect, the polyethylene (PE) prepared by the process which uses the metallocenes disclosed herein can be characterized by a number-average molecular weight (Mn) in a range of from about 5,000 g/mol to about 250,000 g/mol, from about 10,000 g/mol to about 200,000 g/mol, or from about 20,000 g/mol to about 150,000 g/mol. The PE prepared by the process disclosed herein can be characterized by a weight-average molecular weight (Mw) in a range of from about 50,000 g/mol to about 700,000 g/mol, from about 75,000 g/mol to about 500,000 g/mol, or from about 100,000 g/mol to about 400,000 g/mol.

In a further aspect, polyethylene (PE) prepared by the process which uses the metallocene catalysts disclosed herein can be characterized by a density of the olefin polymer in a range of from about 0.90 g/cm³ to about 0.96 g/cm³, from about 0.92 g/cm³ to about 0.96 g/cm³, or from about 0.94 g/cm³ to about 0.96 g/cm³. The PE prepared by the process which uses the metallocene catalysts as disclosed herein also can be characterized by a melt index (MI) in a range of from about 0 g/10 min to about 100 g/10 min, from about 0.1 g/10 min to about 50 g/10 min, or from about 0.5 g/10 min to about 10 g/10 min.

### Articles

This disclosure also provides, in an aspect, a method for forming or preparing an article of manufacture comprising an olefin polymer, in which the method can comprise
a) performing the olefin polymerization process according to any process disclosed herein; and
b) fabricating the article of manufacture comprising the olefin polymer by any technique disclosed herein.
   In another aspect, the article of manufacture comprising the olefin polymer that can be fabricated or made can be, for example, an agricultural film, an automobile part, a bottle, a drum, a fiber or fabric, a food packaging film or container, a container preform, a food service article, a fuel tank, a geomembrane, a household container, a liner, a molded product, a medical device or material, a pipe, a sheet or tape, or a toy.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, may suggest themselves to one of ordinary skill in the art without departing from the spirit of the present invention or the scope of the appended claims.

### EXAMPLES

### General Experimental Considerations

Unless otherwise noted, all manipulations using air sensitive reagents were performed under standard Schlenk line or dry box techniques under an inert atmosphere such as nitrogen and/or argon. Solvents were purchased from commercial sources and were typically dried prior to use. Unless otherwise specified, reagents were obtained from commercial sources. Anhydrous ether (diethyl ether), heptane, toluene and other solvents were sparged with nitrogen and stored over activated 4 Å molecular sieves. The NMR solvents such as C₆D₆, and CD₂Cl₂ (Cambridge Isotope Laboratories) were degassed and stored over activated 4 Å molecular sieves in a dry box.

### Preparation of Alkenylmethyl(Dichloro)Silanes

3-butenyl-methyldichlorosilane. A 500 mL flask was charged with magnesium turnings (5.1 g, 210 mmol) and 200 mL of anhydrous diethylether. A small crystal of iodine was added and the mixture was stirred for 1 hour at ambient temperature. 4-Bromobutene (20.3 mL, 200 mmol) was added dropwise over 1 hour, and the mixture was allowed to reflux as the addition proceeded. Once the addition was completed, the mixture was allowed to cool to ambient with stirring over 1 hour.

A second vessel was charged with methyltrichlorosilane (118 mL, 1.0 mol). The liquid was cooled to −78° C. and the Grignard mixture prepared above was cannulated with stirring. The resulting slurry was allowed to warm to room temperature and was stirred 2 days. The mixture was then filtered and the filtrate was distilled at atmospheric pressure to a pot temperature of 60° C. The remaining liquid was then distilled under high vacuum (<0.5 torr) with a pot temperature of 20° C. Three fractions were collected. The third fraction contained 89% 3-butenyl-methyldichlorosilane (GC-MS, M/Z=169.9) and ˜5% methyltrichlorosilane. Adjusted yield: 8.9 g (26%).

4-pentenyl-methyldichlorosilane. A 500 mL flask was charged with magnesium turnings (3.3 g, 137 mmol) and 200 mL diethyl ether. A few small iodine crystals were added and the mixture was stirred for 1 hour. The mixture was brought to reflux and heat was then discontinued. 5-Bromopentene was added over 1 hour (mixture continued to reflux during addition). Once the addition was complete, the mixture was refluxed for an additional hour and was then cooled to ambient temperature.

A separate flask was charged with methyltrichlorosilane (40 g, 268 mmol) and 200 mL diethyl ether. The solution was cooled to −78° C. and the Grignard prepared above was added over 1 hour. The resulting mixture was allowed to warm to ambient temperature and was stirred overnight. The solvent was stripped under high vacuum (<1 torr) and 50 mL of pentane was added back. The slurry was filtered and the filtrate was stripped to a colorless oil under high vacuum. The oil was then distilled under high vacuum, yielding 9.35 g (38%) of product (93.7% purity by GC-MS).

### Silyl-Bridged Bis(Indene) Ligand Preparation

A 250 mL flask was charged with 21 mmol of indene and 100 mL of diethyl ether, cooled in a dry ice/acetone bath, and 22 mmol of n-BuLi (2.5 M, in hexanes) was added with stirring over 30 minutes. After this mixture was stirred overnight at room temperature, 10 mmol of alkenylmethyl(dichloro)silane were added to the mixture at room temperature. This reaction mixture was stirred overnight, subsequently cooled in an ice bath, and 100 mL of a saturated aqueous solution of ammonium chloride were added. The resulting mixture was extracted with diethyl ether, and the combined organics were washed with water, dried over sodium sulfate, and the volatiles were removed on a rotary evaporator. The resulting crude residue was then purified by column chromatography in 0.2% ethyl acetate/n-hexane to yield the silyl-bridged bis(indene) product as a yellow oil.

### Metallocene Preparation

The silyl-bridged bis(indenyl) metallocenes having an omega-(ω-)alkenyl moiety on the silyl bridge were prepared as shown in Scheme 1. The general metallocene preparation is described for the allylmethylsilyl-bridged metallocene and applicable to all the (ω-alkenyl)methylsilyl bis-indenyl metallocenes.

A 100 mL flask was charged with 4.45 mmol of (ω-alkenyl)methyl(dichloro)silane ligand and 30 mL of diethyl ether and cooled in a dry ice/acetone bath, and 9.2 mmol of n-BuLi (1.6 M, in hexanes) were added to the cooled solution with stirring. This solution was stirred overnight at room temperature, after which it was added dropwise by cannula to a cooled suspension of ZrCl₄ solid (4.45 mmol) in toluene in a dry ice/acetone bath. This mixture was stirred overnight at room temperature. The reaction volatiles were removed from this mixture in vacuo, the residue was dissolved in toluene and the mixture was filtered to remove LiCl. The resulting solution was concentrated under vacuum to afford a red solid. This residue was recrystallized twice from toluene/heptane to afford the metallocene as a yellow powder.

### Activator Support Preparation

The activator-supports used herein may be referred as solid super acids or “SSA”.

Fluorided Silica-Coated Alumina (m-SSA). The fluorided silica-coated alumina SSA was prepared by first contacting alumina with tetraethylorthosilicate in isopropanol to equal 25 wt. % SiO₂. After drying, the silica-coated alumina was calcined at 600° C. for 3 hours, and then allowed to cool to ambient temperature. The fluorided silica-coated alumina (7 wt. % F) was prepared by impregnating the calcined silica-coated alumina with an ammonium bifluoride solution in methanol, drying the resulting solid, and then calcining at 600° C. for 3 hours. This fluorided silica-coated alumina, also termed m-SSA, was used as an activator-support in the following polymerization procedure described below.

Sulfated Alumina (s-SSA). The sulfated alumina SSA was prepared by mixing alumina with a solution of sulfuric acid in methanol, to result in approximately 15 wt. % (weight percent) sulfate based on the weight of the sulfated alumina. After drying under vacuum at 110° C. overnight, the dried powder was calcined at 600° C. in dry air for three hours. The resulting sulfated alumina (s-SSA) was used as an activator-support in the following polymerization procedure.

### General Polymerization Procedure

All polymerization runs were conducted in a one-gallon stainless steel reactor. Isobutane (approx. 2 L) was used in all runs. A metallocene solution of the desired bridged metallocene compound was prepared at about 1 mg/mL concentration in toluene. A 0.8 mL portion of triisobutylaluminum (1.0 M in heptane), approximately 200 mg of fluorided silica-coated alumina, and 1.0 mL of the metallocene solution were added in that order through a charge port while slowly venting isobutane vapor. The charge port was closed, and isobutane was added. The contents of the reactor were stirred and heated to the desired run temperature, and 1-hexene (if added) and ethylene or ethylene/H₂ were then introduced into the reactor. Ethylene was fed on demand to maintain the target pressure. The reactor was maintained at the desired temperature throughout the run by an automated heating-cooling system. When the polymerization was completed, feeds were closed, and the reactor was vented and cooled to ambient conditions. The resulting polymer fluff was removed and dried under vacuum at 50° C.

### Polymer Characterization

Melt index (MI, g/10 min or dg/min) was measured by measuring the rate of flow of a molten resin through an orifice of 0.0825 inch diameter as determined in accordance with ASTM D1238 at 190° C., with a 2,160 gram weight. High Load Melt Index (HMLI, dg/min) was measured by measuring the rate of flow of a molten resin through an orifice of 0.0825 inch diameter when subjected to a force of 21.6 kg at 190° C. in accordance with ASTM D1238. The parameters MI, HLMI, and the Melt Index Ratio (MIR) HLMI/MI are recorded in the data tables.

Density was determined in grams per cubic centimeter (g/cm³) on a compression molded sample, cooled at 15° C. per hour, and conditioned for 40 hours at room temperature in accordance with ASTM D1505 and ASTM D4703.

Molecular weights and molecular weight distributions were obtained using a PL-GPC 220 (Polymer Labs, an Agilent Company) system equipped with a IR4 detector (Polymer Char, Spain) and three Styragel HMW-6E GPC columns (Waters, MA) running at 145° C. The flow rate of the mobile phase 1,2,4-trichlorobenzene (TCB) containing 0.5 g/L 2,6-di-t-butyl-4-methylphenol (BHT) was set at 1 mL/min, and polymer solution concentrations were in the range of 0.5-1.0 mg/mL, depending on the molecular weight. Sample preparation was conducted at 150° C. for nominally 4 hours with occasional and gentle agitation, before the solutions were transferred to sample vials for injection. An injection volume of about 400 μL was used. The integral calibration method was used to deduce molecular weights and molecular weight distributions using a Chevron Phillips Chemical Company's HDPE polyethylene resin, MARLEX® BHB5003, as the standard. The integral table of the standard was predetermined in a separate experiment with SEC-MALS. Mn is the number-average molecular weight, Mw is the weight-average molecular weight, Mz is the z-average molecular weight, and Mp is the peak molecular weight (location, in molecular weight, of the highest point of the molecular weight distribution curve). The IB parameter was determined from the molecular weight distribution curve (that is, a plot of dW/d(Log M) vs. Log M; normalized to an area under the curve), and is defined as 1/[dW/d(Log M)]_{MAX}.

Melt rheological characterizations were performed as follows. Small-strain (less than 10%) oscillatory shear measurements were performed on an Anton Paar MCR rheometer using parallel-plate geometry. All rheological tests were performed at 190° C. The complex viscosity |η*| versus frequency (ω) data were then curve fitted using the modified three parameter Carreau-Yasuda (CY) empirical model to obtain the zero shear viscosity—η₀, characteristic viscous relaxation time—τ_{η}, and the breadth parameter, α (CY-a parameter). The simplified Carreau-Yasuda (CY) empirical model is as follows:

$$\vert {η}^{*} ( ω ) \vert = \frac{{η}_{0}}{{[ 1 + {( {τ}_{η} ω )}^{α} ]}^{( 1 - n ) / α}}$$

wherein:
   |ηq*(ω)|=magnitude of complex shear viscosity;
η₀=zero shear viscosity;
τ_{η}=viscous relaxation time (Tau(η));
α=“breadth” parameter (CY-a parameter);
n=fixes the final power law slope, fixed at 2/11; and
ω==angular frequency of oscillatory shearing deformation.

Details of the significance and interpretation of the CY model and derived parameters can be found in: C. A. Hieber and H. H. Chiang, Rheol. Acta, 28, 321 (1989); C. A. Hieber and H. H. Chiang, Polym. Eng. Sci., 32, 931 (1992); and R. B. Bird, R. C. Armstrong and O. Hasseger, Dynamics of Polymeric Liquids, Volume 1, Fluid Mechanics, 2nd Edition, John Wiley & Sons (1987); each of which is incorporated herein by reference in its entirety.

The long chain branching of the polymers prepared herein, is evaluated by the number long chain branches (LCB) per 1,000,000 total carbon atoms which were calculated using the method of Janzen and Colby (J. Mol. Struct., 485/486, 569-584 (1999)), from values of zero shear viscosity, η₀ (determined from the Carreau-Yasuda model, described herein), and measured values of Mw obtained using a Dawn EOS multiangle light scattering detector (Wyatt). This method is further described in U.S. Pat. No. 8,114,946; J. Phys. Chem. 1980, 84, 649; and Y. Yu, D. C. Rohlfing, G. R Hawley, and P. J. DesLauriers, Polymer Preprints 2003, 44, 49-50. These references are incorporated herein by reference in their entireties.

### Polymerization Results

Using the general polymerization procedure outlined above, the catalyst composition components and the polymerization conditions for a series of ethylene polymerization tests are provided in Tables 1-5 for metallocenes MET-1 through MET-5, respectively. The structures for metallocenes MET-1 through MET-5 are shown in FIG. 1. Corresponding polyethylene resins properties produced with the catalysts and polymerization conditions of Tables 1-5 are set out in Tables 6-10, respectively.

In the tables, the following abbreviations are used: MET, metallocene; t, time; T, temperature; C2=, ethylene; C6=, 1-hexene; H2, hydrogen gas; SSA, solid super acid activator-support; m-SSA, fluorided silica-coated alumina activator-support; s-SSA, sulfated alumina activator-support; P, pressure; TIBAL or TIBA, triisobutyl aluminum; PE, polyethylene (homopolymer or copolymer as the context requires or allows); MET Activity, metallocene activity in grams polyethylene per gram metallocene per hour; SSA Activity, activator support (solid super acid) activity in grams polyethylene per gram activator-support per hour; MI, melt index; HLMI, high load melt index; Mn, number average molecular weight; Mw, weight average molecular weight; Mz, z-average molecular weight; Mp, peak molecular weight; MWD, molecular weight distribution (also termed PDI, polydispersity index) (calculated as Mw/Mn); Eta-0 (η₀), zero shear viscosity; Tau Eta (τ_{η}), characteristic viscous relaxation time; and CY-a, Carreau-Yasuda (CY) breadth parameter, α. A missing entry, or an entry designated as “nd” or “-” indicates the data were not determined.

Other abbreviations which are well-known to the skilled artisan include psig (pounds per square inch, gauge), ° C. (degrees Centigrade or Celsius), ppm (parts per million), g (grams), mg (milligrams), mL (milliliters), min (minutes), h or hr (hours), and cc or cm³ (cubic centimeters).

### Examples

Table 1 provides exemplary catalyst compositions and polymerization conditions for ethylene polymerization runs using the catalyst compositions with metallocenes MET-1 through MET-3 and comparative metallocene MET-5.

Table 2 sets out the properties of the polyethylene resins produced with the catalysts and polymerization conditions of Table 1, for the metallocene based catalysts MET-1 through MET-3 and comparative metallocene MET-5.

Table 3 provides representative polymerization results for ethylene polymerizations with the designated catalysts MET-1 through MET-3 and comparative metallocene MET-5.

General polymerization procedures, characterization methods, and abbreviations used in these tables are outlined above.

TABLE 1
Catalyst compositions and polymerization conditions for
ethylene polymerizations with the designated catalysts

| | | | | | | | | | |
|---|---|---|---|---|---|---|---|---|---|
| | | | C2= | H2 | C6= | m-SSA | TIBAL | MET | |
| Example | t (min) | T (° C.) | (psig) | (ppm) | (g) | (mg) | (mL) | (mg) | PE (g) |

MET-1

| | | | | | | | | | |
|---|---|---|---|---|---|---|---|---|---|
| 1 | 30 | 80 | 320 | 0 | 0 | 229 | 0.8 | 1 | 145 |
| 2 | 30 | 80 | 320 | 0 | 30 | 241 | 0.8 | 1 | 460 |
| 3 | 30 | 80 | 320 | 0 | 40 | 209 | 0.8 | 1 | 395 |
| 4 | 30 | 80 | 320 | 0 | 50 | 224 | 0.8 | 1 | 402 |

MET-2

| | | | | | | | | | |
|---|---|---|---|---|---|---|---|---|---|
| 5 | 30 | 80 | 320 | 0 | 0 | 206 | 0.8 | 1 | 106 |
| 6 | 30 | 80 | 320 | 100 | 0 | 233 | 0.8 | 1 | 127 |
| 7 | 30 | 80 | 320 | 150 | 0 | 221 | 0.8 | 1 | 163 |
| 8 | 30 | 80 | 320 | 200 | 0 | 145 | 0.8 | 1 | 120 |
| 9 | 30 | 80 | 320 | 250 | 0 | 203 | 0.8 | 1 | 132 |
| 10 | 30 | 80 | 320 | 0 | 30 | 221 | 0.8 | 1 | 272 |
| 11 | 30 | 80 | 320 | 0 | 40 | 232 | 0.8 | 1 | 474 |
| 12 | 30 | 80 | 320 | 0 | 50 | 238 | 0.8 | 1 | 441 |

MET-3

| | | | | | | | | | |
|---|---|---|---|---|---|---|---|---|---|
| 13 | 30 | 80 | 320 | 0 | 0 | 242 | 0.8 | 1 | 194 |
| 14 | 30 | 80 | 320 | 0 | 30 | 212 | 0.8 | 1 | 329 |
| 15 | 30 | 80 | 320 | 0 | 40 | ~200 | 0.8 | 1 | 393 |
| 16 | 30 | 80 | 320 | 0 | 50 | 247 | 0.8 | 1 | 401 |

MET-5 (DSI)

| | | | | | | | | | |
|---|---|---|---|---|---|---|---|---|---|
| 17 | 30 | 80 | 320 | 0 | 0 | 218 | 0.8 | 1 | 167 |
| 18 | 30 | 80 | 320 | 0 | 30 | 217 | 0.8 | 1 | 265 |

TABLE 2
Polyethylene resin properties for ethylene polymerizations with the designated catalysts

| | | | | | | | | | | | | |
|---|---|---|---|---|---|---|---|---|---|---|---|---|
| | | | HLMI/ | | | | Mw/ | Mz/ | | | | Density |
| Example | MI | HLMI | MI | Mn/1000 | Mw/1000 | Mz/1000 | Mn | Mw | η₀ | τ_{η} | CY-a | g/cc |

MET-1

| | | | | | | | | | | | | |
|---|---|---|---|---|---|---|---|---|---|---|---|---|
| 1 | 0.12 | 4.64 | 38.7 | 40.6 | 195.0 | 485.1 | 4.8 | 2.5 | 9.66E+04 | 9.10E−02 | 0.2598 | — |
| 2 | 1.7 | 37.7 | 22.2 | 40.1 | 130.7 | 407.2 | 3.3 | 3.1 | 8.90E+03 | 1.13E−03 | 0.213 | — |
| 3 | 1.8 | 43.3 | 24.1 | 26.5 | 114.8 | 349.0 | 4.3 | 3.0 | 1.31E+04 | 4.68E−04 | 0.1612 | 0.9234 |
| 4 | 2.1 | 52.8 | 25.1 | 26.7 | 109.6 | 331.1 | 4.1 | 3.0 | 9.33E+03 | 3.88E−04 | 0.1684 | 0.9211 |

MET-2

| | | | | | | | | | | | | |
|---|---|---|---|---|---|---|---|---|---|---|---|---|
| 5 | — | 4.4 | — | 25.9 | 191.0 | 491.3 | 7.4 | 2.6 | 6.23E+04 | 9.71E−02 | 0.33 | — |
| 6 | 0.1 | 5.6 | 56.0 | 27.4 | 174.7 | 419.2 | 6.4 | 2.4 | 4.37E+04 | 6.59E−02 | 0.34 | 0.94 |
| 7 | 1 | 35 | 35.0 | 19.1 | 124.9 | 393.9 | 6.6 | 3.2 | 9.51E+03 | 2.04E−02 | 0.34 | 0.95 |
| 8 | 4.1 | 103 | 25.1 | 16.6 | 87.9 | 225.1 | 5.3 | 2.6 | 1.30E+03 | 7.99E−04 | 0.24 | 0.94 |
| 9 | 20 | 524 | 26.2 | 10.1 | 58.6 | 182.1 | 5.8 | 3.1 | 5.46E+02 | 3.72E−04 | 0.31 | 0.97 |
| 10 | 1.6 | 40.7 | 25.4 | 27.0 | 108.4 | 300.8 | 4.0 | 2.8 | 3.89E+04 | 1.43E−04 | 0.11 | 0.93 |
| 11 | 3.2 | 58.4 | 18.3 | 30.8 | 95.7 | 236.4 | 3.1 | 2.5 | 1.86E+03 | 3.13E−04 | 0.23 | 0.92 |
| 12 | 3.4 | 87.6 | 25.8 | 23.3 | 93.1 | 247.3 | 4.0 | 2.7 | 4.57E+03 | 2.00E−04 | 0.19 | 0.92 |

MET-3

| | | | | | | | | | | | | |
|---|---|---|---|---|---|---|---|---|---|---|---|---|
| 13 | 0.08 | 4.8 | 60.0 | 51.7 | 183.8 | 424.1 | 3.6 | 2.3 | 6.43E+04 | 6.15E−02 | 0.2855 | 0.9472 |
| 14 | 2 | 40.7 | 20.4 | 25.4 | 109.2 | 268.2 | 4.3 | 2.5 | 7.49E+03 | 1.40E−03 | 0.235 | — |
| 15 | 3.26 | 72.9 | 22.4 | 23.5 | 96.0 | 254.0 | 4.1 | 2.6 | 5.40E+03 | 4.01E−04 | 0.2028 | 0.9244 |
| 16 | 5.1 | 107 | 21.0 | 21.5 | 88.0 | 229.5 | 4.1 | 2.6 | 4.14E+03 | 2.04E−04 | 0.1932 | 0.9225 |

MET-5 (DSI)

| | | | | | | | | | | | | |
|---|---|---|---|---|---|---|---|---|---|---|---|---|
| 17 | 0 | 0.364 | — | 65.6 | 210.5 | 496.3 | 3.2 | 2.4 | 8.776E+18 | 3.061E+08 | 0.03437 | 0.9423 |
| 18 | — | 0.411 | — | 40.3 | 190.3 | 417.6 | 4.7 | 2.2 | 3.102E+26 | 2.029E+17 | 0.02996 | 0.9198 |

TABLE 3
Representative comparative polymerization results for ethylene polymerizations with the designated catalysts ^{A}

| | | | | | | | | | | | |
|---|---|---|---|---|---|---|---|---|---|---|---|
| | | | MET | SSA | | | | | | | |
| | H2 | C6= | Activity | Activity | Mn | Mw | Mz | | | Density | Branches/ |
| Example | (ppm) | (g) | (g/(g · h)) | (g/(g · h)) | (kg/mol) | (kg/mol) | (kg/mol) | Mw/Mn | η₀ | g/cc | 1000TC |

MET-1

| | | | | | | | | | | | |
|---|---|---|---|---|---|---|---|---|---|---|---|
| 19 | 0 | 0 | 290000 | 1266 | 40.56 | 194.98 | 485.09 | 4.81 | 9.66E+04 | — | — |
| 20 | 0 | 30 | 920000 | 3817 | 40.05 | 130.71 | 407.19 | 3.26 | 8.90E+03 | — | — |
| 21 | 0 | 40 | 790000 | 3780 | 26.5 | 114.77 | 348.99 | 4.33 | 1.31E+04 | 0.9234 | — |
| 22 | 0 | 50 | 804000 | 3589 | 26.69 | 109.58 | 331.12 | 4.11 | 9.33E+03 | 0.9211 | — |

MET-2

| | | | | | | | | | | | |
|---|---|---|---|---|---|---|---|---|---|---|---|
| 23 | 0 | 0 | 212000 | 1029 | 25.93 | 191.03 | 491.29 | 7.37 | 6.23E+04 | — | — |
| 24 | 0 | 30 | 554000 | 2589 | 27.96 | 112.64 | 308.19 | 4.03 | 2.43E+04 | 0.9301 | 9.7 |
| 25 | 0 | 40 | 948000 | 4086 | 29.8 | 97.11 | 260.79 | 3.26 | 5.05E+03 | 0.9258 | — |
| 26 | 0 | 50 | 882000 | 3706 | 23.31 | 93.14 | 247.25 | 4 | 4.57E+03 | 0.9238 | 12.2 |

MET-3

| | | | | | | | | | | | |
|---|---|---|---|---|---|---|---|---|---|---|---|
| 27 | 0 | 0 | 388000 | 1603 | 51.73 | 183.75 | 424.12 | 3.55 | 6.43E+04 | 0.9472 | — |
| 28 | 0 | 30 | 658000 | 3104 | 25.38 | 109.24 | 268.17 | 4.3 | 7.49E+03 | — | — |
| 29 | 0 | 40 | 786000 | | 23.54 | 96.03 | 253.99 | 4.08 | 5.40E+03 | 0.9244 | — |
| 30 | 0 | 50 | 802000 | 3247 | 21.5 | 87.95 | 229.49 | 4.09 | 4.14E+03 | 0.9225 | — |

MET-4

| | | | | | | | | | | | |
|---|---|---|---|---|---|---|---|---|---|---|---|
| 31 | 0 | 0 | 92000 | 462 | 133.05 | 427.57 | 1139.18 | 3.21 | — | — | — |
| 32 | 0 | 30 | 216000 | 915 | 65.69 | 191.37 | 470.53 | 2.91 | — | — | — |
| 33 | 0 | 40 | 465400 | 2529 | 56.81 | 167.24 | 448.14 | 2.94 | — | — | — |
| 34 | 0 | 50 | 268000 | 1307 | 47.51 | 139.72 | 373.30 | 2.94 | — | — | — |

MET-5 (DSI)

| | | | | | | | | | | | |
|---|---|---|---|---|---|---|---|---|---|---|---|
| 35 | 0 | 0 | 334000 | 1532 | 65.56 | 210.52 | 496.3 | 3.21 | 8.78E+18 | 0.9423 | — |
| 36 | 0 | 30 | 530000 | 2442 | 40.32 | 190.26 | 417.62 | 4.72 | 3.10E+26 | 0.9198 | — |

^{A} Polymerizations run at 80° C. and 320 psig ethylene.

These and other aspects of the invention can further include the various embodiments that are presented below.

### ASPECTS OF THE DISCLOSURE

Aspect 1. A catalyst composition for polymerizing olefins, the catalyst composition comprising the contact product of:
(a) a metallocene compound having the formula:

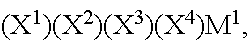

wherein
M¹ is titanium, zirconium, or hafnium;
X¹ and X² are independently a substituted or an unsubstituted indenyl ligand, wherein a substituent, when present, is selected independently from a halogen or a C₁-C₂₀ hydrocarbyl group;
X¹ and X² are bridged by a linking group having the formula >Si[(CH₂)ₙCH═CH₂]R¹, wherein n is 1, 2, 3, 4, 5, or 6, and R¹ is H or a C₁ to C₂₀ hydrocarbyl group; and
X³ and X⁴ are independently a halide, hydride, a C₁-C₂₀ hydrocarbyl group, a C₁-C₂₀ heterohydrocarbyl group, tetrahydroborate, or OBR^{A}₂ or OSO₂R^{A}, wherein R^{A} is independently a C₁-C₁₂ hydrocarbyl group;
(b) an activator-support comprising a solid oxide treated with an electron-withdrawing anion (“solid super-acid” or “SSA”); and
(c) a co-catalyst such as an organoaluminum co-catalyst.

Aspect 2. A process for polymerizing olefins, the process comprising contacting at least one olefin monomer and a catalyst composition under polymerization conditions to form a polyolefin, wherein the catalyst composition comprises the contact product of:
(a) a metallocene compound having the formula:

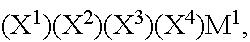

wherein
M¹ is titanium, zirconium, or hafnium;
X¹ and X² are independently a substituted or an unsubstituted indenyl ligand, wherein a substituent, when present, is selected independently from a halogen or a C₁-C₂₀ hydrocarbyl group;
X¹ and X² are bridged by a linking group having the formula >Si[(CH₂)ₙCH═CH₂]R¹, wherein n is 1, 2, 3, 4, 5, or 6, and R¹ is H or a C₁ to C₂₀ hydrocarbyl group; and
X³ and X⁴ are independently a halide, hydride, a C₁-C₂₀ hydrocarbyl group, a C₁-C₂₀ heterohydrocarbyl group, tetrahydroborate, or OBR^{A}₂ or OSO₂R^{A}, wherein R^{A} is independently a C₁-C₁₂ hydrocarbyl group;
(b) an activator-support comprising a solid oxide treated with an electron-withdrawing anion (“solid super acid”); and
(c) a co-catalyst such as an organoaluminum co-catalyst.

Aspect 3. A method of making a catalyst composition, the method comprising contacting in any order:
(a) a metallocene compound having the formula:

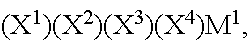

wherein
M¹ is titanium, zirconium, or hafnium;
X¹ and X² are independently a substituted or an unsubstituted indenyl ligand, wherein a substituent, when present, is selected independently from a halogen or a C₁-C₂₀ hydrocarbyl group;
X¹ and X² are bridged by a linking group having the formula >Si[(CH₂)ₙCH═CH₂]R¹, wherein n is 1, 2, 3, 4, 5, or 6, and R¹ is H or a C₁ to C₂₀ hydrocarbyl group; and
X³ and X⁴ are independently a halide, hydride, a C₁-C₂₀ hydrocarbyl group, a C₁-C₂₀ heterohydrocarbyl group, tetrahydroborate, or OBR^{A}₂ or OSO₂R^{A}, wherein R^{A} is independently a C₁-C₁₂ hydrocarbyl group;
(b) an activator-support comprising a solid oxide treated with an electron-withdrawing anion (“solid super acid”); and
(c) a co-catalyst such as an organoaluminum co-catalyst.

Aspect 4. A catalyst composition, a process for polymerizing olefins, or a method of making a catalyst composition according to any preceding Aspect, wherein M¹ is Ti; alternatively, M¹ is Zr; alternatively, M¹ is Hf; or alternatively, M¹ is Zr or Hf.

Aspect 5. A catalyst composition, a process for polymerizing olefins, or a method of making a catalyst composition according to any preceding Aspect, wherein X³ and X⁴ are independently selected from F, Cl, Br, a hydride, a C₁-C₁₂ hydrocarbyl group, a C₁-C₁₂ hydrocarbyloxide group, or an SiR²₃-substituted C₁ to C₁₅ hydrocarbyl group wherein R² is independently a C₁ to C₆ hydrocarbyl group.

Aspect 6. A catalyst composition, a process for polymerizing olefins, or a method of making a catalyst composition according to any preceding Aspect, wherein X³ and X⁴ are independently selected from Cl or Br.

Aspect 7. A catalyst composition, a process for polymerizing olefins, or a method of making a catalyst composition according to any preceding Aspect, wherein n is 1; alternatively, n is 2; alternatively, n is 3; or alternatively, n is 4.

Aspect 8. A catalyst composition, a process for polymerizing olefins, or a method of making a catalyst composition according to any preceding Aspect, wherein R¹ is a C₁ to C₁₀ hydrocarbyl group; alternatively a C₁ to C₈ hydrocarbyl group; or alternatively a C₁ to C₆ hydrocarbyl group.

Aspect 9. A catalyst composition, a process for polymerizing olefins, or a method of making a catalyst composition according to any preceding Aspect, wherein R¹ is a C₁ to C₁₀ saturated hydrocarbyl group; alternatively a C₁ to C₈ saturated hydrocarbyl group; or alternatively a C₁ to C₆ saturated hydrocarbyl group.

Aspect 10. A catalyst composition, a process for polymerizing olefins, or a method of making a catalyst composition according to any preceding Aspect, wherein R¹ is selected from methyl, ethyl, propyl, butyl, pentyl, hexyl, cyclopentyl, cyclohexyl, phenyl, tolyl, or benzyl.

Aspect 11. A catalyst composition, a process for polymerizing olefins, or a method of making a catalyst composition according to any preceding Aspect, wherein:
(a) X¹ and X² are independently a substituted or an unsubstituted indenyl ligand, wherein a substituent, when present, is selected independently from a C₁-C₁₅ hydrocarbyl group; or
(b) X¹ is an unsubstituted indenyl ligand, and X² is a substituted indenyl ligand comprising one or more substituents selected independently from a halogen or a C₁-Cis hydrocarbyl group; or
(b) both X¹ and X² are unsubstituted indenyl ligands.

Aspect 12. A catalyst composition, a process for polymerizing olefins, or a method of making a catalyst composition according to any preceding Aspect, wherein both X¹ and X² are substituted indenyl ligands comprising one or more independently selected substituents.

Aspect 13. A catalyst composition, a process for polymerizing olefins, or a method of making a catalyst composition according to any preceding Aspect, wherein the C₁-C₂₀ hydrocarbyl group, when present as a substituent on X¹ or X², is independently selected from a C₁-C₁₂ hydrocarbyl group, a C₁-C₁₀ hydrocarbyl group, a C₁-C₈ hydrocarbyl group, a C₁-C₆ hydrocarbyl group, or a C₁-C₄ hydrocarbyl group.

Aspect 14. A catalyst composition, a process for polymerizing olefins, or a method of making a catalyst composition according to any preceding Aspect, wherein the C₁-C₂₀ hydrocarbyl group when present as a substituent on X¹ or X², is independently selected from a C₁-C₂₀ aliphatic group, a C₆-C₂₀ aromatic group, a C₁-C₁₂ aliphatic group, a C₆-C₁₂ aromatic group, a C₁-C₁₀ aliphatic group, or a C₆-C₁₀ aromatic group, wherein the carbon count includes any hydrocarbyl substituent on the aliphatic group or the aromatic group.

Aspect 15. A catalyst composition, a process for polymerizing olefins, or a method of making a catalyst composition according to any preceding Aspect, wherein the C₁-C₂₀ hydrocarbyl group, when present as a substituent on X¹ or X², is independently selected from methyl, ethyl, propyl, butyl, pentyl, hexyl, cyclopentyl, cyclohexyl, phenyl, tolyl, benzyl, naphthyl, or biphenyl.

Aspect 16. A catalyst composition, a process for polymerizing olefins, or a method of making a catalyst composition according to any preceding Aspect, wherein the substituent on X¹ and X², when present, is independently selected from a C₁-C₁₂ alkyl, a C₂-C₁₂ alkenyl, a C₃-C₇ cycloalkyl, a C₆-C₁₀ aryl, or a C₇-C₁₂ aralkyl.

Aspect 17. A catalyst composition, a process for polymerizing olefins, or a method of making a catalyst composition according to any preceding Aspect, wherein the linking group has the formula >Si[(CH₂)ₙCH═CH₂]R¹, wherein n is 1, 2, 3, 4, 5, or 6, and R¹ is H or a C₁-C₁₅ hydrocarbyl.

Aspect 18. A catalyst composition, a process for polymerizing olefins, or a method of making a catalyst composition according to any preceding Aspect, wherein the linking group has the formula >Si[(CH₂)ₙCH═CH₂]₂.

Aspect 19. A catalyst composition, a process for polymerizing olefins, or a method of making a catalyst composition according to any preceding Aspect, wherein the linking group has the formula >Si[CH₂CH═CH₂]Me, >Si[(CH₂)₂CH═CH₂]Me, >Si[(CH₂)₃CH═CH₂]Me, >Si[(CH₂)₄CH═CH₂]Me, >Si[CH₂CH═CH₂]Ph, >Si[(CH₂)₂CH═CH₂]Ph, >Si[(CH₂)₃CH═CH₂]Ph, >Si[(CH₂)₄CH═CH₂]Ph, >Si[CH₂CH═CH₂]2, >Si[(CH₂)₂CH═CH₂]2, >Si[(CH₂)₃CH═CH₂]2, or >Si[(CH₂)₄CH═CH₂]2.

Aspect 20. A catalyst composition, a process for polymerizing olefins, or a method of making a catalyst composition according to any preceding Aspect, wherein the metallocene compound has the formula

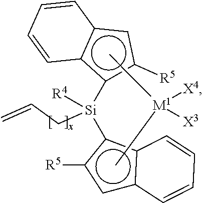

wherein:
M¹ is zirconium or hafnium;
x is 1, 2, 3, or 4;
R⁴ is selected from H or a C₁-C₁₂ hydrocarbyl;
R⁵ in each occurrence is selected independently from H or a C₁-C₂₀ hydrocarbyl; and
X³ and X⁴ are independently selected from F, Cl, Br, a hydride, a C₁-C₁₂ hydrocarbyl group, or a C₁-C₁₂ hydrocarbyloxide group.

Aspect 21. A catalyst composition, a process for polymerizing olefins, or a method of making a catalyst composition according to Aspect 20, wherein:
R⁴ is selected from H or a C₁-C₁₀ hydrocarbyl; and
R⁵ in each occurrence is selected independently from H or a C₁-C₁₅ hydrocarbyl.

Aspect 22. A catalyst composition, a process for polymerizing olefins, or a method of making a catalyst composition according to any of Aspects 21-22, wherein:
R⁴ is selected from methyl, ethyl, propyl, butyl, pentyl, hexyl, cyclopentyl, cyclohexyl, phenyl, tolyl, or benzyl.

Aspect 23. A catalyst composition, a process for polymerizing olefins, or a method of making a catalyst composition according to any preceding Aspect, wherein the metallocene compound has the formula:

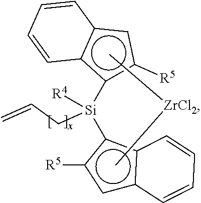

wherein
x is 1, 2, 3, 4, 5, or 6;
R⁴ is methyl or phenyl; and
R⁵ in each occurrence is selected independently from H, methyl, or phenyl.

Aspect 24. A catalyst composition, a process for polymerizing olefins, or a method of making a catalyst composition according to Aspect 23, wherein the metallocene compound has the formula:

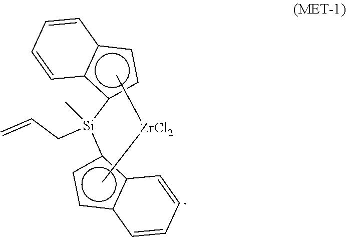

Aspect 25. A catalyst composition, a process for polymerizing olefins, or a method of making a catalyst composition according to Aspect 23, wherein the metallocene compound has the formula:

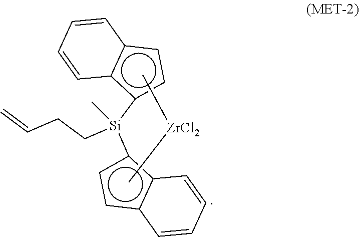

Aspect 26. A catalyst composition, a process for polymerizing olefins, or a method of making a catalyst composition according to Aspect 23, wherein the metallocene compound has the formula:

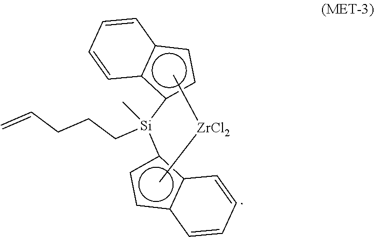

Aspect 27. A catalyst composition, a process for polymerizing olefins, or a method of making a catalyst composition according to Aspect 23, wherein the metallocene compound has the formula:

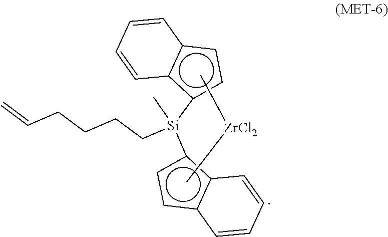

Aspect 28. A catalyst composition, a process for polymerizing olefins, or a method of making a catalyst composition according to Aspect 23, wherein the metallocene compound has the formula:

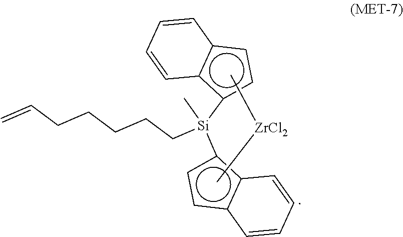

Aspect 29. A catalyst composition, a process for polymerizing olefins, or a method of making a catalyst composition according to Aspect 23, wherein the metallocene compound has the formula:

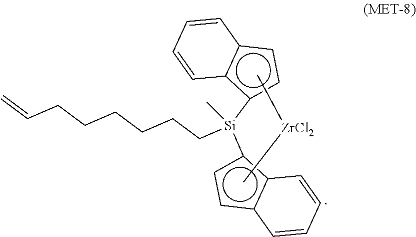

Aspect 30. A catalyst composition, a process for polymerizing olefins, or a method of making a catalyst composition according to any preceding Aspect, wherein the catalyst composition is absent any other (e.g. second) metallocene compound, or wherein the contacting step is absent any other (e.g. second) metallocene compound.

Aspect 31. A catalyst composition, a process for polymerizing olefins, or a method of making a catalyst composition according to any preceding Aspect, wherein the solid oxide comprises or is selected from Al₂O₃, B₂O₃, BeO, Bi₂O₃, CdO, Co₃O₄, Cr₂O₃, CuO, Fe₂O₃, Ga₂O₃, La₂O₃, Mn₂O₃, MoO₃, Na₂O, NiO, P₂O₅, Sb₂O₅, SiO₂, SnO₂, SrO, ThO₂, TiO₂, V₂O₅, WO₃, Y₂O₃, ZnO, ZrO₂, K₂O, CaO, Ce₂O₃, mixtures thereof, mixed oxides thereof, and any combinations thereof.

Aspect 32. A catalyst composition, a process for polymerizing olefins, or a method of making a catalyst composition according to any preceding Aspect, wherein the solid oxide comprises or is selected from silica, alumina, titania, zirconia, magnesia, boria, calcia, zinc oxide, silica-alumina, silica-coated alumina, silica-titania, silica-zirconia, silica-magnesia, alumina-titania, alumina-zirconia, zinc-aluminate, alumina-boria, silica-boria, aluminum phosphate, aluminophosphate, aluminophosphate-silica, magnesium aluminate, titania-zirconia, mullite, boehmite, heteropolytungstates, mixed oxides thereof, a pillared clay such as a pillared montmorillonite, or any combination thereof.

Aspect 33. A catalyst composition, a process for polymerizing olefins, or a method of making a catalyst composition according to any preceding Aspect, wherein the electron-withdrawing anion comprises or is selected from fluoride, chloride, bromide, iodide, sulfate, bisulfate, fluorosulfate, phosphate, fluorophosphate, triflate, mesylate, tosylate, thiosulfate, C₁-C₁₀ alkyl sulfonate, C₆-C₁₄ aryl sulfonate, trifluoroacetate, fluoroborate, fluorozirconate, fluorotitanate, or any combination thereof.

Aspect 34. A catalyst composition, a process for polymerizing olefins, or a method of making a catalyst composition according to any preceding Aspect, wherein the solid oxide treated with an electron-withdrawing anion comprises at least one solid oxide treated with at least two electron-withdrawing anions, and wherein the at least two electron-withdrawing anions comprise or are selected from fluoride and phosphate, fluoride and sulfate, chloride and phosphate, chloride and sulfate, triflate and sulfate, or triflate and phosphate.

Aspect 35. A catalyst composition, a process for polymerizing olefins, or a method of making a catalyst composition according to any preceding Aspect, wherein the solid oxide treated with an electron-withdrawing anion is generated by treatment of a solid oxide with sulfuric acid, sulfate ion, bisulfate ion, fluorosulfuric acid, fluorosulfate ion, phosphoric acid, phosphate ion, fluorophosphoric acid, monofluorophosphate ion, triflic (trifluoromethanesulfonic) acid, triflate trifluoromethanesulfonate) ion, methanesulfonic acid, mesylate (methanesulfonate) ion, toluenesulfonic acid, tosylate (toluenesulfonate) ion, thiosulfate ion, C₁-C₁₀ alkyl sulfonic acid, C₁-C₁₀ alkyl sulfonate ion, C₆-C₁₄ aryl sulfonic acid, C₆-C₁₄ aryl sulfonate ion, fluoride ion, chloride ion, or any combination thereof.

Aspect 36. A catalyst composition, a process for polymerizing olefins, or a method of making a catalyst composition according to any preceding Aspect, wherein the solid oxide treated with an electron-withdrawing anion comprises a sulfated solid oxide, bisulfated (hydrogen sulfated) solid oxide, fluorosulfated solid oxide, phosphated solid oxide, fluorophosphated solid oxide, fluoride solid oxide, or chloride solid oxide.

Aspect 37. A catalyst composition, a process for polymerizing olefins, or a method of making a catalyst composition according to any preceding Aspect, wherein the solid oxide treated with an electron-withdrawing anion comprises a fluorided solid oxide, a sulfated solid oxide or a phosphated solid oxide.

Aspect 38. A catalyst composition, a process for polymerizing olefins, or a method of making a catalyst composition according to any preceding Aspect, wherein the solid oxide treated with an electron-withdrawing anion comprises or is selected from fluorided alumina, chlorided alumina, bromided alumina, sulfated alumina, phosphated alumina, fluorided silica-alumina, chlorided silica-alumina, bromided silica-alumina, sulfated silica-alumina, phosphated silica-alumina, fluorided silica-zirconia, chlorided silica-zirconia, bromided silica-zirconia, sulfated silica-zirconia, phosphated silica-zirconia, fluorided mullite, chlorided mullite, bromided mullite, sulfated mullite, phosphated mullite, fluorided silica-coated alumina, chlorided silica-coated alumina, bromided silica-coated alumina, sulfated silica-coated alumina, phosphated silica-coated alumina, or any combination thereof.

Aspect 39. A catalyst composition, a process for polymerizing olefins, or a method of making a catalyst composition according to any preceding Aspect, wherein:
(a) the solid oxide comprises, consists essentially of, or is selected from silica, alumina, silica-alumina, silica-coated alumina, mullite, aluminum phosphate, aluminophosphate, heteropolytungstate, titania, zirconia, magnesia, boria, zinc oxide, a mixed oxide thereof, or any mixture thereof; and
(b) the electron-withdrawing anion comprises, consists essentially of, or is selected from sulfate, bisulfate, fluorosulfate, phosphate, fluorophosphates, fluoride, or chloride.

Aspect 40. A catalyst composition, a process for polymerizing olefins, or a method of making a catalyst composition according to any preceding Aspect, wherein:
(a) the solid oxide comprises, consists essentially of, or is selected from alumina, silica-alumina, silica-coated alumina, silica-zirconia, mullite, or a mixture thereof, and
(b) the electron-withdrawing anion comprises, consists essentially of, or is selected from fluoride, chloride, sulfate, or phosphate.

Aspect 41. A catalyst composition, a process for polymerizing olefins, or a method of making a catalyst composition according to any of Aspects 1-35, wherein the electron-withdrawing anion comprises or is selected from a sulfur oxoacid anion-modified solid oxide generated by sulfuric acid treatment or sulfate ion treatment.

Aspect 42. A catalyst composition, a process for polymerizing olefins, or a method of making a catalyst composition according to any of Aspects 1-35, wherein the electron-withdrawing anion comprises or is selected from a phosphorus oxoacid anion-modified solid oxide generated by phosphoric acid treatment or phosphate ion treatment.

Aspect 43. A catalyst composition, a process for polymerizing olefins, or a method of making a catalyst composition according to any preceding Aspect, wherein the solid oxide treated with an electron-withdrawing anion is any solid oxide or any combination of solid oxides disclosed herein, treated with any electron-withdrawing anion or any combination of electron-withdrawing anions disclosed herein.

Aspect 44. A catalyst composition, a process for polymerizing olefins, or a method of making a catalyst composition according to any preceding Aspect, wherein the solid oxide treated with an electron-withdrawing anion is produced by a process comprising contacting any suitable solid oxide and any suitable solid oxide with an electron-withdrawing anion to provide a mixture, and concurrently and/or subsequently drying and/or calcining the mixture.

Aspect 45. A catalyst composition, a process for polymerizing olefins, or a method of making a catalyst composition according to any preceding Aspect, wherein:
(a) the solid oxide component used to prepare the solid oxide treated with an electron-withdrawing anion, that is, the solid oxide prior to treatment with the electron-withdrawing anion, has the following properties:
   (i) a surface area from about 100 m²/g to about 1000 m²/g, from about 200 m²/g to about 800 m²/g, or from about 250 m²/g to about 600 m²/g;
   (ii) a pore volume from about 0.1 mL/g to about 3.0 mL/g, from about 0.25 mL/g to about 2.5 mL/g; or from about 0.4 mL/g to about 2.0 mL/g, or from about 0.5 mL/g to about 1.7 mL/g, greater than about 0.1 mL/g, greater than about 0.5 mL/g, or greater than about 1.0 mL/g;
   (iii) an average particle size from about 1 micron to about 250 microns, from about 2 microns to about 200 microns, from about 5 microns to about 150 microns, or from about 10 to about 100 microns; or
   (iv) any combination of (i), (ii), and (iii);
      or
(b) the solid oxide treated with an electron-withdrawing anion has the following properties:
   (i) a surface area from about 100 m²/g to about 1000 m²/g, from about 200 m²/g to about 800 m²/g, or from about 250 m²/g to about 600 m²/g;
   (ii) a pore volume from about 0.1 mL/g to about 3.0 mL/g, from about 0.25 mL/g to about 2.5 mL/g; or from about 0.4 mL/g to about 2.0 mL/g, or from about 0.5 mL/g to about 1.7 mL/g, greater than about 0.1 mL/g, greater than about 0.5 mL/g, or greater than about 1.0 mL/g;
   (iii) an average particle size from about 1 micron to about 250 microns, from about 2 microns to about 200 microns, from about 5 microns to about 150 microns, or from about 10 to about 100 microns; or
   (iv) any combination of (i), (ii), and (iii).

Aspect 46. A catalyst composition, a process for polymerizing olefins, or a method of making a catalyst composition according to any preceding Aspect, wherein the solid oxide treated with an electron-withdrawing anion has a surface area from about 150 m²/g to about 700 m²/g.

Aspect 47. A catalyst composition, a process for polymerizing olefins, or a method of making a catalyst composition according to any preceding Aspect, wherein the solid oxide treated with an electron-withdrawing anion has a pore volume from about 0.5 mL/g to about 2.5 mL/g.

Aspect 48. A catalyst composition, a process for polymerizing olefins, or a method of making a catalyst composition according to any preceding Aspect, wherein the solid oxide treated with an electron-withdrawing anion has an average particle size (d50) from about 10 microns to about 100 microns.

Aspect 49. A catalyst composition, a process for polymerizing olefins, or a method of making a catalyst composition according to any preceding Aspect, wherein the catalyst composition is substantially free of an aluminoxane compound, an organoboron or organoborate compound, an ionizing ionic compound, or combinations thereof, or wherein the contacting step is absent an aluminoxane compound, an organoboron or organoborate compound, an ionizing ionic compound, or combinations thereof.

Aspect 50. A catalyst composition, a process for polymerizing olefins, or a method of making a catalyst composition according to any preceding Aspect, wherein the catalyst composition is substantially free of an aluminoxane compound, or wherein the contacting step is absent an aluminoxane compound.

Aspect 51. A catalyst composition, a process for polymerizing olefins, or a method of making a catalyst composition according to any preceding Aspect, wherein the co-catalyst comprises, consists essentially of, or is selected from an alkylating agent.

Aspect 52. A catalyst composition, a process for polymerizing olefins, or a method of making a catalyst composition according to any preceding Aspect, wherein the co-catalyst further comprises an organoboron compound, an organozinc compound, an organomagnesium compound, an organolithium compound, or any combination thereof.

Aspect 53. A catalyst composition, a process for polymerizing olefins, or a method of making a catalyst composition according to any preceding Aspect, wherein the co-catalyst has a general formula Al(X¹⁰)ₙ(X¹¹)₃, wherein n is 1, 2 or to 3; X¹⁰ is independently a C₁ to C₂₀ hydrocarbyl; and X¹¹ is independently a halide, a hydride, a C₁ to C₂₀ hydrocarbyl, or a C₁ to C₂₀ hydrocarbyloxide.

Aspect 54. A catalyst composition, a process for polymerizing olefins, or a method of making a catalyst composition according to any preceding Aspect, wherein the co-catalyst comprises, consists essentially of, or is selected from a trialkylaluminum compound.

Aspect 55. A catalyst composition, a process for polymerizing olefins, or a method of making a catalyst composition according to any preceding Aspect, wherein the co-catalyst comprises, consists essentially of, or is selected from an organoaluminum compound, wherein the organoaluminum compound comprises trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, or any combination thereof.

Aspect 56. A catalyst composition, a process for polymerizing olefins, or a method of making a catalyst composition according to any preceding Aspect, wherein the co-catalyst comprises, consists essentially of, or is selected from triethylaluminum, triisobutylaluminum, diethylaluminum ethoxide, diethylaluminum chloride, or any combination thereof.

Aspect 57. A catalyst composition, a process for polymerizing olefins, or a method of making a catalyst composition according to any preceding Aspect, wherein the co-catalyst comprises, consists essentially of, or is selected from any organoaluminum compound disclosed herein.

Aspect 58. A catalyst composition, a process for polymerizing olefins, or a method of making a catalyst composition according to any preceding Aspect, wherein the co-catalyst comprises, consists essentially of, or is selected from any organoaluminum compound having a formula Al(X¹²)_{q}(X¹³)_{3-q}, wherein X¹² is independently a C₁ to C₁₂ hydrocarbyl, X¹¹ is independently a halide, a hydride, or a C₁ to C₁₂ hydrocarboxide, and q is an integer from 1 to 3 inclusive.

Aspect 59. A catalyst composition, a process for polymerizing olefins, or a method of making a catalyst composition according to any preceding Aspect, wherein the catalyst composition further comprises an aluminoxane compound, or wherein the contacting step further comprises contacting in any order an aluminoxane compound.

Aspect 60. A catalyst composition, a process for polymerizing olefins, or a method of making a catalyst composition according to Aspect 59, wherein the aluminoxane comprises:
a cyclic aluminoxane having the formula

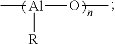

wherein R is a linear or branched alkyl having from 1 to 10 carbon atoms, and n is an integer from 3 to about 10;
a linear aluminoxane having the formula

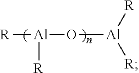

wherein R is a linear or branched alkyl having from 1 to 10 carbon atoms, and n is an integer from 1 to about 50;
a cage aluminoxane having the formula R^{t}_{5m+α}R^{b}_{m-α}Al₄ₘO₃ₘ, wherein m is 3 or 4 and α=n_{Al(3)}−n_{O(2)}+n_{O(4)}; wherein n_{Al(3)} is the number of three coordinate aluminum atoms, nO₍₂₎ is the number of two coordinate oxygen atoms, n_{O(4)} is the number of 4 coordinate oxygen atoms, R^{t} represents a terminal alkyl group, and R^{b} represents a bridging alkyl group; wherein R is a linear or branched alkyl having from 1 to 10 carbon atoms; or
any combination thereof.

Aspect 61. A catalyst composition, a process for polymerizing olefins, or a method of making a catalyst composition according to Aspect 59, wherein aluminoxane has the formula:

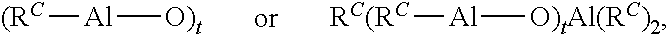

wherein
R^{C} is a linear or branched C₁-C₆ alkyl such as methyl, ethyl, propyl, butyl, pentyl, or hexyl wherein t is an integer from 1 to 50, inclusive.

Aspect 62. A catalyst composition, a process for polymerizing olefins, or a method of making a catalyst composition according to any of Aspects 59-61, wherein the aluminoxane comprises, consists essentially of, or is selected from methylaluminoxane (MAO), ethylaluminoxane, modified methylaluminoxane (MMAO) such as an isobutyl-modified methyl aluminoxane, n-propylaluminoxane, iso-propylaluminoxane, n-butylaluminoxane, t-butyl-aluminoxane, sec-butylaluminoxane, iso-butylaluminoxane, t-butyl aluminoxane, 1-pentyl-aluminoxane, 2-pentylaluminoxane, 3-pentylaluminoxane, iso-pentylaluminoxane, neopentylaluminoxane, or combinations thereof.

Aspect 63. A catalyst composition, a process for polymerizing olefins, or a method of making a catalyst composition according to any preceding Aspect, wherein the catalyst composition further comprises a diluent or wherein the contacting step comprises contacting the recited elements in a diluent.

Aspect 64. A catalyst composition, a process for polymerizing olefins, or a method of making a catalyst composition according to Aspect 63, wherein the diluent comprises any suitable non-protic solvent, or any non-protic solvent disclosed herein.

Aspect 65. A catalyst composition, a process for polymerizing olefins, or a method of making a catalyst composition according to any of Aspects 63-64, wherein the diluent comprises any suitable weakly coordinating or non-coordinating solvent, or any weakly coordinating or non-coordinating solvent disclosed herein.

Aspect 66. A catalyst composition, a process for polymerizing olefins, or a method of making a catalyst composition according to any of Aspects 63-65, wherein the diluent comprises any suitable aliphatic hydrocarbon solvent, or any aliphatic hydrocarbon solvent disclosed herein, e.g. a diluent olefin in the case of bulk polymerizations, propane, butanes (for example, n-butane, iso-butane), pentanes (for example, n-pentane, iso-pentane), hexanes, heptanes, octanes, petroleum ether, light naphtha, heavy naphtha, or any combination thereof.

Aspect 67. A catalyst composition, a process for polymerizing olefins, or a method of making a catalyst composition according to any of Aspects 63-66, wherein the diluent comprises any suitable aromatic hydrocarbon solvent, or any aromatic hydrocarbon solvent disclosed herein, e.g., benzene, toluene, xylenes, etc.

Aspect 68. A method of making a catalyst composition according to any of Aspects 3-67, wherein:
(a) the metallocene compound and the co-catalyst are contacted in a diluent, to provide a first composition, and the first composition is contacted with the activator-support;
(b) the metallocene compound and the activator-support are contacted in the diluent, to provide a second composition, and the second composition is contacted with the co-catalyst;
(c) the co-catalyst and the activator-support are contacted in the diluent, to provide a third composition, and the third composition is contacted with the metallocene compound; or
(d) the metallocene compound, the activator-support, and the co-catalyst are co-fed and contacted in a single step.

Aspect 69. A method of making a catalyst composition according to any of Aspects 3-68, wherein the recited components are contacted in the presence of an olefin.

Aspect 70. A method of making a catalyst composition according to any of Aspects 3-68, wherein the recited components are contacted in the absence of an olefin.

Aspect 71. A process for polymerizing olefins according to any of Aspects 2 and 4-67, wherein the at least one olefin monomer comprises ethylene.

Aspect 72. A process for polymerizing olefins according to any of Aspects 2, 4-67, and 71, wherein the at least one olefin monomer comprises ethylene or ethylene in combination with an olefin co-monomer selected from propylene, butene (e.g., 1-butene), pentene, hexene (e.g., 1-hexene), heptene, octene (e.g., 1-octene), styrene, and the like.

Aspect 73. A process for polymerizing olefins according to any of Aspects 2, 4-67, and 71-72, wherein the at least one olefin monomer comprises ethylene, propylene, butene (e.g., 1-butene), pentene, hexene (e.g., 1-hexene), heptene, octene (e.g., 1-octene), or styrene.

Aspect 74. A process for polymerizing olefins according to any of Aspects 2, 4-67, and 71-73, wherein the process is conducted in the presence of hydrogen.

Aspect 75. A process for polymerizing olefins according to any of Aspects 2, 4-67, and 71-73, wherein the process is conducted in the absence of hydrogen.

Aspect 76. A process for polymerizing olefins or a method of making a catalyst composition according to any of Aspects 2-75, wherein
(a) the process or the method is carried out under any of following conditions:
   (i) the molar ratio of the co-catalyst to the metallocene compound is from about 0.1:1 to about 1,200:1, or from about 2:1 to about 1,100:1, or from about 5:1 to about 1,000:1, or from about 10:1 to about 750:1;
   (ii) the weight ratio of the activator-support to the metallocene compound is from about 5:1 to about 1,500:1, or from about 10:1 to about 1,250:1, or form about 20:1 to about 1,000:1;
   (iii) the weight ratio of the at least one olefin monomer to the metallocene compound is from about 1,000:1 to about 100,000,000:1, or from about 5,000:1 to about 50,000,000:1, or from about 10,000:1 to about 25,000,000:1; or
   (iv) any combination of conditions (i), (ii), and (iii);
      or
(b) the process or the method is carried out under any of following conditions:
   (i) the molar ratio of the co-catalyst to the metallocene compound(s) is from about 10:1 to about 500:1, for example when the co-catalyst comprises an organoaluminum compound such as a trialkylaluminum compound; or
   (ii) the weight ratio of the activator-support to the metallocene compound(s) is from about 5:1 to about 1,000:1, for example when the activator-support comprises a fluorided silica-alumina, fluorided silica-coated alumina, or a fluorided mullite; or
   (iii) the weight ratio of the at least one olefin monomer to the metallocene compound(s) is from about 1,000:1 to about 100,000,000:1; or
   (iv) any combination of (i), (ii), and (iii).

Aspect 77. A process for polymerizing olefins according to any of Aspects 2, 4-67, and 71-76, wherein the process is conducted in a polymerization reactor system comprising, consisting essentially of, or selected from a batch reactor, a slurry reactor, a loop-slurry reactor, a gas phase reactor, a solution reactor, a high pressure reactor, a tubular reactor, an autoclave reactor, a continuous stirred tank reactor (CSTR), or a combination thereof.

Aspect 78. A process for polymerizing olefins according to any of Aspects 2, 4-67, and 71-77, wherein the polymerization conditions suitable to form a polyethylene comprise:
(a) a polymerization reaction temperature from about 40° C. to about 210° C., from about 50° C. to about 180° C., or from about from about 60° C. to about 160° C.; or
(b) a reaction pressure or a partial pressure of ethylene of from about 25 psig (0.17 MPa) to about 1500 psig (10.3 MPa), from about 50 psig (0.34 MPa) to about 1200 psig (8.3 MPa), from about 85 psig (0.59 MPa) to about 1100 psig (7.6 MPa), or from about 100 psig (0.69 MPa) to about 1000 psig (6.9 MPa);
(c) a time of the contacting step of from about 1 minute to about 3 hours, from about 5 minutes to about 2.5 hours, from about 10 minutes to about 2 hours, or from about 20 minutes to about 1.5 hours; or
(d) any combination of (a), (b), and (c).

Aspect 79. A process for polymerizing olefins according to any of Aspects 2, 4-67, and 71-78, wherein the polyolefin is an ethylene homopolymer or an ethylene-α-olefin copolymer characterized by:
(a) a polydispersity index (molecular weight distribution, Mw/Mn) which is greater than the molecular weight distribution of a comparative polyolefin;
(b) a Carreau-Yasuda CY-a parameter which is greater than the CY-a parameter of the comparative polyolefin;
(c) a long chain branch (LCB) formation which is lower than the LCB formation of the comparative polyolefin; or
(d) any combination of (a), (b), and (c), and wherein:
   (i) the comparative polyolefin is prepared under identical conditions as the ethylene homopolymer or the ethylene-α-olefin copolymer except for using a comparative metallocene compound in place of the metallocene compound in a comparative catalyst composition; and
   (ii) the comparative metallocene compound is: (A) dimethylsilyl bis(indenyl) zirconium dichloride; or (B) identical to the metallocene compound except that X¹ and X² except that X¹ and X² are bridged by a linking group having a formula >Si[(CH₂)ₘCH₂CH₂]R⁶, wherein m has the same value as n, and R⁶ is the same as R¹.

Aspect 80. A catalyst composition, a process for polymerizing olefins, or a method of making a catalyst composition according to any preceding Aspect, wherein the catalyst composition is characterized by an activator-support activity in a range from about 20 g/(g·h) (grams polyethylene per gram of activator-support per hour) to about 12,000 g/(g·h), from about 100 g/(g·h) to about 10,000 g/(g·h), from about 250 g/(g·h) to about 7,500 g/(g·h), or from about 500 g/(g·h) to about 5,000 g/(g·h).

Aspect 81. A catalyst composition, a process for polymerizing olefins, or a method of making a catalyst composition according to any preceding Aspect, wherein the catalyst composition is characterized by a metallocene activity in a range from about 10,000 g/(g·h) (grams polyethylene per gram of metallocene per hour) to about 2,000,000 g/(g·h), from about 30,000 g/(g·h) to about 1,500,000 g/(g·h), from about 40,000 g/(g·h) to about 1,250,000 g/(g·h), from about 50,000 g/(g·h) to about 1,100,000 g/(g·h), from about 60,000 g/(g·h) to about 1,000,000 g/(g·h), or from about 75,000 g/(g·h) to about 900,000 g/(g·h).

Aspect 82. A polyolefin prepared according to the process for polymerizing olefins of any of Aspects 2, 4-67, and 71-81, wherein the polyolefin is an ethylene homopolymer characterized by any one or any combination of the following properties:
(a) a polydispersity index (molecular weight distribution, Mw/Mn) of from 3.5-7.5, or alternatively from 5.0-7.0;
(b) a ratio of a high load melt index to a melt index (HLMI/MI) of from 25 to 60, or alternatively from 28-40;
(c) a Carreau-Yasuda CY-a parameter of from 0.24 to 0.36, or alternatively from 0.25 to 0.34; and/or
(d) a density in a range from about 0.94 g/cm³ to 0.96.

Aspect 83. A polyolefin prepared according to the process for polymerizing olefins of any of Aspects 2, 4-67, and 71-81, wherein the polyolefin is an ethylene-α-olefin copolymer characterized by any one or any combination of the following properties:
(a) a polydispersity index (molecular weight distribution, Mw/Mn) of from 3.0-4.5, or alternatively from 3.1-4.3;
(b) a ratio of a high load melt index to a melt index (HLMI/MI) of from 15 to 27, or alternatively from 20-25;
(c) a Carreau-Yasuda CY-a parameter of from 0.10 to 0.24, or alternatively from 0.16 to 0.232; and/or
(d) a density in a range from about 0.90 g/cm³ to 0.96.

Aspect 84. A polyolefin prepared according to the process for polymerizing olefins of any of Aspects 2, 4-67, and 71-81, wherein the polyolefin is characterized the following properties:
(a) a number-average molecular weight (Mn) in a range of from about 5,000 g/mol to about 250,000 g/mol, from about 10,000 g/mol to about 200,000 g/mol, or from about 20,000 g/mol to about 150,000 g/mol;
(b) a weight-average molecular weight (Mw) in a range of from about 50,000 g/mol to about 700,000 g/mol, from about 75,000 g/mol to about 500,000 g/mol, or from about 100,000 g/mol to about 400,000 g/mol;
(c) a density in a range of from about 0.90 g/cm³ to about 0.96 g/cm³, from about 0.92 g/cm³ to about 0.96 g/cm³, or from about 0.94 g/cm³ to about 0.96 g/cm³;
(d) a melt index (MI) in a range of from about 0 g/10 min to about 100 g/10 min, from about 0.1 g/10 min to about 50 g/10 min, or from about 0.5 g/10 min to about 10 g/10 min; or
(e) any combination of (a), (b), (c), and (d).

Aspect 85. A polyolefin produced by the process for polymerizing olefins of any of Aspects 2, 4-67, and 71-84.

Aspect 86. An article comprising the polyolefin according to Aspect 85.

Aspect 87. An article according to Aspect 86, wherein the article is an agricultural film, an automobile part, a bottle, a drum, a fiber, a fabric, a food packaging film or container, a container preform, a food service article, a fuel tank, a geomembrane, a household container, a liner, a molded product, a medical device or material, a pipe, a sheet, a tape, or a toy.

Aspect 88. A method for making an article of manufacture comprising a polyolefin, the method comprising:
(a) performing the polymerization process according to any of Aspects 2, 4-67, and 71-81; and
(b) fabricating the article of manufacture comprising the polyolefin.

We claim:

1. A catalyst composition for polymerizing olefins, the catalyst composition comprising the contact product of:
(a) a metallocene compound having the formula: 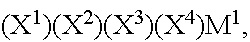
wherein
M¹ is titanium, zirconium, or hafnium;
X¹ and X² are independently a substituted or an unsubstituted indenyl ligand, wherein a substituent, when present, is selected independently from a halogen or a C₁-C₂₀ hydrocarbyl group;
X¹ and X² are bridged by a linking group having the formula >Si[(CH₂)ₙCH═CH₂]R¹, wherein n is 1, 2, 3, 4, 5, or 6, and R¹ is H or a C₁ to C₂₀ hydrocarbyl group; and
X³ and X⁴ are independently a halide, hydride, a C₁-C₂₀ hydrocarbyl group, a C₁-C₂₀ heterohydrocarbyl group, tetrahydroborate, or OBR^{A}₂ or OSO₂R^{A}, wherein R^{A} is independently a C₁-C₁₂ hydrocarbyl group;
(b) an activator-support comprising a solid oxide treated with an electron-withdrawing anion; and
(c) an organoaluminum co-catalyst.

2. The catalyst composition according to claim 1, wherein:
M¹ is zirconium or hafnium;
X¹ and X² are independently a substituted or an unsubstituted indenyl ligand, wherein a substituent, when present, is selected independently from a C₁-C₁₅ hydrocarbyl group;
X¹ and X² are bridged by a linking group having the formula >Si[(CH₂)ₙCH═CH₂]R¹, wherein n is 1, 2, 3, 4, 5, or 6, and R¹ is H or a C₁-C₁₅ hydrocarbyl; and
X³ and X⁴ are independently selected from F, Cl, Br, a hydride, a C₁-C₁₂ hydrocarbyl group, a C₁-C₁₂ hydrocarbyloxide group, or an SiR²₃-substituted C₁ to C₁₅ hydrocarbyl group wherein R² is independently a C₁ to C₆ hydrocarbyl group.

3. The catalyst composition according to claim 1, wherein R¹ is (CH₂)ₙCH═CH₂, such that X¹ and X² are bridged by a linking group having the formula >Si[(CH₂)ₙCH═CH₂]₂.

4. The catalyst composition according to claim 1, wherein the metallocene compound has the formula: 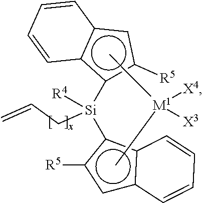
wherein
M¹ is zirconium or hafnium;
x is 1, 2, 3, 4, 5, or 6;
R⁴ is selected from H or a C₁-C₁₂ hydrocarbyl;
R⁵ in each occurrence is selected independently from H or a C₁-C₂₀ hydrocarbyl; and
X³ and X⁴ are independently selected from F, Cl, Br, a hydride, a C₁-C₁₂ hydrocarbyl group, or a C₁-C₁₂ hydrocarbyloxide group.

5. The catalyst composition according to claim 4, wherein:
R⁴ is selected from H or a C₁-C₁₀ hydrocarbyl; and
R⁵ in each occurrence is selected independently from H or a C₁-C₁₅ hydrocarbyl.

6. The catalyst composition according to claim 4, wherein:
R⁴ is selected from methyl, ethyl, propyl, butyl, pentyl, hexyl, cyclopentyl, cyclohexyl, phenyl, tolyl, or benzyl.

7. The catalyst composition according to claim 1, wherein the C₁-C₂₀ hydrocarbyl group, when present as a substituent on X¹ or X², is independently selected from methyl, ethyl, propyl, butyl, pentyl, hexyl, cyclopentyl, cyclohexyl, phenyl, tolyl, benzyl, naphthyl, or biphenyl.

8. The catalyst composition according to claim 1, wherein the linking group has the formula >Si[CH₂CH═CH₂]Me, >Si[(CH₂)₂CH═CH₂]Me, >Si[(CH₂)₃CH═CH₂]Me, >Si[(CH₂)₄CH═CH₂]Me, >Si[CH₂CH═CH₂]Ph, >Si[(CH₂)₂CH═CH₂]Ph, >Si[(CH₂)₃CH═CH₂]Ph, >Si[(CH₂)₄CH═CH₂]Ph, >Si[CH₂CH═CH₂]2, >Si[(CH₂)₂CH═CH₂]2, >Si[(CH₂)₃CH═CH₂]2, or >Si[(CH₂)₄CH═CH₂]2.

9. The catalyst composition according to claim 1, wherein the metallocene compound has the formula: 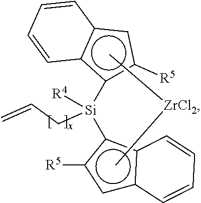
wherein
x is 1, 2, 3, 4, 5, or 6;
R⁴ is methyl or phenyl; and
R⁵ in each occurrence is selected independently from H, methyl, or phenyl.

10. The catalyst composition according to claim 1, wherein the metallocene compound has the formula:

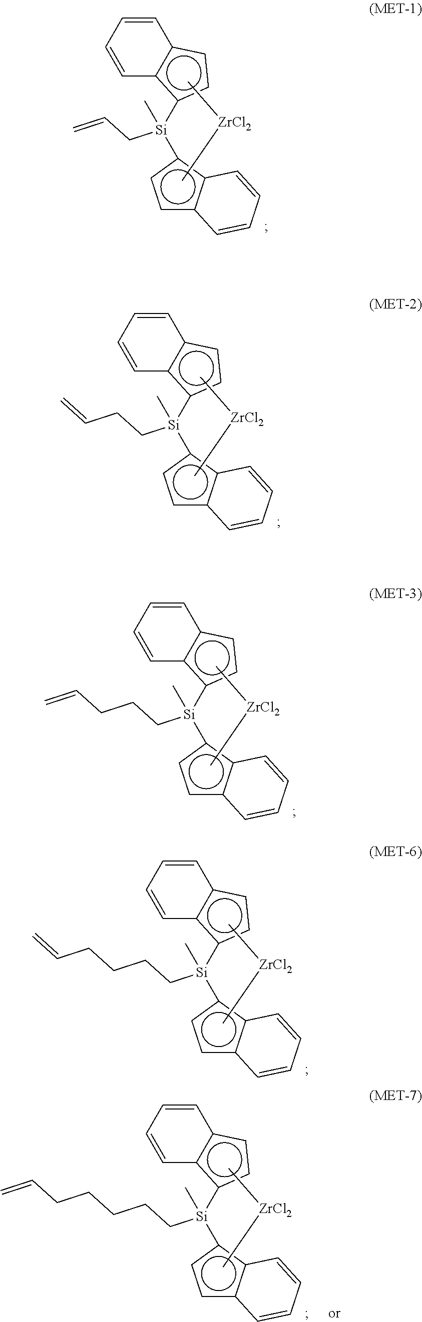

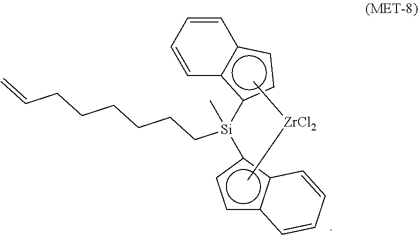

11. The catalyst composition according to claim 1, wherein the solid oxide comprises silica, alumina, titania, zirconia, magnesia, boria, calcia, zinc oxide, silica-alumina, silica-coated alumina, silica-titania, silica-zirconia, silica-magnesia, alumina-titania, alumina-zirconia, zinc-aluminate, alumina-boria, silica-boria, aluminum phosphate, aluminophosphate, aluminophosphate-silica, magnesium aluminate, titania-zirconia, mullite, boehmite, heteropolytungstates, mixed oxides thereof, or any combination thereof.

12. The catalyst composition according to claim 1, wherein the solid oxide comprises silica, alumina, silica-alumina, silica-coated alumina, or any combination thereof.

13. The catalyst composition according to claim 1, wherein the electron-withdrawing anion comprises fluoride, chloride, bromide, iodide, sulfate, bisulfate, fluorosulfate, phosphate, fluorophosphate, triflate, mesylate, tosylate, thiosulfate, C₁-C₁₀ alkyl sulfonate, C₆-C₁₄ aryl sulfonate, trifluoroacetate, fluoroborate, fluorozirconate, fluorotitanate, or any combination thereof.

14. The catalyst composition according to claim 1, wherein the solid oxide treated with an electron-withdrawing anion comprises a fluorided solid oxide, a sulfated solid oxide or a phosphated solid oxide.

15. The catalyst composition according to claim 1, wherein:
the solid oxide comprises alumina, silica-alumina, silica-coated alumina, or a mixture thereof, and
the electron-withdrawing anion comprises fluoride, sulfate, or phosphate.

16. The catalyst composition according to claim 1, wherein the solid oxide treated with an electron withdrawing anion comprises a fluorided silica-coated alumina.

17. The catalyst composition according to claim 1, wherein the solid oxide prior to treatment with the electron-withdrawing anion has the following properties:
(a) a surface area from about 100 m²/g to about 1000 m²/g;
(b) a pore volume from about 0.1 mL/g to about 3.0 mL/g;
(c) an average particle size from about 1 micron to about 250 microns; or
(d) any combination of (a), (b), and (c).

18. The catalyst composition according to claim 1, wherein the solid oxide treated with an electron-withdrawing anion has the following properties:
(a) a surface area from about 100 m²/g to about 1000 m²/g;
(b) a pore volume from about 0.1 mL/g to about 3.0 mL/g;
(c) an average particle size from about 1 micron to about 250 microns; or
(d) any combination of (a), (b), and (c).

19. The catalyst composition according to claim 1, wherein the solid oxide treated with an electron-withdrawing anion has an average particle size (d50) from about 10 microns to about 100 microns.

20. The catalyst composition according to claim 1, wherein catalyst composition is substantially free of an aluminoxane compound.

21. The catalyst composition according to claim 1, wherein the organoaluminum co-catalyst has a formula Al(X¹²)ₛ(X¹³)₃₋ₛ, wherein X¹² is independently a C₁ to C₁₂ hydrocarbyl, X¹³ is independently a halide, a hydride, or a C₁ to C₁₂ hydrocarboxide, and s is an integer from 1 to 3 (inclusive).

22. The catalyst composition according to claim 1, wherein the organoaluminum co-catalyst comprises trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, or any combination thereof.

23. The catalyst composition according to claim 1, wherein the catalyst composition further comprises a diluent selected from an aliphatic hydrocarbon solvent or an aromatic hydrocarbon solvent.

24. A process for polymerizing olefins, the process comprising contacting at least one olefin monomer and a catalyst composition under polymerization conditions to form a polyolefin, wherein the catalyst composition comprises the contact product of:
(a) a metallocene compound having the formula: 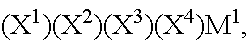
wherein
M¹ is titanium, zirconium, or hafnium;
X¹ and X² are independently a substituted or an unsubstituted indenyl ligand, wherein a substituent, when present, is selected independently from a halogen or a C₁-C₂₀ hydrocarbyl group;
X¹ and X² are bridged by a linking group having the formula >Si[(CH₂)ₙCH═CH₂]R¹, wherein n is 1, 2, 3, 4, 5, or 6, and R¹ is H or a C₁ to C₂₀ hydrocarbyl group; and
X³ and X⁴ are independently a halide, hydride, a C₁-C₂₀ hydrocarbyl group, a C₁-C₂₀ heterohydrocarbyl group, tetrahydroborate, or OBR^{A}₂ or OSO₂R^{A}, wherein R^{A} is independently a C₁-C₁₂ hydrocarbyl group;
(b) an activator-support comprising a solid oxide treated with an electron-withdrawing anion; and
(c) an organoaluminum co-catalyst.

25. The process for polymerizing olefins according to claim 24, wherein:
(a) the metallocene compound has the formula: 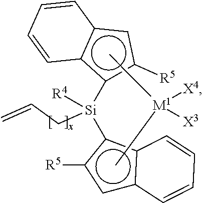
wherein
M¹ is zirconium or hafnium;
x is 1, 2, 3, 4, 5, or 6;
R⁴ is selected from H or a C₁-C₁₂ hydrocarbyl;
R⁵ in each occurrence is selected independently from H or a C₁-C₂₀ hydrocarbyl; and
X³ and X⁴ are independently selected from F, Cl, Br, a hydride, a C₁-C₁₂ hydrocarbyl group, or a C₁-C₁₂ hydrocarbyloxide group;
(b) the solid oxide comprises alumina, silica-alumina, silica-coated alumina, or a mixture thereof,
(c) the electron-withdrawing anion comprises fluoride, sulfate, or phosphate; and
(d) the organoaluminum co-catalyst comprises trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, or any combination thereof.

26. The process for polymerizing olefins according to claim 24, wherein the at least one olefin monomer comprises ethylene or ethylene in combination with an olefin co-monomer selected from propylene, butene, pentene, hexene, heptene, octene, or styrene.

27. The process for polymerizing olefins according to claim 24, wherein the process is conducted in the presence of hydrogen.

28. The process for polymerizing olefins according to claim 24, wherein the polymerization conditions comprise:
(a) the molar ratio of the co-catalyst to the metallocene compound is from about 0.1:1 to about 1,200:1;
(b) the weight ratio of the activator-support to the metallocene compound is from about 5:1 to about 1,500:1;
(c) the weight ratio of the at least one olefin monomer to the metallocene compound is from about 1,000:1 to about 100,000,000:1;
(d) a polymerization reaction temperature from about 40° C. to about 210° C.; or
(e) a reaction pressure or a partial pressure of ethylene of from about 25 psig (0.17 MPa) to about 1500 psig (10.3 MPa);
(f) a time of contacting is from about 1 minute to about 5 hours; or
(g) any combination of (a), (b), (c), (d), (e), and (f).

29. The process for polymerizing olefins according to claim 24, wherein the process is conducted in batch reactor, a slurry reactor, a loop-slurry reactor, a gas phase reactor, a solution reactor, a high pressure reactor, a tubular reactor, an autoclave reactor, a continuous stirred tank reactor (CSTR), or a combination thereof.

30. A method of making a catalyst composition, the method comprising contacting in any order:
(a) a metallocene compound having the formula: 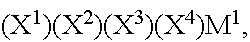
wherein
M¹ is titanium, zirconium, or hafnium;
X¹ and X² are independently a substituted or an unsubstituted indenyl ligand, wherein a substituent, when present, is selected independently from a halogen or a C₁-C₂₀ hydrocarbyl group;
X¹ and X² are bridged by a linking group having the formula >Si[(CH₂)ₙCH═CH₂]R¹, wherein n is 1, 2, 3, 4, 5, or 6, and R¹ is H or a C₁ to C₂₀ hydrocarbyl group; and
X³ and X⁴ are independently a halide, hydride, a C₁-C₂₀ hydrocarbyl group, a C₁-C₂₀ heterohydrocarbyl group, tetrahydroborate, or OBR^{A}₂ or OSO₂R^{A}, wherein R^{A} is independently a C₁-C₁₂ hydrocarbyl group;
(b) an activator-support comprising a solid oxide treated with an electron-withdrawing anion (“solid super acid”); and
(c) an organoaluminum co-catalyst.

31. The method of making a catalyst composition according to claim 30, wherein:
(a) the metallocene compound and the organoaluminum co-catalyst are contacted in a diluent, to provide a first composition, and the first composition is contacted with the activator-support;
(b) the metallocene compound and the activator-support are contacted in the diluent, to provide a second composition, and the second composition is contacted with the organoaluminum co-catalyst;
(c) the organoaluminum co-catalyst and the activator-support are contacted in the diluent, to provide a third composition, and the third composition is contacted with the metallocene compound; or
(d) the metallocene compound, the activator-support, and the co-catalyst are co-fed and contacted in a single step.
